(19) United States
(12) Patent Application Publication
(10) Pub. No.: US 2007/0109919 A1
(43) Pub. Date: May 17, 2007

(54) Light-condensing head and storage apparatus

(75) Inventors: Mitsuru Yokoyama, Osaka (JP); Kenji Konno, Osaka (JP)

Correspondence Address: BRINKS HOFER GILSON & LIONE, P.O. BOX 10395, CHICAGO, IL, 60610, US

(73) Assignee: KONICA MINOLTA HOLDINGS, INC.

(21) Appl. No.: 11/600,461

(22) Filed: Nov. 16, 2006

(30) Foreign Application Priority Data
Nov. 17, 2005 (JP) 2005-332895

(51) Int. Cl. G11B 11/00

(52) U.S. Cl. 369/13.24; 369/13.01; 369/13.02

(57) ABSTRACT

A light-condensing head has a light source unit, a light-condensing element that condenses the light emitted from the light source unit, and an electrically conductive scatterer that, when irradiated with light, produces localized plasmon at the light condensation position of the light from the light-condensing element. The light emitted from the light source unit contains, at least in part thereof, polarized waves that constitute a rotation-symmetric radiating electric field vector distribution in which the electric field vectors have equal magnitudes at equal distances from the center of rotation symmetry. The electrically conductive scatterer has, in the light-receiving portion thereof that receives the light from the light-condensing element, rotation symmetry of order three or more.

This application is based on Japanese Patent Application No. 2005-332895 filed on Nov. 17, 2005, the contents of which are hereby incorporated by reference.

### BACKGROUND OF THE INVENTION

1. Field of the Invention

The present invention relates to a light-condensing head capable of producing near-field light, and also relates to a storage apparatus provided therewith.

2. Description of Related Art

In recent years, to achieve higher recording densities in magnetic disk apparatuses (e.g., hard disk drives, abbreviated to HDDs), there have been developed various types of heat-assisted magnetic recording that exploits temperature-dependence of magnetization. According to this recording method, a very small light spot is shone on a magnetic medium and thereby the temperature of the irradiated part is instantaneously raised so that recording is achieved by a drop in coercivity resulting from the raise in temperature. On completion of recording, the recorded information is stably held by high coactivity that is restored as the temperature drops after the rise.

Where this method is used, the size of the condensed light spot should preferably be as small as possible. One way to achieve that is to use near-field light, which is not affected by the limit of diffraction. Examples of technologies for producing near-field light (i.e., technologies for condensing light) are disclosed in Patent Documents 1 to 3 listed below, which exploit surface plasmon polariton, abbreviated to SPP, and in Patent Document 4 listed below, which exploits localized plasmon.

Patent Document 1: JP-2004-061880

Patent Document 2: JP-2004-213000

Patent Document 3: JP-2005-031028

Patent Document 4: JP-2003-114184

According to the light-condensing technologies disclosed in Patent Documents 1 and 2, light is shone on a metal film having periodic surface irregularities and having very small openings. This produces surface plasmon polariton (SPP) attributable to the periodic surface irregularities, and also produces near-field light passing through the very small openings. Here, near-field light and surface plasmon polariton combine to produce a plasmon enhancement effect. This effect produces near-field light with augmented light intensity (near-field light with augmented electric field vectors).

According to the light-condensing technology disclosed in Patent Document 3, light is shone on a member having at least two very small openings (slits) and having periodic surface irregularities formed by those very small openings. What is special here is that the light has rotation-symmetric, radiating electric field vectors, and in addition that the electric field vectors have equal magnitudes at equal distances from the center of rotation symmetry (hereinafter, this type of light will be referred to as a radically polarized beam). Here, SPP produced by the periodic surface irregularities interferes with radically polarized beam to produce an intense electric field. This intense electric field produces near-field light with augmented light intensity.

According to the light-condensing technology disclosed in Patent Document 4, as shown in FIG. 51, light L′ is shone on a scatterer (electrically conductive scatterer) 102 that is electrically conductive and that is increasingly narrow toward one corner. Here, localized plasmon (unillustrated) occurs at the corner of the scatterer 102. This localized plasmon produces near-field light with augmented light intensity.

The light-condensing technologies disclosed in Patent Documents 1 to 4, however, have the following disadvantages. According to the light-condensing technologies disclosed in Patent Documents 1 and 2, near-field light is produced by use of very small openings in a metal film. The very small openings have diameters of about 200 nm, as disclosed in Patent Document 2 (see paragraph [0037] etc.). This size is about one-severalth of the wavelength of the laser light produced by a red-light semiconductor laser (about 660 nm, so-called the red-light wavelength). Thus, these light-condensing technologies can produce near-field light with augmented light intensity when the very small openings are about 200 nm large. With smaller openings, however, it is difficult to produce near-field light with augmented light intensity; that is, it is impossible to sufficiently augment the light intensity (the magnitude of the electric field vectors) of the near-field light produced.

According to the light-condensing technology disclosed in Patent Document 3, like those disclosed in Patent Documents 1 and 2, it is possible to produce near-field light with augmented light intensity when the very small openings are about one-severalth as large as the red-light wavelength, which is the wavelength of the incident light. However, just as described above, with smaller openings, it is difficult to produce near-field light with augmented light intensity.

In addition, as described above, a radially polarized beam has rotation-symmetric, radiating electric field vectors, and moreover the electric field vectors have equal magnitudes at equal distances from the center of rotation symmetry. Thus, as shown in FIG. 52, as seen from the direction of the propagation of light, the direction in which the electric field vectors point (the direction of polarization) is indicated by radiating arrows. Light polarized in such a special direction, however, is extremely difficult to produce.

A radially polarized beam can be produced, for example, by use of an optical element called a polarization rotator 105 (see FIGS. 53A to 53D). A polarization rotator 105 rotates the polarization direction of light; if the so rotated polarization direction is 90° apart from the original polarization direction, the polarization rotator 105 is called a polarization rotator with “a rotating power of 0.25”. Thus, the rotating power and the rotated angle have the following relationship.

TABLE 1

| | Rotated Angle | |
|---|---|---|
| Rotating Power | (°) | Drawing |
| 0.00 | 0 | See FIG. 53A |
| 0.25 | 90 | See FIG. 53B |
| 0.50 | 180 | See FIG. 53C |
| 0.75 | 270 | See FIG. 53D |
| 1.00 | 360 | |

In FIGS. 53A to 53D, for the sake of convenience, the polarization direction is indicated by a single-headed arrow, and the rotating power is indicated by a value marked on the polarization rotator 105; moreover, the travel direction of light is indicated by a dash-dot-dot line.

For example as shown in FIG. 54, a radially polarized beam is produced by a combined polarization rotator 105′ composed of a plurality of types of polarization rotator 105 (the values placed between double quotes (“ ”) indicate the rotating power). That is, as a result of linearly polarized light passing through a plurality of types of polarization rotator 105 simultaneously, a radially polarized beam is produced.

This requires that the width of the light beam LF′ as it is shone on the combined polarization rotator 105′ accurately overlap one side of the combined polarization rotator 105′. For example as shown in FIG. 54, the center LF′c of the width of the light beam LF′ needs to coincide with the center 105′c of that side of the combined polarization rotator 105′. Such coincidence, however, is extremely difficult to achieve. Thus, it can be said that, with the light-condensing technology disclosed in Patent Document 3, it is difficult to easily produce a radially polarized beam, which is the prerequisite for producing near-field light. Moreover, it is also extremely difficult to fabricate the combined polarization rotator 105′ incorporating a plurality of types of polarization rotator 105, its fabrication requiring high cost.

The light-condensing technology disclosed in Patent Document 4 exploits localized plasmon. Localized plasmon is a phenomenon caused by resonance, not by propagated light. Accordingly, this light-condensing technology can produce near-field light having a wavelength sufficiently shorter than that of incident light (near-field light having an wavelength about one-tenth of the wavelength of incident light). Inconveniently, however, localized plasmon is produced only by P-polarized light, and this property makes it difficult for the light-condensing technology disclosed in Patent Document 4 to efficiently produce near-field light with augmented light intensity. The reason will be explained in detail below with reference to FIGS. 51 and 55 to 58.

As shown in FIG. 51, the light L′ shone on the scatterer 102 is produced by making the light from a light source unit (such as a semiconductor laser) 101 converge with a light-condensing element (unillustrated). The distribution of electric field vectors in the light before entering the light-condensing element is indicated by arrows (double-headed arrows) shown in the light beam LF′1 in FIG. 55. It should be noted that these arrows simply show the direction (polarization direction) of arbitrary electric field vectors in linearly polarized light.

For the sake of convenience, the side to which the corner of the scatterer 102 points will be called the T side, and the side opposite from that side, that is, the side to which the base of the scatterer 102 faces will be called the B side; moreover, the opposite sides across the line connecting the T and B sides (called the T-B direction) in which the two halves of the scatterer 102 are respectively located will be called the S1 and S2 sides. Thus, as viewed from the direction AX′1, that is, the direction AX′ from which the light L′ travels, the light beam LF′1 before entering the light-condensing element is illustrated as shown in FIG. 55. AX′ also represents the optical axis.

In the light beam LF′1 shown in FIG. 55, the S1 and S2 side parts thereof are polarized, as shown in FIG. 56, parallel to the incidence plane 191a assumed when the light beam LF′ 1 is incident on the scatterer 102 while being made to converge. Thus, in the light L′ before entering the light-condensing element, the S1 and S2 sides parts thereof are P-polarized when incident on the scatterer 102. In FIG. 56, the dotted-line arrows indicate the polarization direction of the light that travels to the scatterer 102 while being made to converge (i.e., the polarization direction of P-polarized light).

On the other hand, in the light beam LF′ 1 shown in FIG. 55, the light in the T and B side parts thereof is polarized, as shown in FIG. 57, perpendicular to the incidence plane 191b assumed when the light beam LF′1 is incident on the scatterer 102 while being made to converge. Thus, in the light before entering the light-condensing element, the light in the S1 and S2 sides parts thereof is S-polarized when incident on the scatterer 102. In FIG. 57, the dotted-line arrows indicate the polarization direction of the light that travels to the scatterer 102 while being made to converge (i.e., the polarization direction of S-polarized light).

Then, as viewed from the direction AX′2, that is, the direction AX′ from which the light L′ travels, the light beam LF′2 shone on the scatterer 102 is illustrated as shown in FIG. 58. That is, the light L′ shown on the scatterer 102 contains P-polarized light and S-polarized light. In this light L′ containing P-polarized light and S-polarized light, as described above, the S-polarized light does not contribute to producing localized plasmon. Thus, it can be said that part of the light (S-polarized light) is wasted. Hence, it can be said that the light-condensing technology disclosed in Patent Document 4 does produce near-field light with augmented light intensity but with poor efficiency.

### SUMMARY OF THE INVENTION

In view of the conventionally experienced disadvantages and inconveniences discussed above, it is an object of the present invention to provide a light-condensing head or the like that can efficiently produce near-field light with augmented light intensity.

To achieve the above object, according to the present invention, a light-condensing head is provided with: a light source unit; a light-condensing element that condenses the light emitted from the light source unit; and an electrically conductive scatterer that is arranged at the light condensation position of the light-condensing element and that produces localized plasmon when irradiated with light. Here, the light emitted from the light source unit contains, at least in part thereof, polarized waves that constitute a radiating electric field vector distribution. On the other hand, the electrically conductive scatterer has, in the light-receiving portion thereof that receives the light from the light-condensing element, rotation symmetry of order three or more (at least three-fold rotation symmetry).

### BRIEF DESCRIPTION OF THE DRAWINGS

The above and other objects and features of the present invention will become clear through the following description of preferred embodiments taken in conjunction with the accompanying drawings, in which:

FIG. 1 is a diagram schematically showing the construction of a light-condensing head according to the present invention;

FIG. 2 is a diagram schematically showing the construction of a HDD, as an example of a storage apparatus;

FIG. 3 is a diagram schematically showing the structure of a two-dimensional photonic crystal surface-emission laser;

FIG. 4 is a plan view of the two-dimensional structure of a photonic crystal;

FIG. 5 is a diagram illustrating emission of light inside a photonic crystal;

FIG. 6 is a band diagram of a two-dimensional photonic crystal having a square lattice;

FIG. 7A is a plan view showing the real lattice space of a square lattice;

FIG. 7B is a plan view showing the reciprocal lattice space determined from the real lattice space;

FIG. 7C is a plan view showing a Brillouin zone and an irreducible zone;

FIG. 8 is an enlarged view of part W in FIG. 6;

FIG. 9 is a diagram showing the electric field vector distribution in A mode;

FIG. 10 is a simplified diagram of FIG. 9;

FIG. 11 is a diagram showing the electric field vector distribution in B mode;

FIG. 12 is a simplified diagram of FIG. 11;

FIG. 13A is a perspective view of a plate-shaped electrically conductive scatterer having the shape of a perfect circle;

FIG. 13B is a perspective view showing localized plasmon produced around the plate-shaped electrically conductive scatterer shown in FIG. 13A;

FIG. 13C is a plan view of FIG. 13B;

FIG. 14A is a perspective view of a plate-shaped electrically conductive scatterer having the shape of a right quadrangle;

FIG. 14B is a perspective view of a plate-shaped electrically conductive scatterer having the shape of a right triangle;

FIG. 15A is a perspective view of an electrically conductive scatterer having the shape of a circular column;

FIG. 15B is a perspective view of an electrically conductive scatterer having the shape of a regular quadrangular column;

FIG. 15C is a perspective view of an electrically conductive scatterer having the shape of a regular triangular column;

FIG. 16A is a perspective view of an electrically conductive scatterer having the shape of a circular pyramid (cone);

FIG. 16B is a perspective view of an electrically conductive scatterer having the shape of a regular quadrangular pyramid;

FIG. 16C is a perspective view of an electrically conductive scatterer having the shape of a regular triangular pyramid;

FIG. 17 is an enlarged plan view of the tip end of an electrically conductive scatterer having a pyramidal shape;

FIG. 18A is a perspective view of an electrically conductive scatterer for producing surface plasmon, one having the shape of a perfect circle;

FIG. 18B is a perspective view of an electrically conductive scatterer for producing surface plasmon, one having a column-shaped protrusion;

FIG. 18C is a perspective view of an electrically conductive scatterer for producing surface plasmon, one having a pyramid-shaped protrusion;

FIG. 19 is a diagram schematically showing the structure of a light source unit;

FIG. 20A is a diagram illustrating how an electric field vector is changed by a wave plate when the direction of the former is the same as the orientation of the latter;

FIG. 20B is a diagram illustrating how an electric field vector is changed by a wave plate when the direction of the former is the same as the orientation of the latter, in a case different from that shown in FIG. 20A;

FIG. 20C is a diagram illustrating how an electric field vector is changed by a wave plate when the direction of the former is 90° inclined relative to the orientation of the latter;

FIG. 20D is a diagram illustrating how an electric field vector is changed by a wave plate when the direction of the former is 90° inclined relative to the orientation of the latter, in a case different from that shown in FIG. 20C;

FIG. 20E is a diagram illustrating how an electric field vector is changed by a wave plate when the direction of the former is 45° inclined relative to the orientation of the latter;

FIG. 20F is a diagram illustrating how an electric field vector is changed by a wave plate when the direction of the former is 45° inclined relative to the orientation of the latter, in a case different from that shown in FIG. 20E;

FIG. 20G is a diagram illustrating how an electric field vector is changed by a wave plate when the direction of the former is 45° inclined relative to the orientation of the latter, in a case different from those shown in FIGS. 20E and 20F;

FIG. 20H is a diagram illustrating how an electric field vector is changed by a wave plate when the direction of the former is 45° inclined relative to the orientation of the latter, in a case different from those shown in FIGS. 20E to 20G;

FIG. 21 is a diagram showing the electric field vector distribution obtained, when Scheme 1 is adopted for B-mode light, before the light passes through a first half-wave plate;

FIG. 22 is a diagram showing the electric field vector distribution obtained, when Scheme 1 is adopted for B-mode light, after the light has passed through the first half-wave plate;

FIG. 23A is a simplified diagram of FIG. 21;

FIG. 23B is a simplified diagram of FIG. 22;

FIG. 24 is a diagram showing the electric field vector distribution obtained, when Scheme 2 is adopted for B-mode light, before the light passes through a first half-wave plate;

FIG. 25 is a diagram showing the electric field vector distribution obtained, when Scheme 2 is adopted for B-mode light, after the light has passed through the first half-wave plate;

FIG. 26 is a diagram showing the electric field vector distribution obtained, when Scheme 2 is adopted for B-mode light, after the light has passed through a second half-wave plate;

FIG. 27 is a diagram showing the electric field vector distribution obtained, when Scheme 2 is adopted for B-mode light, after the light has passed through a third half-wave plate;

FIG. 28A is a simplified diagram of FIG. 24;

FIG. 28B is a simplified diagram of FIG. 25;

FIG. 28C is a simplified diagram of FIG. 26;

FIG. 28D is a simplified diagram of FIG. 27;

FIG. 29 is a diagram showing the electric field vector distribution obtained, when Scheme 3 is adopted for A-mode light, before the light passes through a first half-wave plate;

FIG. 30 is a diagram showing the electric field vector distribution obtained, when Scheme 3 is adopted for A-mode light, after the light has passed through the first half-wave plate;

FIG. 31 is a diagram showing the electric field vector distribution obtained, when Scheme 3 is adopted for A-mode light, before the light has passed through a second half-wave plate;

FIG. 32A is a simplified diagram of FIG. 29;

FIG. 32B is a simplified diagram of FIG. 30;

FIG. 32C is a simplified diagram of FIG. 31;

FIG. 33 is a diagram showing another example of the electric field vector distribution shown in FIG. 29;

FIG. 34 is a diagram showing another example of the electric field vector distribution shown in FIG. 30;

FIG. 35 is a diagram showing another example of the electric field vector distribution shown in FIG. 31;

FIG. 36A is a simplified diagram of FIG. 33;

FIG. 36B is a simplified diagram of FIG. 34;

FIG. 36C is a simplified diagram of FIG. 35;

FIG. 37A is a diagram illustrating how an electric field vector is changed by a polarization rotator with a rotating power of 0.25;

FIG. 37B is a diagram illustrating how an electric field vector is changed by a polarization rotator with a rotating power of 0.75;

FIG. 38 is a diagram showing the electric field vector distribution obtained, when Scheme 4 is adopted for A-mode light, after the light has passed through a polarization rotator;

FIG. 39 is a diagram showing the electric field vector distribution obtained, when Scheme 4 is adopted for B-mode light, after the light has passed through a polarization rotator;

FIG. 40A is a perspective view showing the electric and magnetic fields produced in a two-dimensional photonic crystal surface-emission laser (in TE lasing mode);

FIG. 40B is a perspective view showing the electric and magnetic fields produced in a two-dimensional photonic crystal surface-emission laser (in TM lasing mode);

FIG. 41 is a diagram showing the frequency response of the gain in the active layer;

FIG. 42 is a diagram showing the electric field vector distribution in AA-mode light;

FIG. 43 is a diagram showing the electric field vector distribution in BB-mode light;

FIG. 44 is a band diagram of a two-dimensional photonic crystal having a triangular lattice, the diagram being an enlarged view of part of the Γ point;

FIG. 45 is a diagram showing the electric field vector distribution in α-mode light;

FIG. 46 is a diagram showing the electric field vector distribution in β-mode light;

FIG. 47 is a diagram showing the electric field vector distribution obtained, when Scheme 4 is adopted for β-mode light, after the light has passed through a polarization rotator;

FIG. 48 is a diagram showing the electric field vector distribution in αα-mode light;

FIG. 49 is a diagram showing the electric field vector distribution in ββ-mode light;

FIG. 50A is a diagram illustrating, in simplified form, part of the relationship of the light source unit among embodiments 1 to 4;

FIG. 50B is a diagram illustrating, in simplified form, the rest of the relationship of the light source unit among embodiments 1 to 4;

FIG. 51 is a perspective view of a conventional near-field light generating apparatus employing a scatterer that generates localized plasmon;

FIG. 52 is a plan view of a radially polarized beam;

FIG. 53A is a diagram illustrating how an electric field vector is changed by a polarization rotator with a rotating power of 0.00;

FIG. 53B is a diagram illustrating how an electric field vector is changed by a polarization rotator with a rotating power of 0.25;

FIG. 53C is a diagram illustrating how an electric field vector is changed by a polarization rotator with a rotating power of 0.50;

FIG. 53D is a diagram illustrating how an electric field vector is changed by a polarization rotator with a rotating power of 0.75;

FIG. 54 is a perspective view schematically showing a combined polarization rotator;

FIG. 55 is a diagram showing the electric field vector distribution of light before entering a light-condensing element;

FIG. 56 is a diagram illustrating why P-polarized light is produced;

FIG. 57 is a diagram illustrating why S-polarized light is produced;

FIG. 58 is a diagram showing an electric field vector distribution where P-polarized light and S-polarized light coexist;

FIG. 59 is a diagram illustrating why only P-polarized light is produced when a radially polarized beam has passed through a light-condensing element;

FIG. 60 is a diagram showing the polarization direction along one of the two directions shown in FIG. 9; and

FIG. 61 is a diagram showing the polarization direction along the other of the two directions shown in FIG. 9.

### DETAILED DESCRIPTION OF PREFERRED EMBODIMENTS

### Embodiment 1

An embodiment of the present invention will be described below with reference to the drawings. It should be noted that, in the following description, radially polarized waves are indicated as “R” some times but not at other times, in which latter case it is to be understood that reference to another drawing is requested.

1. Construction of a Storage Apparatus

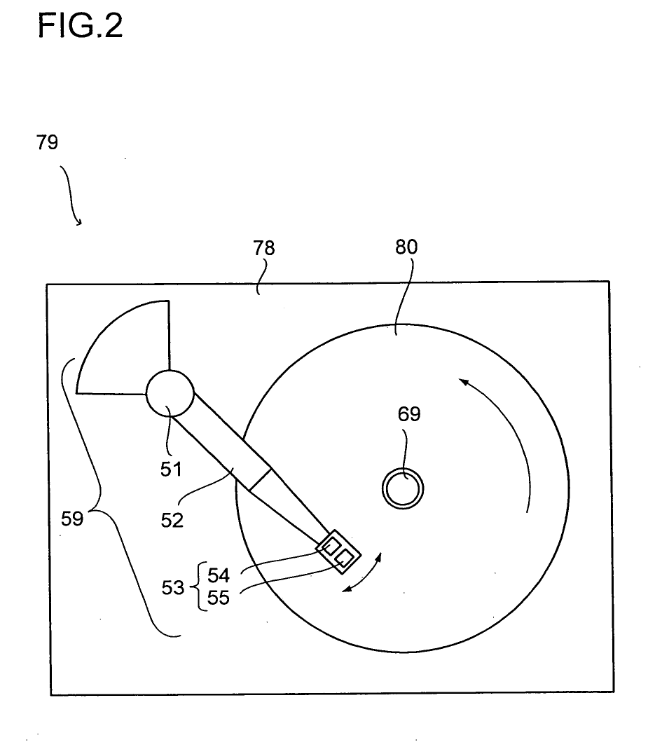

FIG. 2 is a diagram schematically showing the construction of a HDD 79 adopting heat-assisted magnetic recording, as an example of a storage apparatus. As shown in the figure, the HDD 79 includes, housed inside a housing 78: a spindle motor 69 that holds and rotates a magnetic recording medium (disk) 80; and an actuator assembly 59.

The actuator assembly 59 has an actuator arm 52 that is rotatable on a pivot (rotary shaft) 51. At the non-pivoted end of the actuator arm 52, a head unit 53 is fitted.

The head unit 53 includes: a magnetic head 54 that writes and reads magnetic information to and from the disk 80; and a light-condensing head 55 that heats a spot on the disk 80 when magnetic information is written thereto.

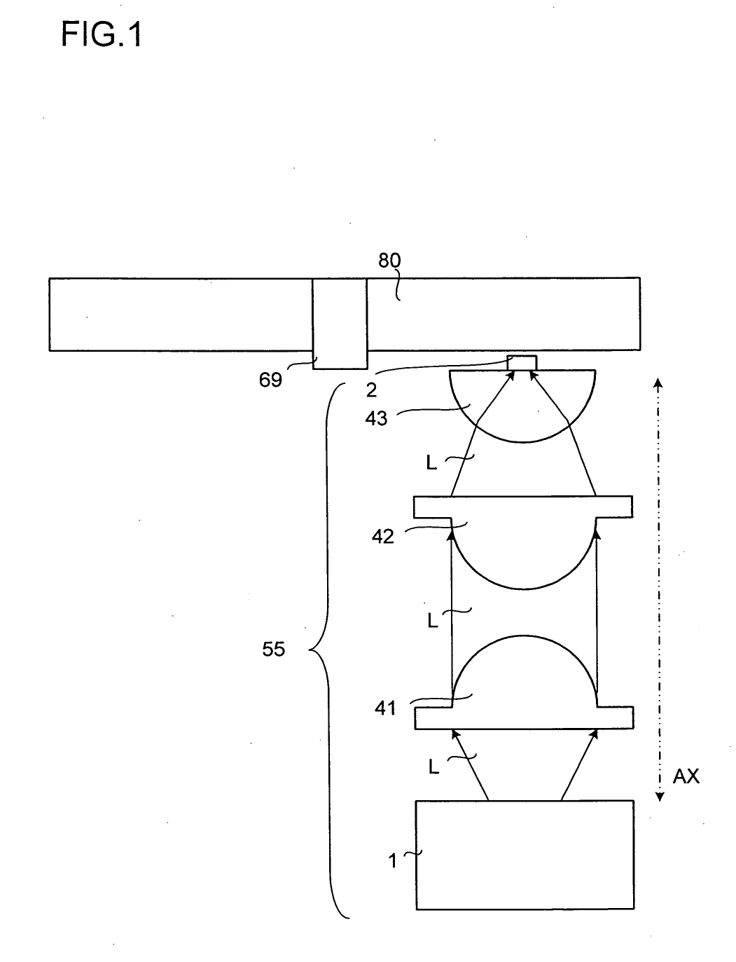

The light-condensing head 55 shines a very small light spot on the disk 80 and thereby instantaneously heats the irradiated part to cause a drop in the coercivity of the disk 80. On the other hand, the magnetic head 54 writes magnetic information to the disk 80, whose coercivity is thus lower now. Hence, for higher recording capacity, it is preferable that the size of the light spot be as small as possible. Accordingly, the light-condensing head 55 is constructed as shown in FIG. 1. In FIG. 1, in the light-condensing head 55, the light from the light source unit 1 is indicated by L, and the optical axis of the light L is indicated by AX.

As shown in FIG. 1, the light-condensing head 55 includes a light source unit 1, a collimator lens 41, an objective lens (light-condensing element) 42, a hemispherical lens (light-condensing element) 43, and an electrically conductive scatterer 2. The light source unit 1 may be anything that emits light L (laser light), and is not subject to any particular limitation. The light source unit 1 will be described in detail later.

The collimator lens 41 converts the light emitted from the light source unit 1 into parallel light. The objective lens 42 condenses the parallel light from the collimator lens 41 onto the hemispherical lens 43. The objective lens 42 further condenses the light onto the electrically conductive scatterer 2, which is fitted on the hemispherical lens 43. Thus, the electrically conductive scatterer 2 is located at the position, called the light condensation position, onto which the light that has passed through the objective lens 42 and the hemispherical lens 43 is condensed.

The electrically conductive scatterer 2 receives the thus condensed light to produce localized plasmon. The electrically conductive scatterer 2 will be described in detail later.

2. Light Source Unit

2-1. Photonic Crystal Surface-Emission Laser

Various types of light source unit 1 can be used in storage apparatuses. Here, as one of usable examples, a semiconductor laser employing a two-dimensional photonic crystal (a two-dimensional photonic crystal surface-emission laser, or 2-D PCL) will be taken up. A photonic crystal denotes a crystal having a structure with a periodic refractive index distribution.

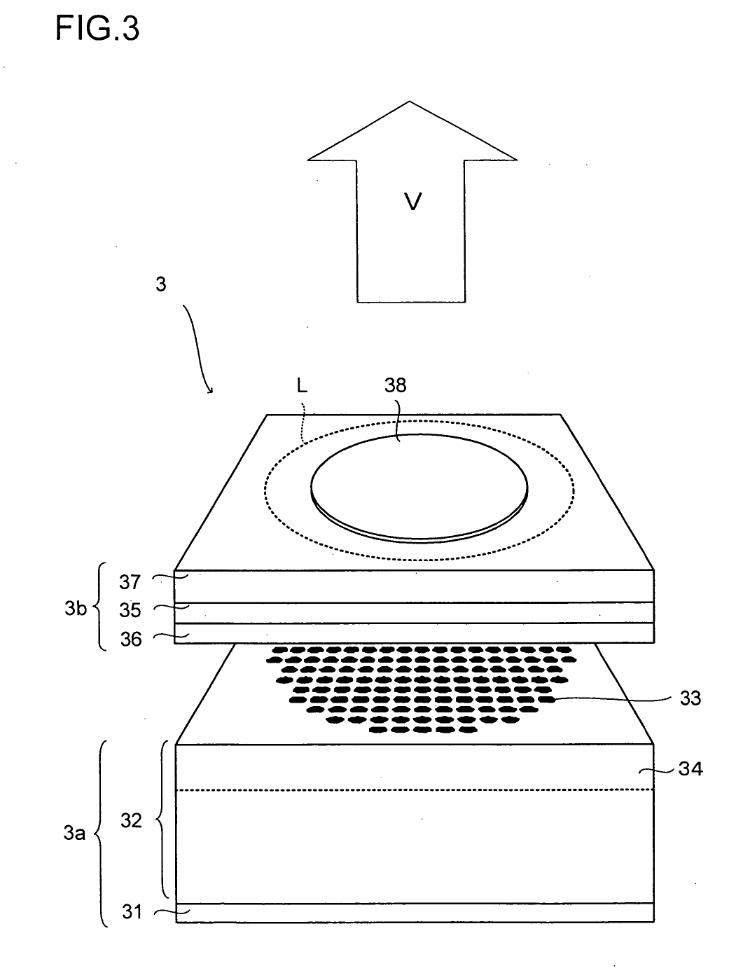

As shown in FIG. 3, the photonic crystal surface-emission laser (light-emitting element) 3 includes two substrates 3a and 3b. The first substrate 3a includes: a first electrode 31; and a first n-type clad layer 32 laid to overlap the first electrode 31.

The first n-type clad layer 32 is formed of, for example, an n-type semiconductor material. On the surface (two-dimensional surface) of the first n-type clad layer 32, dimples (openings) 33 are arrayed in two dimensions by electron beam exposure and dry etching processes (for example, the dimples (lattice points) 33 are arrayed in a square lattice). Here, the difference in refractive index between the air inside the dimples 33 and the p-type semiconductor material produces a two-dimensional periodic refractive index distribution (establishes a two-dimensional periodic structure). Thus, the first n-type clad layer 32 contains a photonic crystal 34.

On the other hand, the second substrate 3b includes: an active layer 35 that emits light when charged particles (carriers) are injected thereinto; a second n-type clad layer 36 and a p-type clad layer 37 that sandwich the active layer 35 between them; and a second electrode 38 that is laid to overlap the p-type clad layer 37.

When the first substrate 3a and the second substrate 3b are fused together with the surface of the first n-type clad layer 32 of the former facing the second n-type clad layer 36 of the latter, the photonic crystal surface-emission laser (2-D PCL) 3 is complete. With this 2-D PCL 3, when a voltage is applied between the electrodes 31 and 38, the active layer 35 emits light, and light leaking from the active layer 35 (evanescent waves) reaches the photonic crystal 34. The light that has reached there is resonated by the photonic crystal 34, thereby achieving laser oscillation. The laser light is diffracted by the photonic crystal into the direction perpendicular to one surface of the p-type clad layer 37 of the second substrate 3b so as to eventually emerge outside.

2-2. Resonance in the Photonic Crystal

Now, the resonating action of the photonic crystal 34 will be described. In the following description (of embodiments 1 to 3), as an example of the two-dimensional periodic structure, a square lattice structure will be taken up throughout.

The photonic crystal 34 has a periodic refractive index distribution. This periodic refractive index distribution is similar to the periodic array of atoms in a solid crystal. Thus, a band theory (for example, a band diagram) that represents the movement of electrons propagated in a crystal can be applied to photons propagated through the photonic crystal 34. That is, it is believed that, just as electrons in a solid crystal form a band structure with periodic potentials, so photons in the photonic crystal 34 form a band structure (photonic band structure).

The technology underlying the photonic crystal surface-emission laser 3 is that which exploits the phenomenon of light becoming standing waves at a position called a band edge (for example, the Γ point) in a photonic band structure (see Non patent documents 1 to 3 listed below).
Non-patent Document 1: H. Yokoyama, M. Imada, and S. Noda, “Two-Dimensional Photonic Crystal Surface-Emission Lasers”, Material Stage, vol. 1, no. 12, pp. 23-29, 2002.
Non-patent Document 2: H. Yokoyama and S. Noda, “Two-Dimensional Photonic Crystal Lasers”, Chemical Industry, vol. 53, pp. 844-851, 2002.
Non-patent Document 3: H. Yokoyama and S. Noda, “Two-Dimensional Photonic Crystal Surface-Emission Lasers”, The journal of the Japan Society of Infrared Science and Technology, vol. 12, pp. 17-23, 2003.

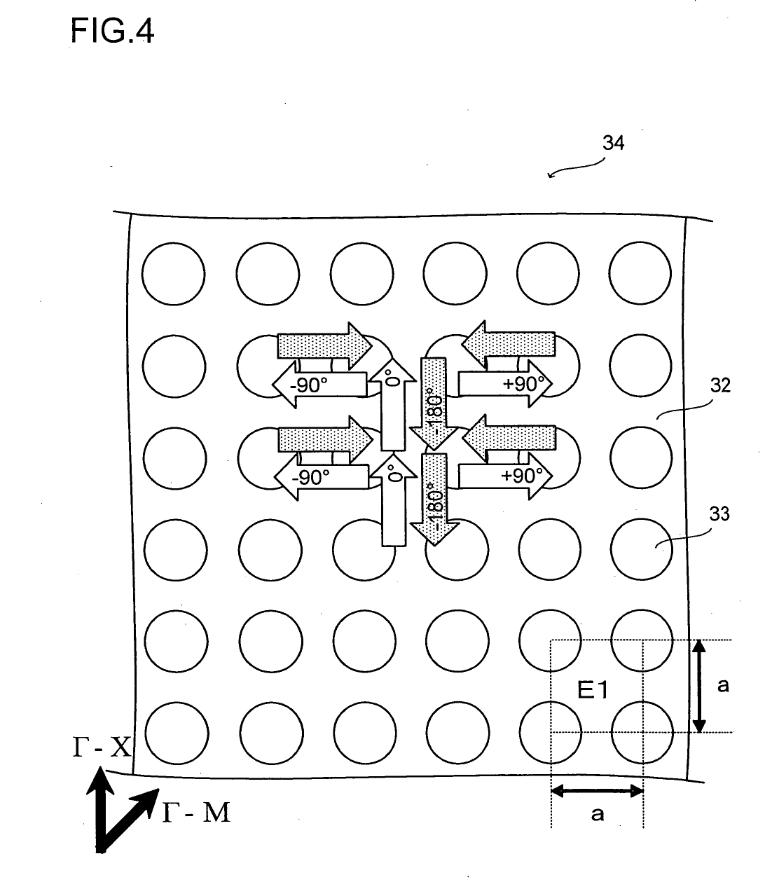

This laser technology exploits the resonance that occurs when an integer times a within-the-photonic-crystal-plane component of the wavelength (λ) of the light that enters a photonic crystal 34 is equal to the lattice interval (pitch) of the photonic crystal 34. As shown in FIG. 4, in the photonic crystal 34, the square lattice has periodicity in two representative directions (the Γ-X direction and the Γ-M direction). Thus, for example, let the lattice interval in the Γ-X direction be “a”, then it can be said that, within the plane, there exist a plurality of lattice segments (fundamental lattices E1) of which each is a square measuring “a” at each side (in the figure, the arrows with hollow and dotted insides represent light waves).

Here, when light waves whose within-the-photonic-crystal-plane components have a wavelength λ equal to the lattice interval “a” travel in any Γ-X direction (in this case, the F-X direction is called “0°”), part of the light waves continue to travel in the “0°” direction, and the rest are diffracted at lattice points 33. Specifically, by Bragg diffraction, these light waves are diffracted at “±90°” and “180°” relative to the light wave travel direction. Furthermore, since the lattice points 33 exist where the thus diffracted light heads for, again, part of the diffracted light continues to travel in the “0°” direction, and the rest is diffracted at “±90” and “180°” relative to the travel direction (of the symbol “±”, “+” indicates a clockwise rotation relative to the light wave travel direction, and “−” indicates a counter-clockwise rotation relative to the light wave travel direction.

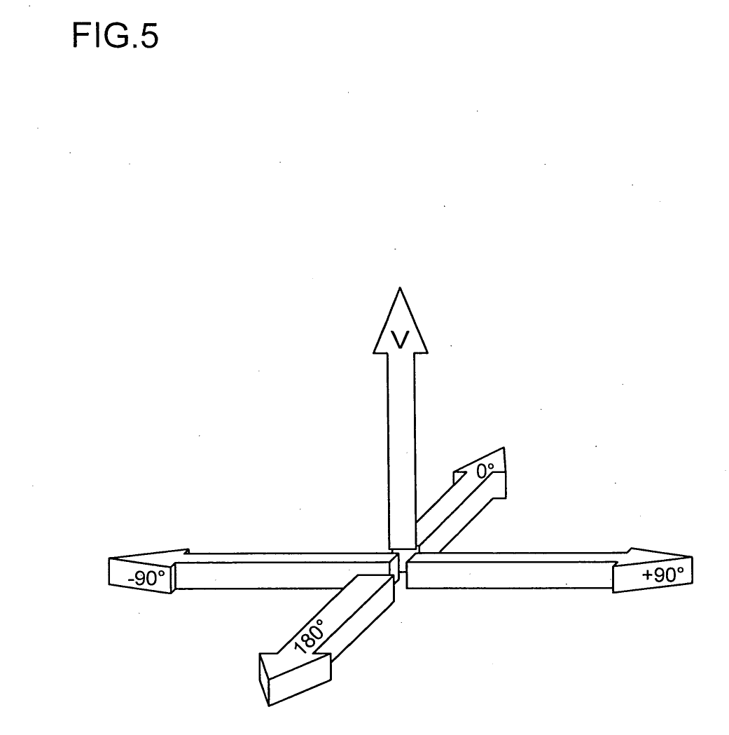

As shown in FIG. 5, these four varieties of light (traveling at “0°”, “±90°”, and “180°”) couple together to initiate resonance. Moreover, in the direction V perpendicular to those directions (i.e., in the perpendicular direction V relative to the lattice plane), Bragg diffraction occurs. Thus, the laser light produced by resonance emerges in the vertical direction V relative to the lattice plane of the photonic crystal 34 (i.e., the V direction is the travel direction of the laser light).

The description thus far has dealt with an example where the fundamental period “a” in the Γ-X direction is equal to the wavelength “λ” of light. Other than that specific example, resonance as described above occurs wherever any period present within the two-dimensional periodic structure of a photonic crystal is equal to an integer times a within-the-photonic-crystal-plane component of the wavelength of light.

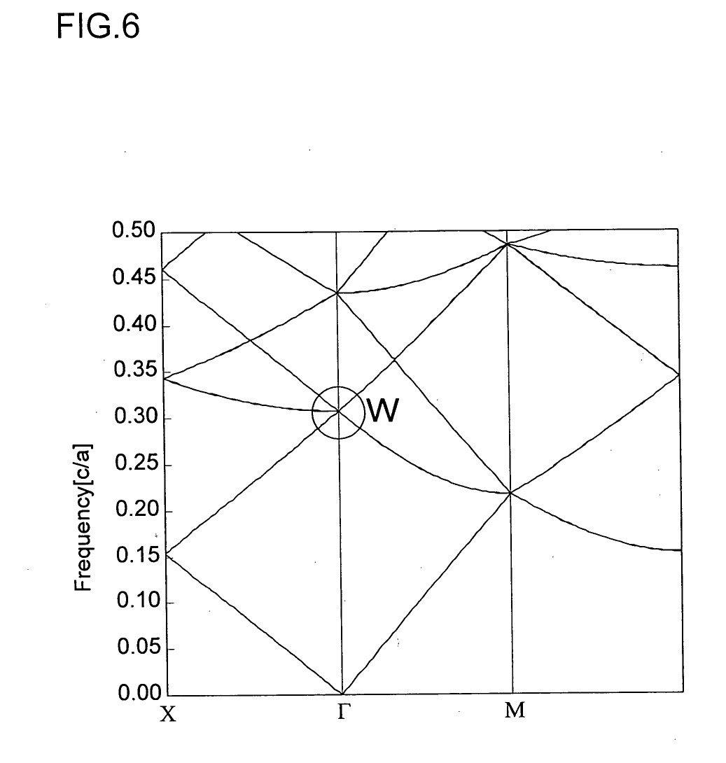

Next, two-dimensional resonance employing the photonic crystal 34 will be described more quantitatively; for that purpose, it will now be explained with reference to a band diagram (photonic band diagram) that shows a light scattering relationship. FIG. 6 is a band diagram of the photonic crystal 34, which has a square lattice structure. In this band diagram, “a” represents the lattice interval (in m), and “c” represents the speed of light (in m/sec); the vertical axis represents the normalized frequency (the energy of light) calculated by non-dimensionalizing the frequency of light by multiplying it by “a/c”; the horizontal axis represents the wave number vector. The Γ, X, and M points on the horizontal axis of the band diagram represent the vertices of the irreducible zone in the Brillouin zone.

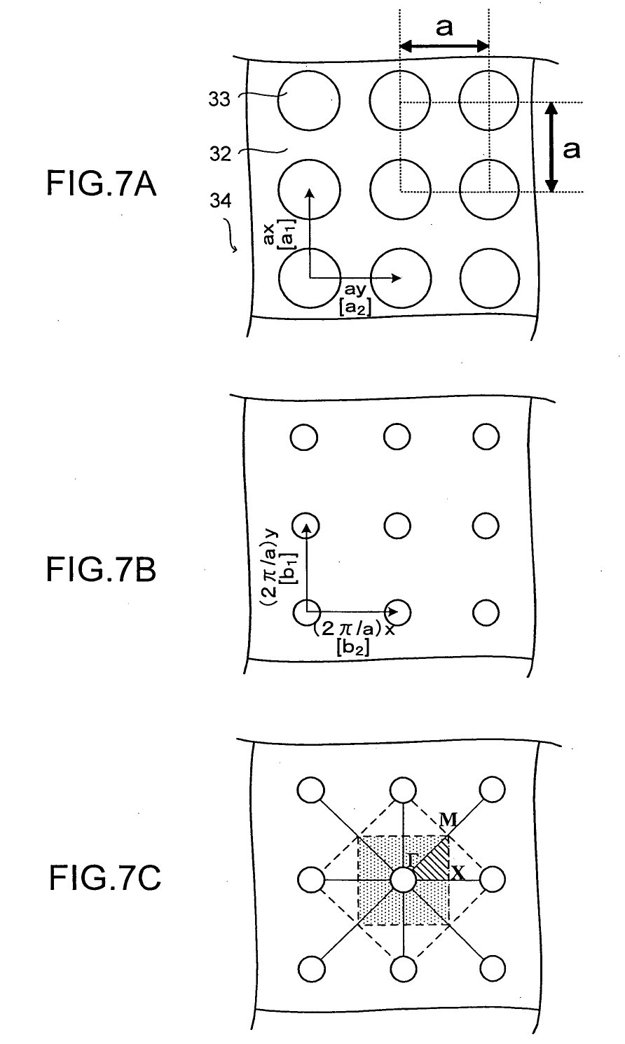

The Brillouin zone denotes the fundamental domain of the wave number vector in the reciprocal lattice space determined from the real lattice space. The irreducible zone denotes the domain that repeats the same characteristics within the Brillouin zone, and is, in the case of a square lattice, a domain having the shape of rectangular triangle. The real lattice space of the square lattice described above is shown in FIG. 7A, and the reciprocal lattice space determined from the real lattice space is shown in FIG. 7B. The Brillouin zone is indicated as a shaded area in FIG. 7C, and the irreducible zone is indicated as a hatched area in FIG. 7C.

In FIG. 7A, let the fundamental translation vectors in the square lattice with the lattice interval “a” be “a₁” and “a₂”, and let the unit vectors of the rectangular coordinate system be “x” and “y”, then “a₁” and “a₂” are expressed by the following formulae:
a₁=ax
a₂=ay

On the other hand, the reciprocal lattice fundamental vectors “b₁” and “b₂” corresponding to those fundamental translation vectors “a₁” and “a₂” are given by are expressed by the following formulae. (see FIG. 7B):
b₁=(2π/a)y
b₂=(2π/a)x

Then, it can be said that the Γ point can be said to be a point where the component of the wave number vector k of light as mapped within the photonic crystal plane has the value fulfilling, in terms of the reciprocal lattice fundamental vectors “b₁” and “b₂”, formula (0) below:
k=nb₁+mb₂ (0)
where “n” and “m” are arbitrary integers.

Thus, “a state where any period present within the two-dimensional periodic structure of a photonic crystal is equal to an integer times a within-the-photonic-crystal-plane component of the wavelength of light” can be said to be “a state of a photonic band structure where the wave number vector is at the Γ point”.

A location where resonance occurs as described above (a location where standing waves occur) can be said to be located, in the band diagram of FIG. 6, where the group velocity of light is equal to zero (“0”). Since the group velocity of light is expressed as ∂ω/∂k, the inclination of the band diagram represents the group velocity of light (ω represents the angular velocity, and k represents the magnitude of the wave number). Then, it can be said that there exit a plurality of locations where the inclination equals “0” and thus resonance occurs, and these locations, like the X and M points as well as the Γ point, are located at the edge of the Brillouin zone.

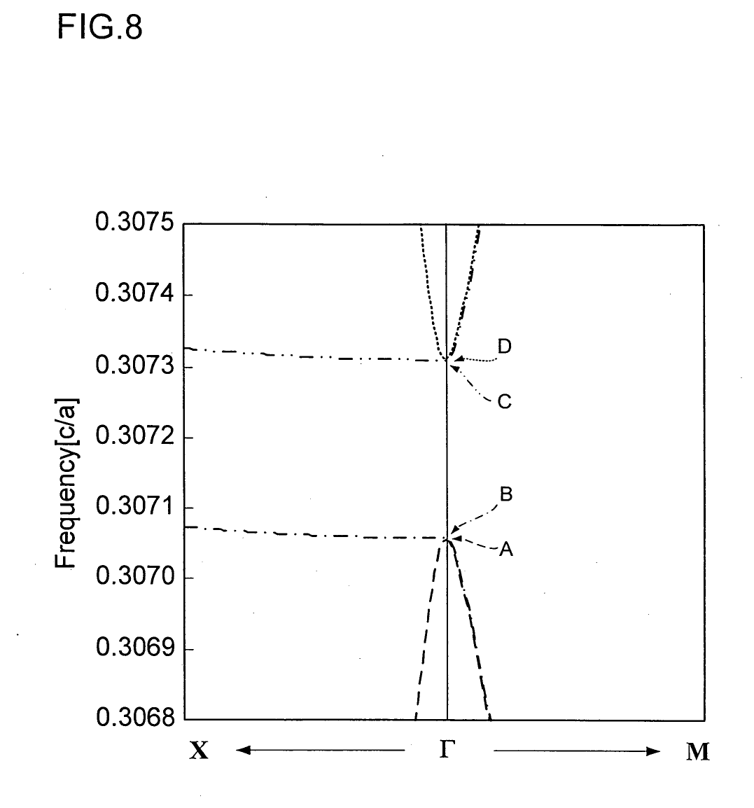

The resonance that occurs when the F-X direction period is equal to the wavelength is that which occurs at the band edge (point W) at the point Γ where the inclination equals “0”. On the other hand, it is known that, at the point W, there exist four band edges (A to D) as shown in FIG. 8. It should be noted that not all of these four bands (A to D) are suitable for laser oscillation (see Non-patent Documents 4 and 5 listed below).
Non-patent Document 4: H. Yokoyama and S. Noda, “Finite-Difference Time-Domain Simulation of Two-Dimensional Photonic Crystal Surface-Emitting Laser Having a Square-Lattice Slab Structure”, IEICE Trans. On Electron., vol. E87-C, pp. 386-392, 2004.
Non-patent Document 5: H. Yokoyama and S. Noda, “Finite-Difference Time-Domain Simulation of Two-Dimensional Photonic Crystal Surface-Emitting Laser”, Optics Express, vol. 13, pp. 2869-2880, 2005.

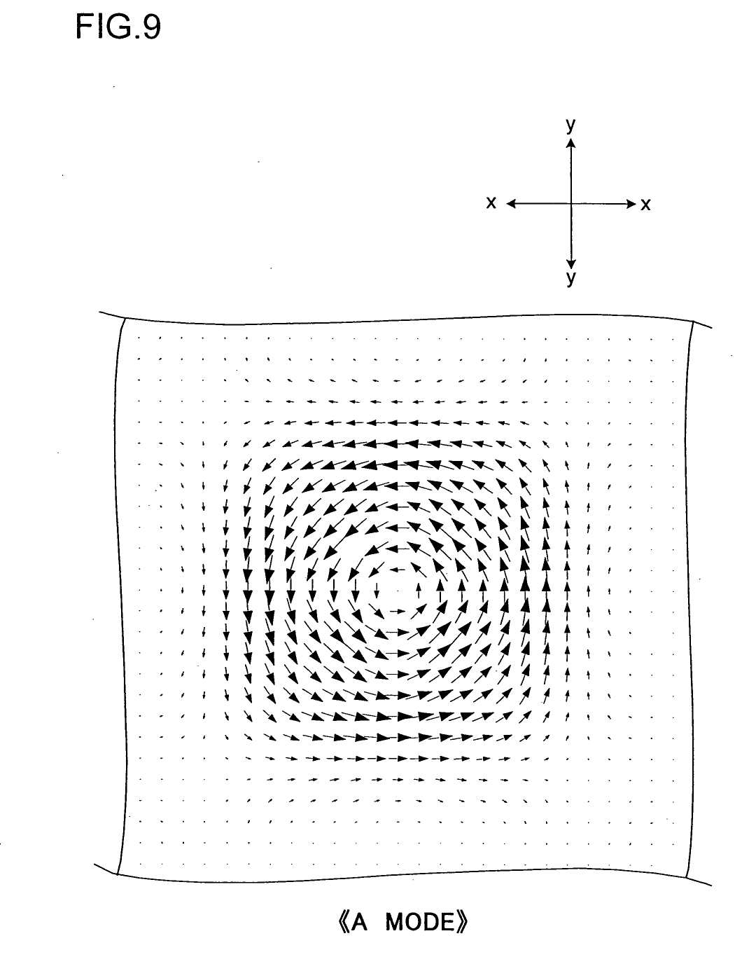

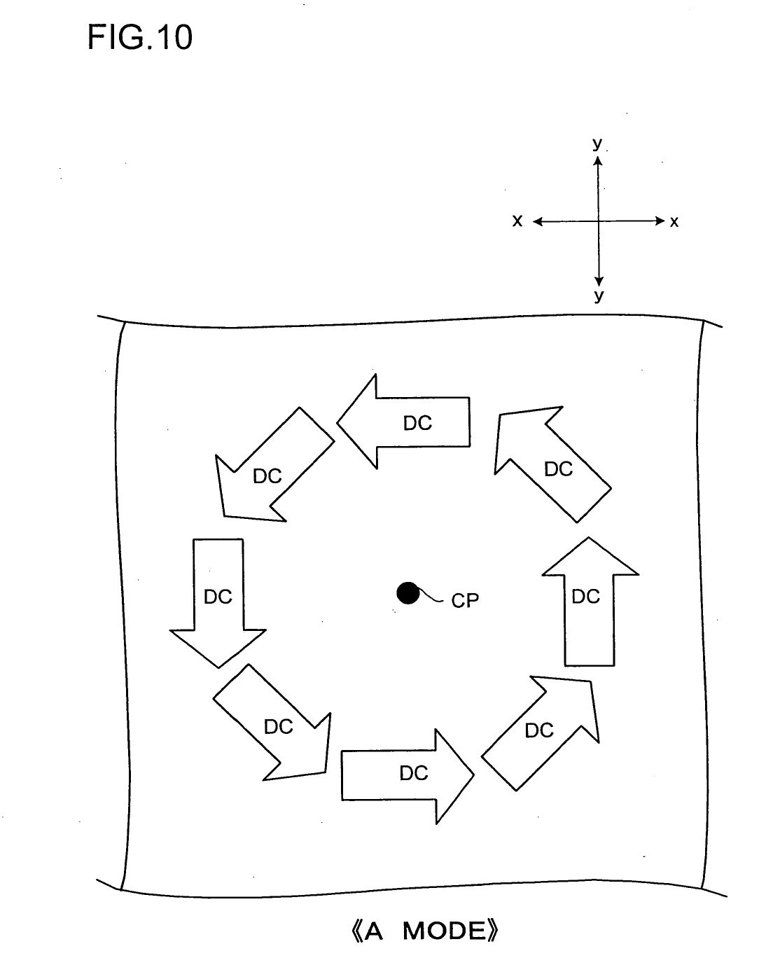

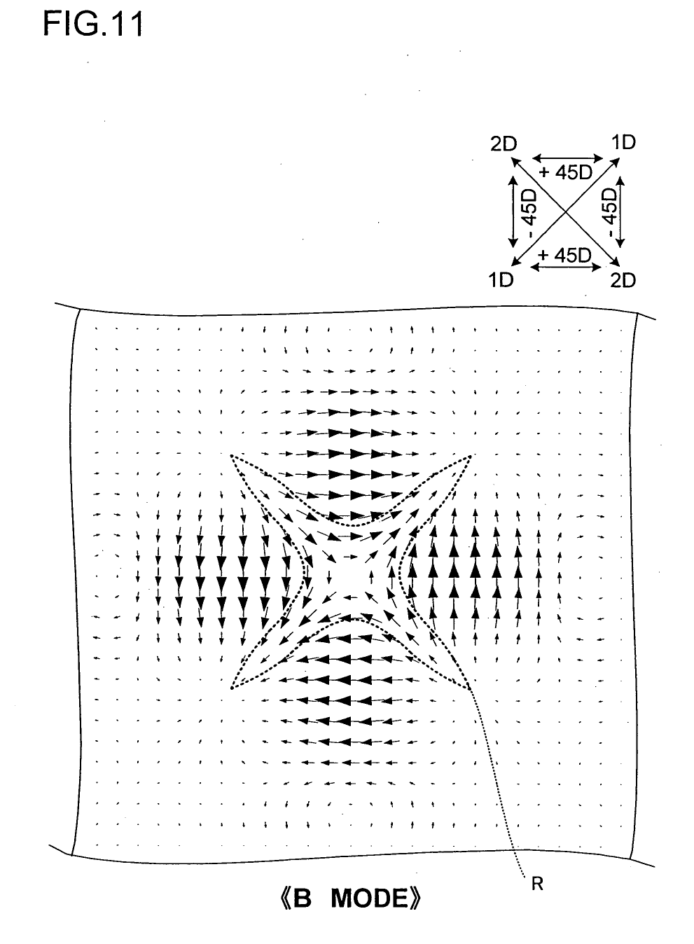

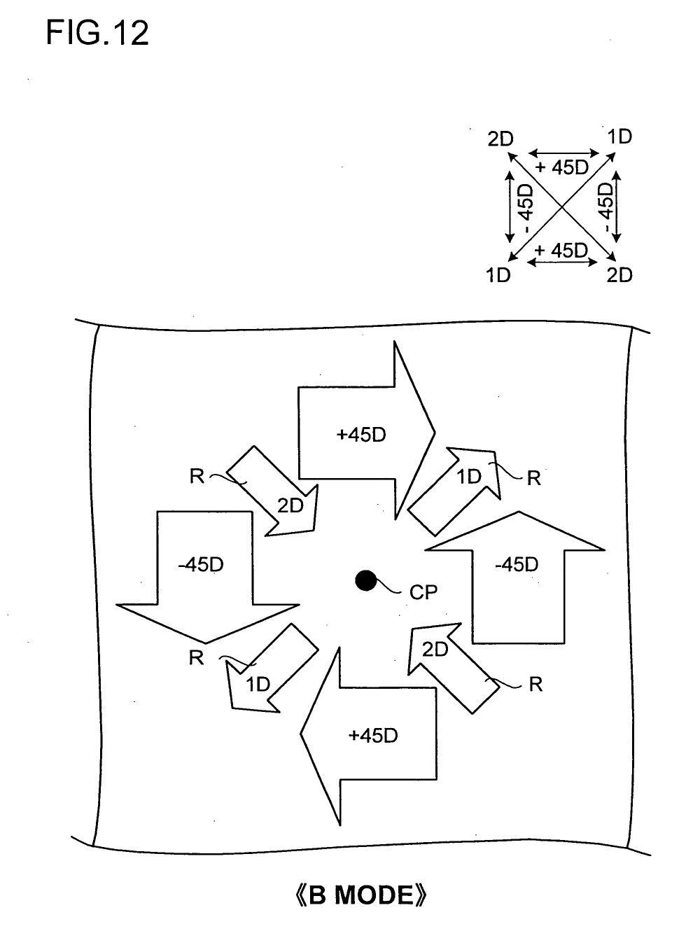

Specifically, in the example shown in FIG. 8, the band edge A with the lowest resonance frequency and the band edge B with the second lowest resonance frequency are suitable for laser oscillation; on the other hand, the band edge C with the highest resonance frequency and the band edge D with the second highest resonance frequency are unsuitable for laser oscillation. The resonance that occurs at the band edge A is called “A mode” resonance, and the resonance that occurs at the band edge B is called “B mode” resonance. The electric field vector distribution (state of polarization) during light oscillation in A mode is shown in FIG. 9 and FIG. 10 (a simplified version of FIG. 9), and the electric field vector distribution (state of polarization) during light oscillation in B mode is shown in FIG. 11 and FIG. 12 (a simplified version of FIG. 11).

These diagrams show the electric field vector distribution observed on an arbitrary cross-sectional plane perpendicular to the light emergence direction (how electric field vectors are distributed in an arbitrary cross-sectional plane of the light beam). The direction of arrows represent the direction of electric field vectors (polarization direction), and the length of arrows represent the magnitude of the electric field vectors (light intensity).

As shown in FIGS. 9 and 10, in the electric field vector distribution in A mode, the electric field vectors point in such a direction as to rotate about the center of the light beam (center of rotation CP) (i.e., in the azimuth angle direction (in the circumferential direction) DC). Moreover, the electric field vectors have equal magnitudes at equal distances from the center of the light beam (center of rotation CP). Thus, in A mode, the light from the 2-D PCL 3 contains, at least in part thereof, electric field vectors that constitute a rotation-symmetric electric field vector distribution, that have equal magnitudes at equal distances from the center of rotation symmetry CP, and that point in the azimuth angle direction DC.

On the other hand, as shown in FIGS. 11 and 12, the electric field vectors in B mode have, at least in part thereof, two different, mutually perpendicular directions (1D and 2D), and constitute an electric field vector distribution that has rotation symmetry of order four (four-fold rotation symmetry). In addition, these electric field vectors having has rotation symmetry of order four point in the direction radiating from the center of rotation symmetry CP (in the radial direction). Such electric field vectors that are rotation-symmetric, that constitute a radiating electric field vector distribution, and that have equal magnitudes at equal distances from the center of rotation symmetry will be called radially polarized waves R. Instead, electric field vectors that show a radial distribution may be called polarized waves.

Relative to the first (1D) of the two directions mentioned above, a clockwise azimuth angle is given a positive sign “+”, and a counter-clockwise azimuth angle is given a negative sign “−”. Then, the electric field vectors in B mode can be said to contain radially polarized waves R, electric field vectors pointing in the direction +45° inclined relative to the first direction (1D) (the +45° direction; +45D), and electric field vectors pointing in the direction −45° inclined relative to the first direction (1D) (the −45° direction; −45D). In B-mode light, the radially polarized waves R occupy a smaller proportion than the electric field vectors in the +45° and −45° directions (+45D and −45D).

3. Electrically Conductive Scatterer

Next, the electrically conductive scatterer 2 will be described. The electrically conductive scatterer 2 may be anything that, when irradiated with the light (especially, P-polarized light) from the light source unit 1, produces localized plasmon. The electrically conductive scatterer 2 is formed of, for example, gold (Au), silver (Ag), aluminum (Al), chromium (Cr), or magnesium (Mg).

3-1. Exploiting Localized Plasmon

As described previously, localized plasmon is produced by P-polarized light. On the other hand, in the 2-D PCL 3, A-mode light (see FIGS. 9 and 10) having passed through the objective lens 42 and the hemispherical lens 43 only contains S-polarized light. Thus, even when A-mode light is shone on the electrically conductive scatterer 2, no localized plasmon is produced.

On the other hand, the radially polarized waves R in B-mode light (see FIGS. 11 and 12) having passed through the objective lens 42 and the hemispherical lens 43 partly contain P-polarized light. Thus, when B-mode light is shone on the electrically conductive scatterer 2, owing to the radially polarized waves R, localized plasmon is produced.

Here, if the electrically conductive scatterer 2 (more precisely, the light-receiving portion 2a thereof; see FIG. 13A) is so shaped as to suit the light of the radially polarized waves R, it is possible to efficiently produce localized plasmon. Specifically, it is preferable that the light-receiving portion 2a of the electrically conductive scatterer 2 have rotation symmetry within the plane perpendicular to the optical axis AX of the light from the 2-D PCL 3 (for example, it is preferable that the electrically conductive scatterer 2 be a plate (perfectly circular plate) having the rotation-symmetric shape of a perfect circle.

In such a structure, the electric charges in the rotation-symmetric light-receiving portion 2a and the radially pointing electric field vectors (here, rotation-symmetric and radially pointing electric field vectors (i.e., the electric field vectors of the radially polarized waves R)) oscillate radially. Then, as shown in FIGS. 13B and 13C (the latter being a plan view of the former), further in the radial direction, that is, in the edge part EG of the electrically conductive scatterer 2, localized plasmon LP is produced. When this localized plasmon LP is produced, by the electric field augmenting effect it exerts, the light intensity of near-field light is augmented.

The near-field light having its light intensity augmented by localized plasmon in this way is condensed into about the size of the light-receiving portion 2a. Thus, so long as the light-receiving portion 2a is appropriately sized, even when the localized plasmon is hollow in a central part thereof, it is practically possible to ignore the hollow part.

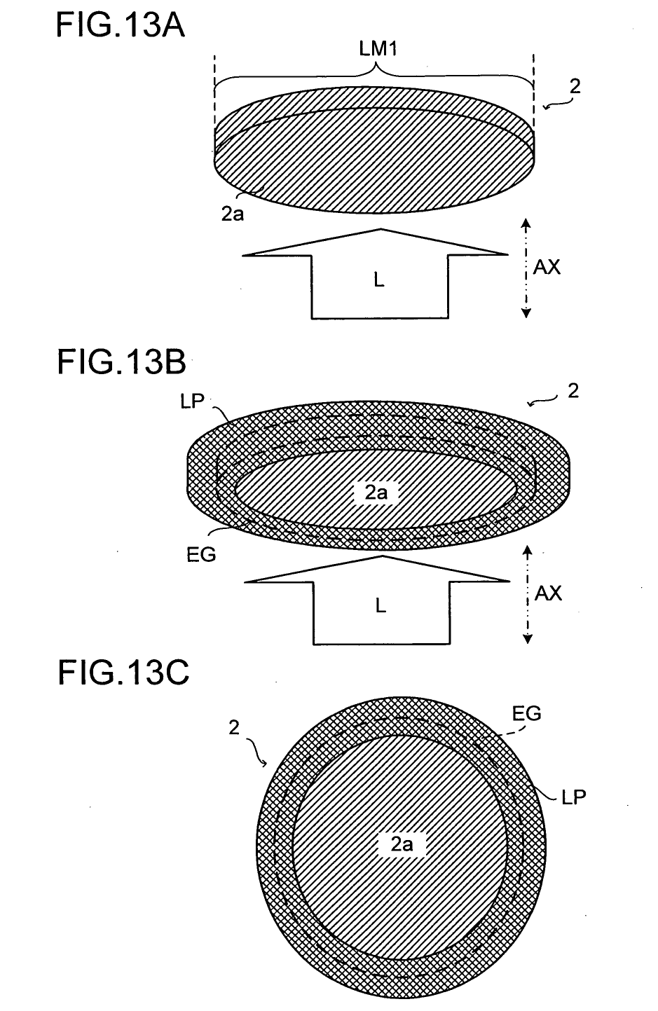

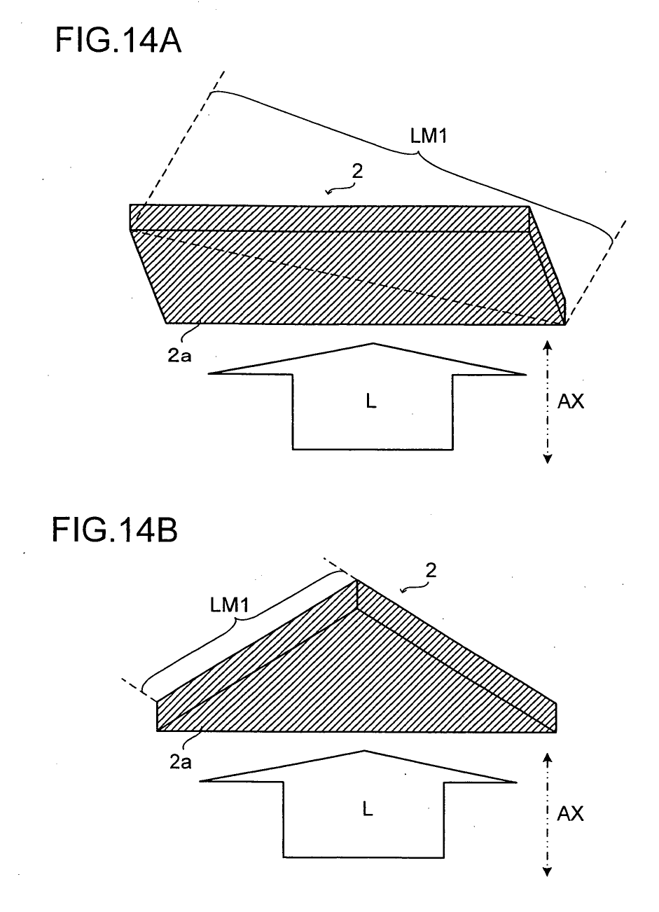

The radially polarized waves R in B-mode light have been described to have rotation symmetry of order four (four-fold rotation symmetry), but the rotation symmetry of the electrically conductive scatterer 2 is not limited to that of order four. Rather, the higher the order of rotation symmetry the electrically conductive scatterer 2 has, the more efficiently localized plasmon LP can be produced. Accordingly, the electrically conductive scatterer 2 may be formed as a plate having the shape of a right quadrangle (a right quadrangular plate), which has rotation symmetry of order four as shown in FIG. 14A, or as a plate having the shape of a perfect circle (a perfect circular plate), which has rotation symmetry of order infinity as shown in FIG. 13A.

Even with an electrically conductive scatterer 2 formed as a plate having the shape of a right triangle (a right triangular plate), which has rotation symmetry of order three, it is possible to produce localized plasmon LP more efficiently than with an electrically conductive scatterer having no rotation symmetry. What is important here is that the light-receiving portion 2a of the electrically conductive scatterer 2 has the shape of a perfect circle, a right triangle, or a more-sided right polygon.

It is preferable that, in addition, the electrically conductive scatterer 2 fulfill conditional formula (1) below:
λ/1 000≦LM1≦λ/10 (1)
where
LM1 represents the maximum width dimension (nm) of the light-receiving portion 2a of the electrically conductive scatterer 2 irradiated with light; and
λ represents the wavelength (nm) of the light (the wavelengths of the light emitted from the light source unit 1).

The size of the near-field light having its light intensity augmented by localized plasmon LP is proportional to the size of the electrically conductive scatterer 2. Therefore, if the electrically conductive scatterer 2 is improperly sized, the near-field light may inconveniently lower the function of the light-condensing head 55 (and hence that of the HDD 79). This inconvenience can be avoided when the electrically conductive scatterer 2 is so sized as to fulfill the range defined by conditional formula (1). The maximum width dimension of the light-receiving portion 2a is, for example where it is perfectly circular, its diametrical dimension; where it is right quadrangular, its diagonal dimension; and, where it is right triangular, the dimension of each side thereof (i.e., where it is right polygonal, the dimension of its longest diagonal).

If the upper limit of conditional formula (1) is violated, the width dimension of the light-receiving portion 2a is comparatively large. As a result, the localized plasmon LP produced near the edge part EG of the electrically conductive scatterer 2 is hollow in a central part thereof. That is, the larger the width dimension of the electrically conductive scatterer 2 is, the larger the distance between the opposite edges (edge-to-edge distance) is, producing ring-shaped localized plasmon LP.

With such ring-shaped localized plasmon LP, its hollow central part makes the near-field light non-uniform (it is impossible to produce near-field light with uniform light intensity). Thus, the disk 80 is then irradiated with a light spot of the ring-shaped near-field light, and therefore the temperature of its irradiated part does not rise uniformly (Problem 1).

On the other hand, if the lower limit of conditional formula (1) is violated, the width dimension of the light-receiving portion 2a is unduly short. As a result, even when the light-receiving portion 2a is irradiated with light, it is difficult to produce localized plasmon LP itself. Moreover, light that has circumvented being intercepted by the light-receiving portion 2a directly strikes the disk 80, producing noise (Problem 2).

Within the range defined by conditional formula (1), both Problems 1 and 2 are avoided, and the light-condensing head 55 emits near-field light suitable for the disk 80.

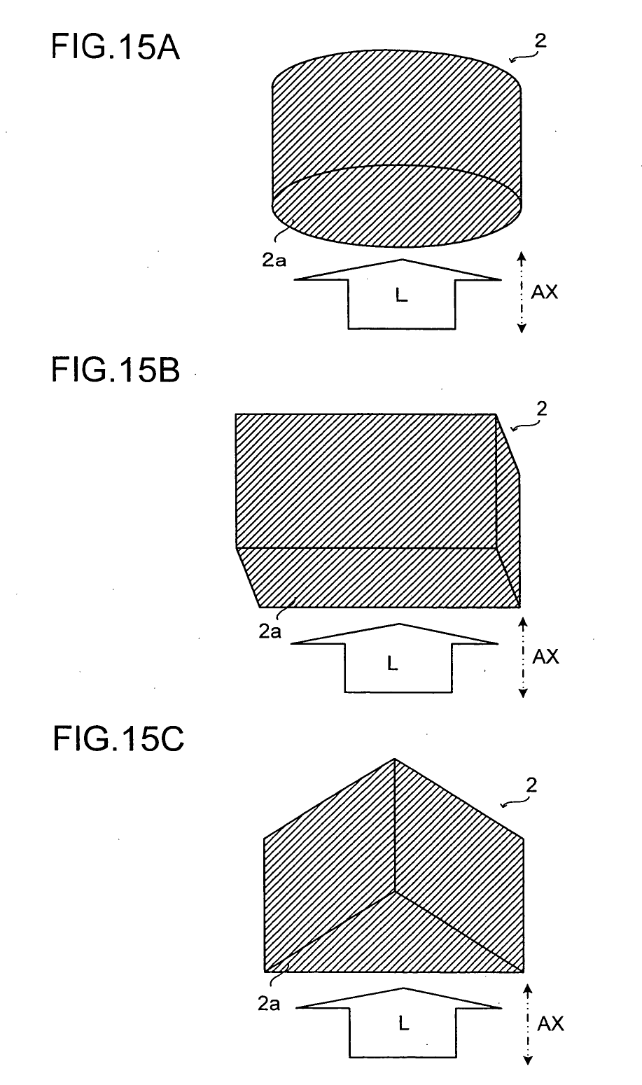

It can be said that the light-receiving portion 2a of the electrically conductive scatterer 2 simply has to have rotation symmetry. Accordingly, the electrically conductive scatterer 2 may be formed as a columnar solid (column) that has rotation symmetry within the plane perpendicular to the optical axis AX of the light from the 2-D PCL 3 and whose base face lies on the light-receiving portion 2a. For example, the electrically conductive scatterer 2 may be formed as a circular column (with a perfectly circular base face), a quadrangular column (with a right quadrangle base face), or a triangular column (with a right triangle base face) as shown in FIGS. 15A, 15B, and 15C.

When the electrically conductive scatterer 2 is given such a shape, localized plasmon LP travels (is propagated) along the column. This makes it possible, even where a particular design does not allow the hemispherical lens 43 to be arranged close to the disk 80, to extend the electrically conductive scatterer 2 into a columnar shape and thereby bring the localized plasmon LP (and hence the near-field light) closer to the disk 80. Thus, it is possible to surely irradiate the disk 80 with near-field light. In addition, more flexibility is allowed in the design of the storage apparatus.

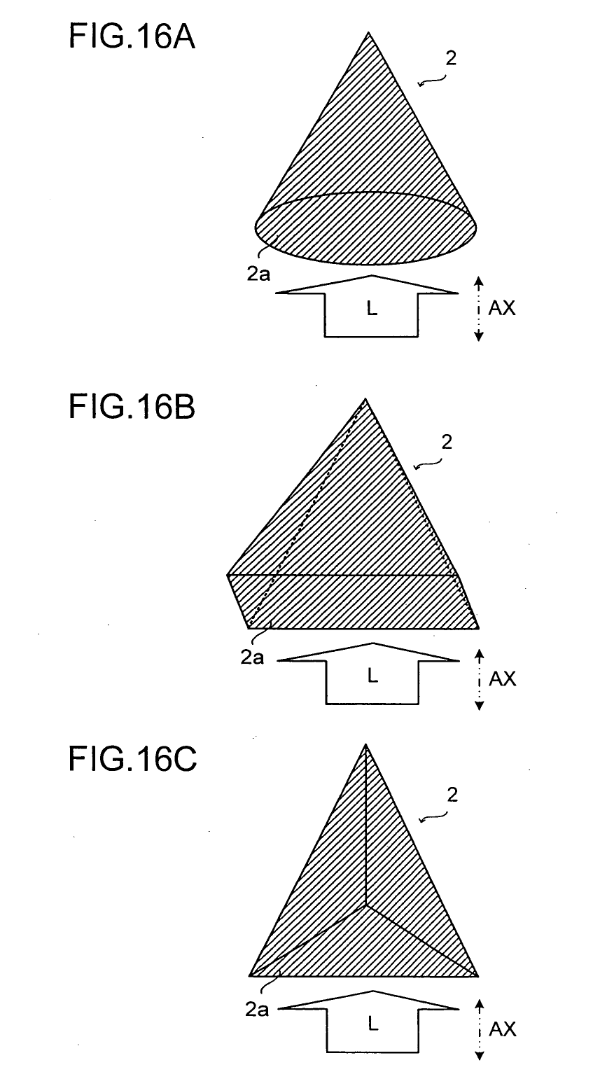

The localized plasmon LP produced on the surface of the electrically conductive scatterer 2 tends to concentrate at a protrusion. Thus, the localized plasmon LP can be concentrated at one location to exert a more powerful plasmon enhancement effect. For example, the electrically conductive scatterer 2 may be formed as a pyramidal solid (pyramid) that has rotation symmetry and whose base face lies on the light-receiving portion 2a. Specifically, the electrically conductive scatterer 2 may be formed as a circular pyramid (with a perfectly circular base face), a quadrangular pyramid (with a right quadrangle base face), or a triangular pyramid (with a right triangle base face) as shown in FIGS. 16A, 16B, and 16C.

When the electrically conductive scatterer 2 is formed as a columnar or pyramidal solid, provided that its light-receiving portion 2a fulfills conditional formula (1) above, quite naturally, the end face of the columnar solid or the tip end of the pyramidal solid is never larger than the light-receiving portion 2a.

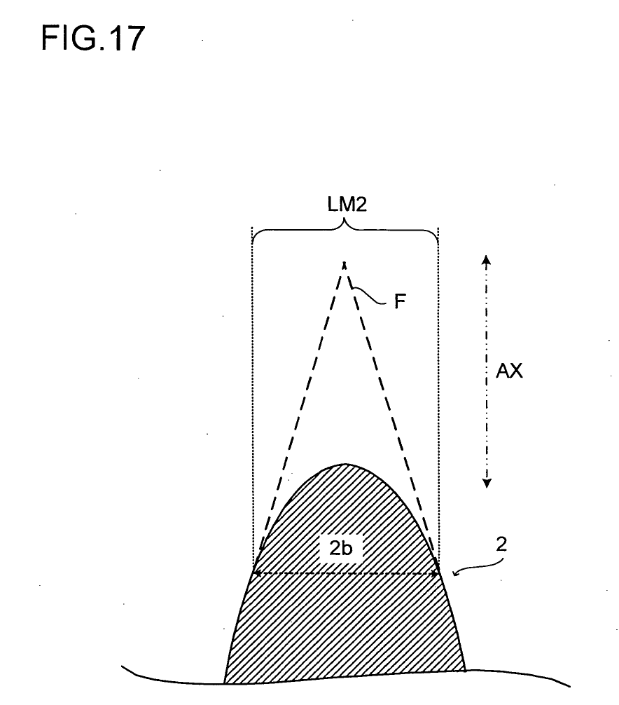

Ideally, the tip end of a pyramidal solid (the electrically conductive scatterer formed as a pyramid) 2 should be sharply pointed as indicated by broken lines F in FIG. 17. In reality, however, when the tip end of the electrically conductive scatterer 2 is observed in an enlarged view, for reasons associated with fabrication processes, a curved surface (curved surface part 2b) is produced at the tip end. Thus, where the electrically conductive scatterer 2 is formed as a pyramid, the size of the near-field light having its light intensity augmented by localized plasmon LP is proportional to the size (maximum width dimension) of the curved surface part 2b. According, it is preferable that the curved surface part 2b be properly sized.

The proper size of the curved surface part 2b is defined by conditional formulae (2) and (2′) below:
λ/1 000≦LM2≦λ/10 (2)
λ/10≦LM3≦λ (2′)
where
LM2 represents the maximum width dimension (nm) of the curved surface part produced at the tip end of the pyramidal shape, as measured within the plane perpendicular to the optical axis;
LM3 represents the maximum width dimension of the base face of the pyramidal solid; and
λ represents the wavelength of light (nm).

When conditional formula (2) is fulfilled, both Problems 1 and 2 mentioned above are avoided. In addition, localized plasmon LP itself occurs not at the tip end of the electrically conductive scatterer 2 but at the light-receiving portion (bottom part) 2a. Thus, localized plasmon LP occurs in a comparatively large area (i.e., an area wider than the tip end of the pyramidal solid fulfilling conditional formula (2)), and the localized plasmon LP concentrates at the tip end of the pyramidal solid. Hence, it is possible to augment the light intensity of the near-field light more efficiently with an electrically conductive scatterer 2 that fulfills conditional formulae (2) and (2′) than with one that fulfills conditional formula (1).

3-2. Exploitation of Surface Plasmon

The augmentation of the light intensity of near-field light may alternatively be achieved through the formation of a periodic structure that excites surface plasmon around the light condensation location of the electrically conductive scatterer.

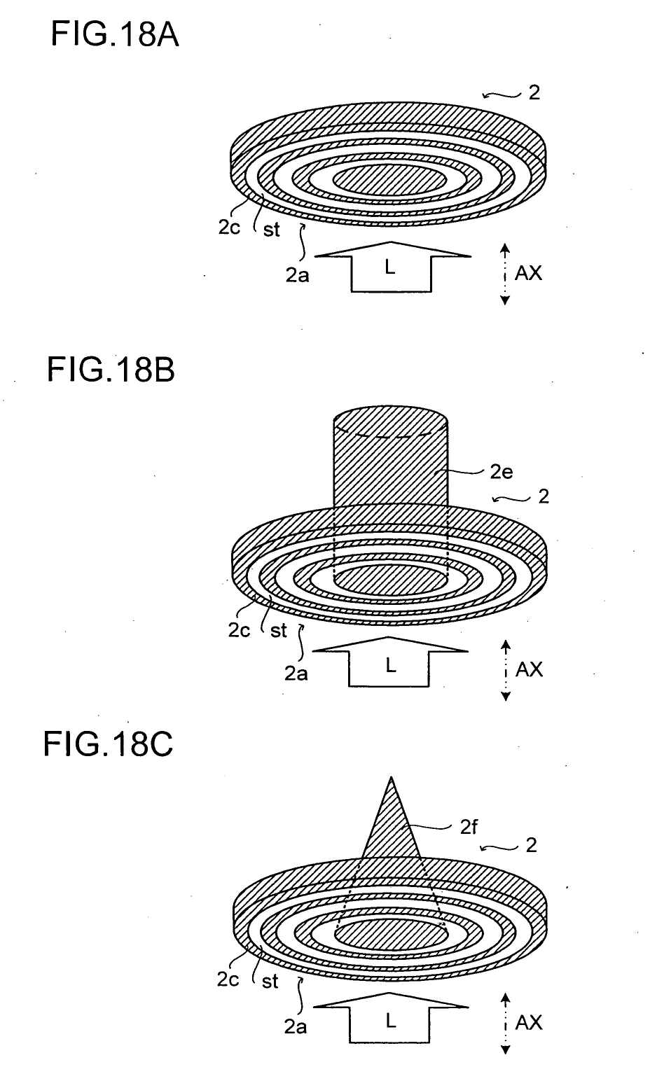

For example, as shown in FIG. 18, there may be provided, in a peripheral part of the light-receiving portion 2a of the electrically conductive scatterer 2, a periodic structure (for example, a rotation-symmetric periodic structure) that produces surface plasmon. Such a structure can be formed, for example, by concentrically arranging a plurality of metal rings 2c having different radii (while in a central part of the rotation-symmetric periodic structure is placed a metal piece having the shape of a perfect circle). That is, the intervals between the metal rings 2c serve as slits “st”, of which the alternating presence and absence form a periodic structure.

With this structure, the surface plasmon produced by the light shone in the peripheral part of the scatterer concentrates in the central part thereof. Thus, the light is concentrated with high efficiency in the central part (in this example, a metal piece having the shape of a perfect circle). This makes it possible to produce localized plasmon LP still more efficiently.

There is no particular limitation to the size of such an electrically conductive scatterer 2 having a periodic structure. It is, however, preferable that it fulfill, for example, conditional formula (1) noted previously. It is also preferable that the light-receiving portion 2a have the shape of a perfect circle, a right triangle, or a more-sided right polygon.

4. Producing Light Containing Radially Polarized Waves (Radially Polarized Beam)

As described earlier, plasmon (localized plasmon or surface plasmon) is produced by P-polarized light. Thus, in the B-mode light of the 2-D PCL 3, only the radially polarized waves R that become P-polarized light after passing through the light-condensing elements (the objective lens 42 and the hemispherical lens 43) contribute to producing localized plasmon etc. Now, different schemes will be described for augmenting or producing radially polarized waves R in B-mode or A-mode light.

4-1. Schemes for B-Mode Light (Schemes 1 and 2)

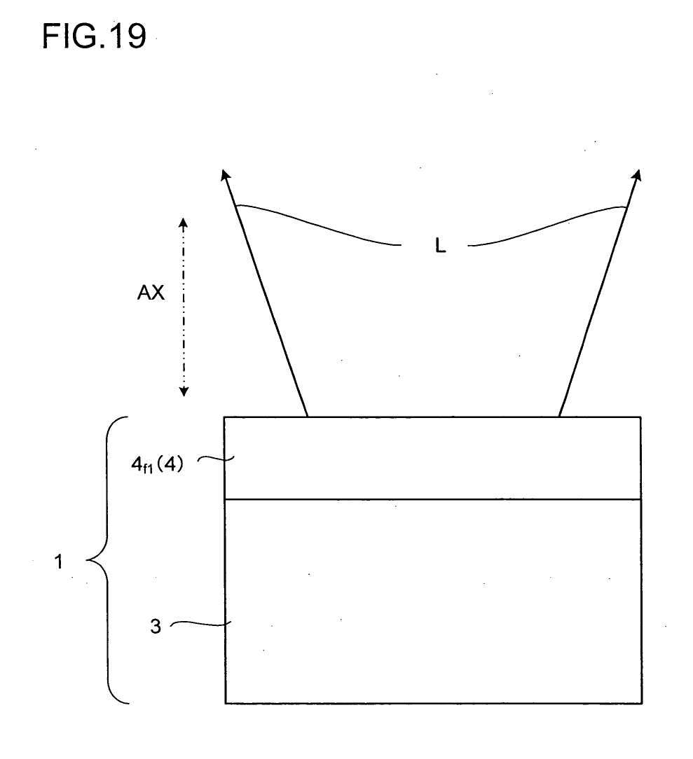

One scheme (Scheme 1) for B-mode light is, as shown in FIG. 19, to provide one half-wave plate (polarization controlling element) 4 on the light-exit side of the 2-D PCL 3. What is particular with Scheme 1 is that the orientation of the half-wave plate 4 (the wave-plate orientation) is limited relative to the direction of electric field vectors (the polarization direction).

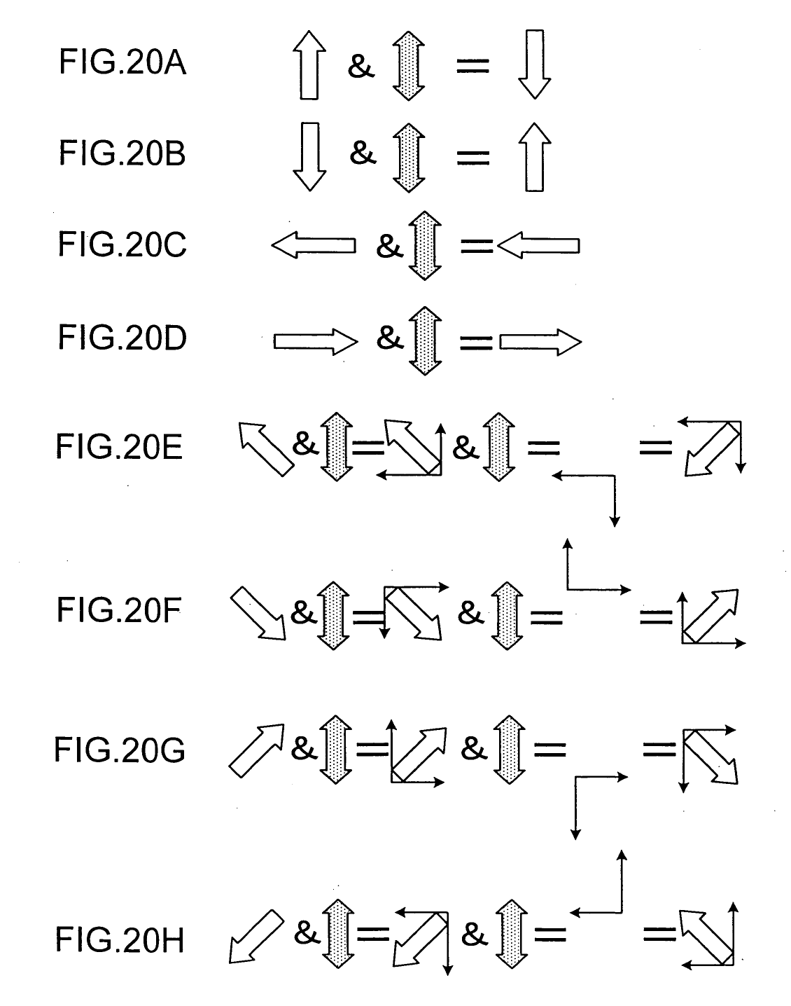

The wave-plate orientation exerts effect as described in (1) to (3) below and shown in FIGS. 20A to 20H. FIGS. 20A to 20H show how an electric field vector is changed by the wave-plate orientation. In these diagrams, an arrow with a hollow inside represents an electric field vector, an arrow with a dotted inside represents the orientation of the half-wave plate 4, and a pair of solid-line arrows represents the component vectors obtained by decomposing an electric field vector into mutually perpendicular directions. Moreover, the symbol “&” denotes that the electric field vector indicated by an arrow with a hollow inside has passed through the half-wave plate 4 having the orientation indicated by an arrow with a dotted inside, and the symbol “=” denotes that what follows it is the electric field vector after the passage through the half-wave plate 4.
(1) As shown in FIGS. 20A and 20B, when the direction of an electric field vector is the same as the wave-plate orientation, the half-wave plate 4 inverts the direction of the electric field vector;
(2) As shown in FIGS. 20C and 20D, when the direction of an electric field vector is 90° inclined relative to the wave-plate orientation, the half-wave plate 4 does not change the direction of the electric field vector; and
(3) As shown in FIGS. 20E to 20H, when the direction of an electric field vector is 45° inclined relative to the wave-plate orientation, the half-wave plate 4 changes the direction of the electric field vector through 90°.
   The direction of the electric field vector in FIGS. 20E and 20F is described as being −45° inclined relative to the wave-plate orientation, and the direction of the electric field vector after the change is described as being −90° inclined relative to that before the change. The direction of the electric field vector in FIGS. 20G and 20H is described as being +45° inclined relative to the wave-plate orientation, and the direction of the electric field vector after the change is described as being +90° inclined relative to that before the change. That is, a clockwise azimuth angle is indicated by a positive sign “+”, and a counter-clockwise azimuth angle is indicated by a negative sign “−”.

Scheme 1

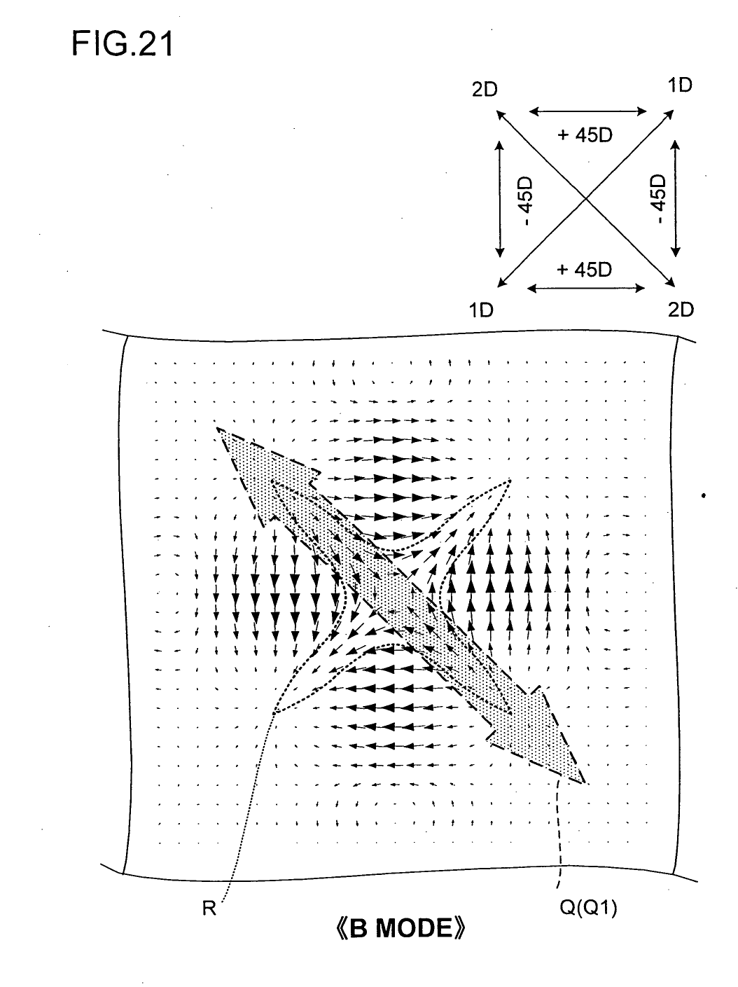

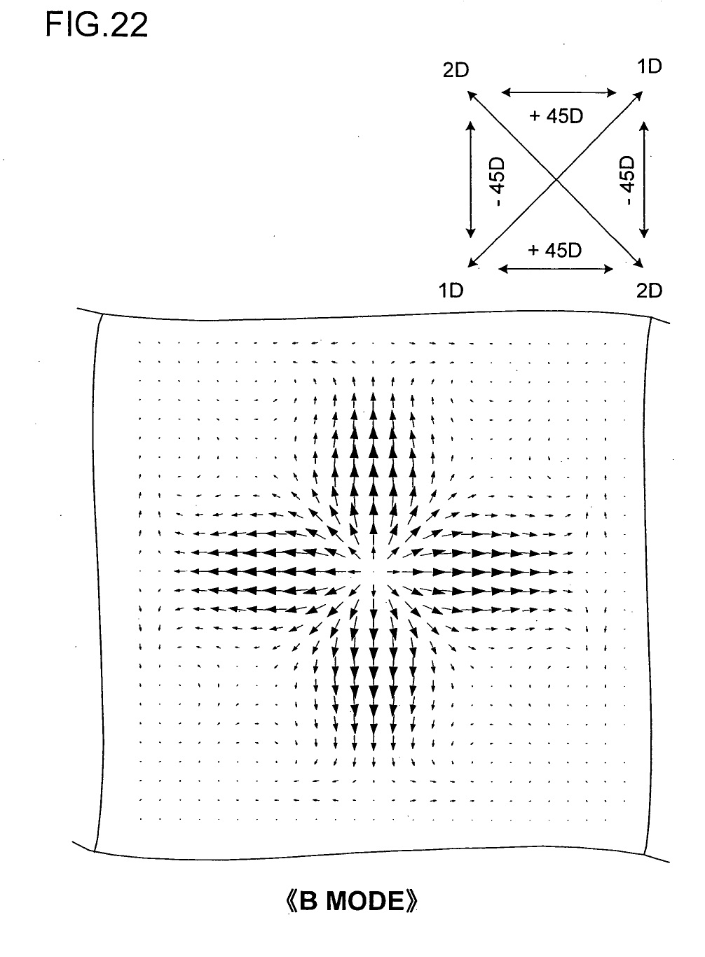

According to Scheme 1, the wave-plate orientation, which exerts the above effect, is aligned with the first direction (1D) or the second direction (2D) of the radially polarized waves R in B-mode light. FIG. 21 shows, as an example of Scheme 1, a state where the wave-plate orientation Q is aligned with the second direction (2D) of the radially polarized waves R (the arrow with a dotted inside represents the wave-plate orientation Q (Q1)).

Where Scheme 1 is applied, electric field vectors appear whose polarization direction has been changed according to the relationship between the direction of electric field vectors (the polarization direction) in light and the wave-plate orientation Q. FIG. 22 shows the distribution of electric field vectors in this state, that is, the distribution of electric field vectors after being changed by the half-wave plate 4.

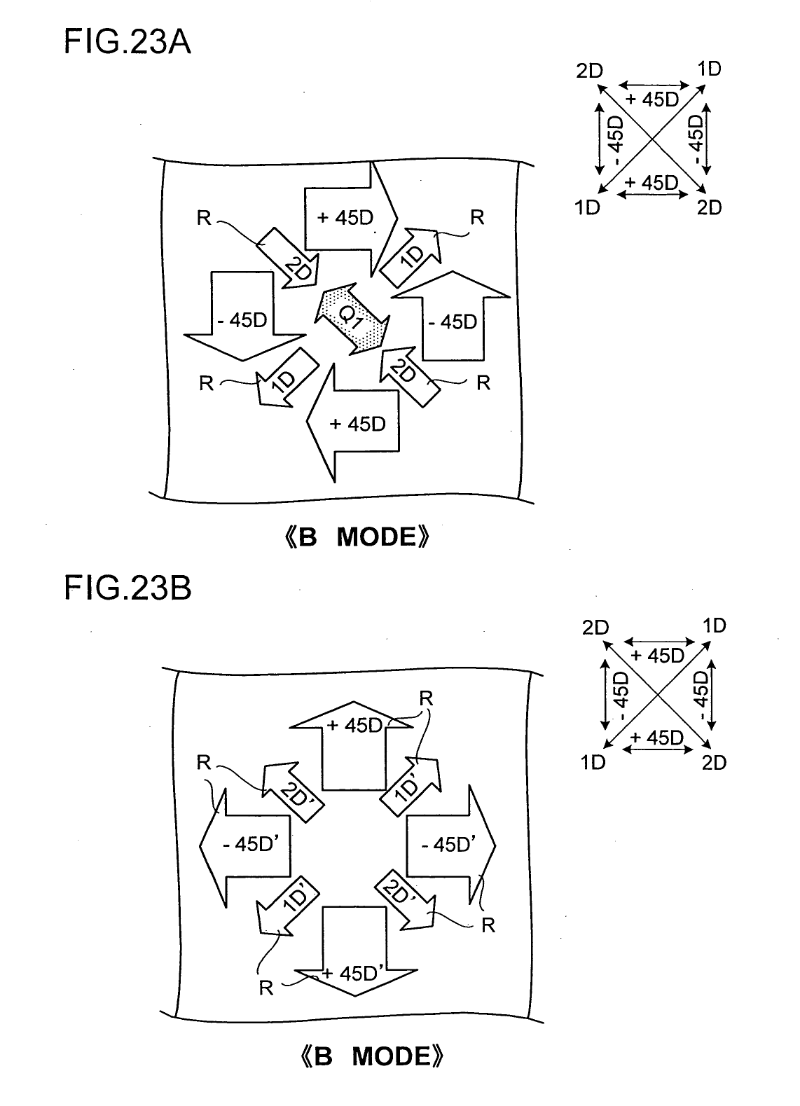

FIGS. 23A and 23B are simplified diagrams of FIGS. 21 and 22, FIG. 23A corresponding to FIG. 21 and FIG. 23B corresponding to FIG. 22. In FIG. 23, electric field vectors that have passed through one half-wave plate 4 are indicated by a prime symbol (′) (likewise, in the following description and in the diagrams referred to therein, the number of prime symbols (′) represents the number of half-wave plates 4 that a particular electric field vector has passed through).

As shown in FIGS. 21 to 23, in the radially polarized waves R in FIG. 21, part of the electric field vectors (those pointing in the first direction (1D)) 90° inclined relative to the wave-plate orientation Q have corresponding waves in FIG. 22. In FIG. 23, electric field vectors that have passed through one half-wave plate 4 are indicated by a prime symbol (′) (likewise, in the following description and in the diagrams referred to therein, the number of prime symbols (′) represents the number of half-wave plates 4 that a particular electric field vector has passed through).

As shown in FIGS. 21 to 23, in the radially polarized waves R in FIG. 21, part of the electric field vectors 90° inclined relative to the wave-plate orientation Q (those pointing in the first direction (1D)) are not changed under the influence of the wave-plate orientation Q (see FIG. 22, and 1D and 1D′ in FIGS. 23A and 23B). By contrast, in the radially polarized waves R in FIG. 21, another part of the electric field vectors that are aligned with wave-plate orientation Q (those pointing in the second direction (2D)) point are inverted (see FIGS. 22, and 2D and 2D′ in FIGS. 23A and 23B).

Thus, the radially polarized waves R in FIG. 21, even after having passed through the half-wave plate 4, remains to contain electric field vectors that constitute a rotation-symmetric radiating electric field vector distribution and that have equal magnitudes at equal distances from the center of rotation symmetry (see FIG. 22, and 1D, 1D′, 2D, and 2D′ in FIGS. 23A and 23B).

On the other hand, the electric field vectors pointed in the −45° direction (−45D) in FIG. 21 are inclined by +45° in terms of a clockwise azimuth angle (+) relative to the wave-plate orientation Q. Accordingly, after the change, the electric field vectors point in the radial direction, being inclined by +90° in terms of a clockwise azimuth angle (+) relative to the electric field vectors before the change (see FIG. 22, and see −45D and −45D′ in FIGS. 23A and 23B).

Moreover, the electric field vectors pointed in the +45° direction (+45D) in FIG. 21 are inclined by −45° in terms of a counter-clockwise azimuth angle (−) relative to the wave-plate orientation Q. Accordingly, after the change, the electric field vectors point in the radial direction, being inclined by −90° in terms of a counter-clockwise azimuth angle (−) relative to the electric field vectors before the change (see FIG. 22, and +45D and +45D′ in FIGS. 23A and 23B).

Thus, the electric field vectors pointing in the −45° direction (−45D) and the electric field vectors pointing in the +45° direction (+45D) in FIG. 21, by passing through the half-wave plate 4, become electric field vectors that constitute a rotation-symmetric radiating electric field vector distribution and that have equal magnitudes at equal distances from the center of rotation symmetry (see −45D′ and +45D′ in FIGS. 22 and 23B).

As described above, when B-mode light passes through a half-wave plate 4 whose wave-plate orientation Q is aligned with one of the polarization directions (1D and 2D) of the radially polarized waves R contained in the B-mode light from the beginning, the electric field vectors pointing in the +45° direction (+45D) and the electric field vectors pointing in the −45° direction (−45D) change into radially polarized waves R. In this way, B-mode light, by passing through the half-wave plate 4, becomes light of which the most part is radially polarized waves R (a radially polarized beam). When 80% or more of all the electric field vectors contained in light have changed into radially polarized waves R, the light is called a radially polarized beam.

Scheme 2

According to Scheme 1 described above, a radially polarized beam is produced by passing B-mode light through one half-wave plate 4f1 (4). This, however, is not meant as any limitation; it is also possible to produce a radially polarized beam with two or more half-wave plates 4 (Scheme 2). According to Scheme 2, B-mode light is passed through, for example, three half-wave plates 4.

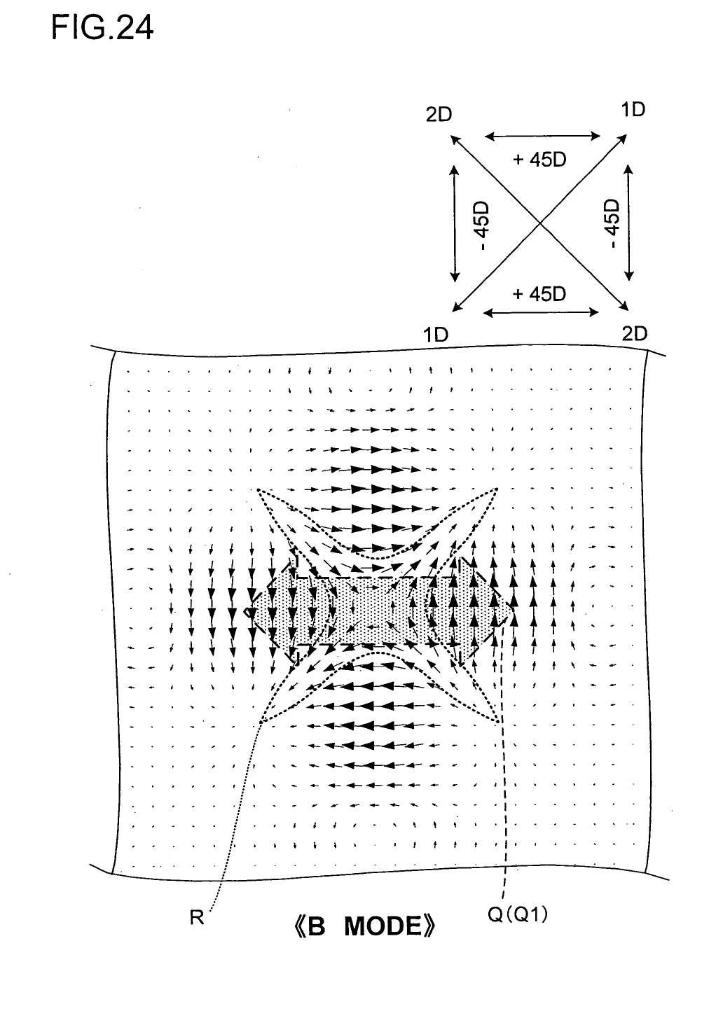

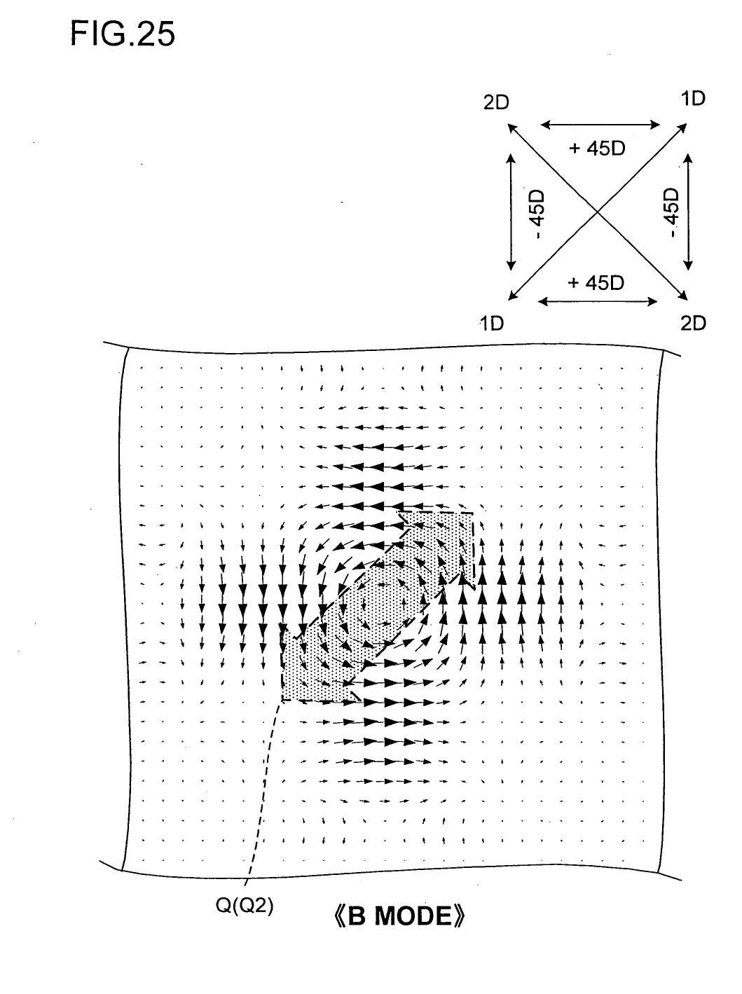

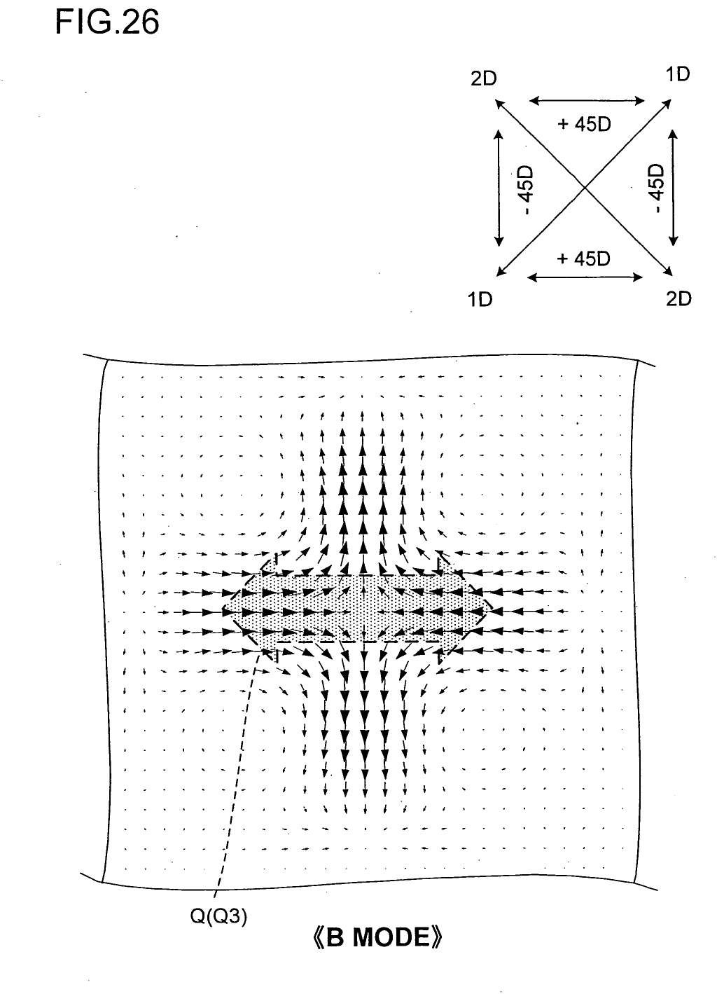

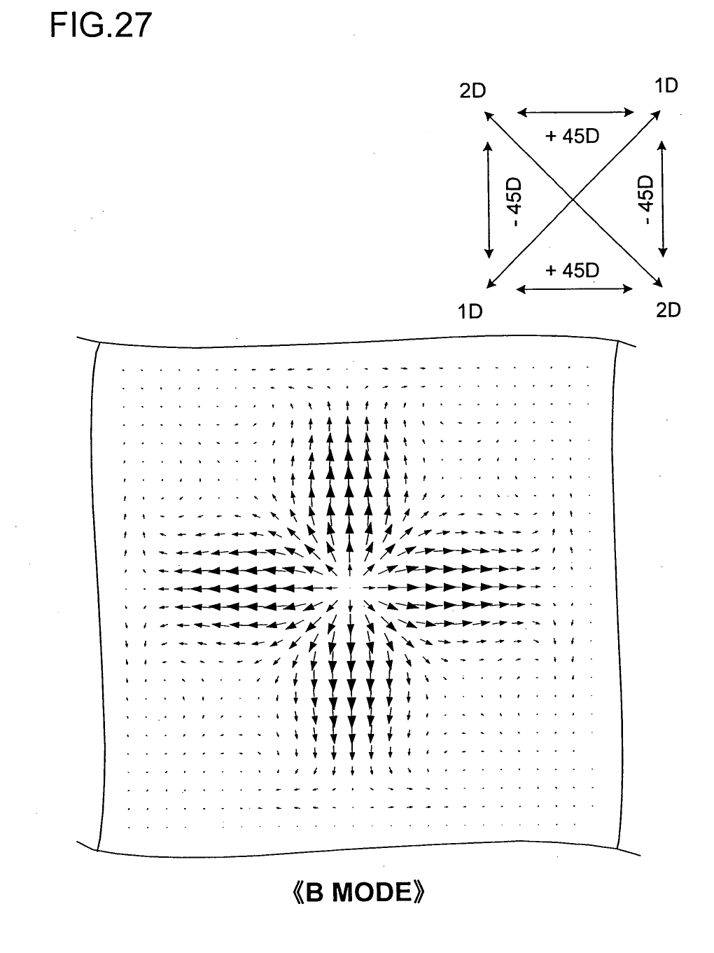

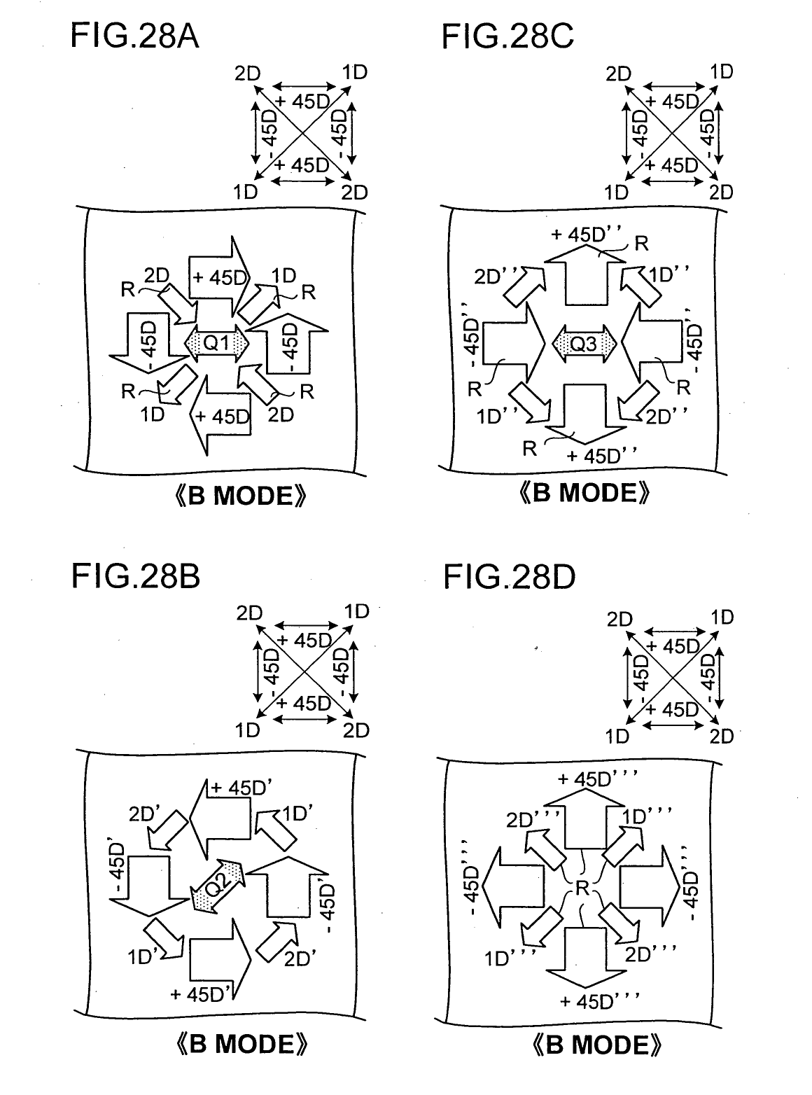

Now, with reference to the electric field vector distribution diagrams in FIGS. 24 to 28, Scheme 2 including three steps will be described. FIG. 24 shows B-mode light; FIG. 25 shows the light having passed through a first half-wave plate 4f1 (4; unillustrated for the sake of convenience); FIG. 26 shows the light having passed through a second half-wave plate 4f2 (4; unillustrated for the sake of convenience); and FIG. 27 shows the light having passed through a third half-wave plate 4B (4; unillustrated for the sake of convenience). FIGS. 28A to 28D are simplified diagrams of FIGS. 24 to 27.

Step 1

According to Scheme 2, when B-mode light passes through the first half-wave plate 4f1, the wave-plate orientation (first wave-plate orientation) is inclined by +45° in terms of a clockwise azimuth angle (+) relative to the first direction (1D) or the second direction (2D) of the radially polarized waves R (Step 1). FIG. 24 shows, as an example of Step 1, a state where the first wave-plate orientation Q1 is +45° inclined relative to the first direction (1D) of the radially polarized waves R.

Through Step 1, electric field vectors appear whose polarization direction has been changed according to the relationship between the direction of electric field vectors (the polarization direction) in light and the first wave-plate orientation Q1. FIG. 25 shows the distribution of electric field vectors in this state, that is, the distribution of electric field vectors after being changed by the first half-wave plate 4f1.

The electric field vectors pointing in the first direction (1D) in FIG. 24 are inclined by −45° in terms of a counter-clockwise azimuth angle (−) relative to the first wave-plate orientation Q1. Accordingly, as shown in FIG. 25, the direction of the electric field vectors after the change is inclined by −90° in terms of a clockwise azimuth angle (−) relative to the electric field vectors before the change (see 1D and 1D′ in FIGS. 28A and 28B).

By contrast, the electric field vectors pointing in the second direction (2D) in FIG. 24 are inclined by +45° in terms of a counter-clockwise azimuth angle (+) relative to the first wave-plate orientation Q1. Accordingly, as shown in FIG. 25, the direction of the electric field vectors after the change is inclined by +90° in terms of a counter-clockwise azimuth angle (+) relative to the electric field vectors before the change (see 2D and 2D′ in FIGS. 28A an 28B).

On the other hand, the electric field vectors pointing in the −45° direction (−45D) in FIG. 24 are inclined by 90° relative to the first wave-plate orientation Q1, and are therefore not changed (see −45D and −45D′ in FIGS. 25 and 28). By contrast, the electric field vectors pointing in the +45° direction in FIG. 24 are aligned with the first wave-plate orientation Q1, and are therefore inverted (see FIG. 25, and +45D and +45D′ in FIGS. 28A and 28B).

Step 2

According to Scheme 2, on completion of Step 1, the light that has passed through the first half-wave plate 4f1 is passed through a second half-wave plate 4f2 (Step 2). Specifically, the light is passed through the second half-wave plate 4f2 whose orientation (the second wave-plate orientation Q2 (Q)) is inclined by −45° in terms of a counter-clockwise azimuth angle (−) relative to the first wave-plate orientation Q1.

Through Step 2, electric field vectors appear whose polarization direction has been changed according to the relationship between the direction of electric field vectors (the polarization direction) in light and the second wave-plate orientation Q2. FIG. 26 shows the distribution of electric field vectors in this state, that is, the distribution of electric field vectors after being changed by the second half-wave plate 4f2.

The electric field vectors with an azimuth angle 90° inclined relative to the second wave-plate orientation Q2 in FIG. 25 are not changed under the influence of the second wave-plate orientation Q2 (see 1D′ and 1D″ in FIGS. 26 and 28). By contrast, the electric field vectors with an azimuth angle aligned with the second wave-plate orientation Q2 in FIG. 25 are inverted (see FIGS. 26, and 2D′ and 2D″ in FIGS. 28C and 28D).

On the other hand, the electric field vectors pointing in the −45° direction (−45D) in FIG. 25 are inclined by −45° in terms of a counter-clockwise azimuth angle (−) relative to the second wave-plate orientation Q2. Accordingly, as shown in FIG. 26, the electric field vectors after the change point in the radial direction, being inclined by −90° in terms of a counter-clockwise azimuth angle (−) relative to the electric field vectors before the change (see −45D and −45D″ in FIGS. 28A and 28B).

By contrast, the electric field vectors pointing in the (+45° direction +45D) in FIG. 25 are inclined by +45° in terms of a clockwise azimuth angle (+) relative to the second wave-plate orientation Q2. Accordingly, as shown in FIG. 26, the electric field vectors after the change point in the radial direction, being inclined by +90° in terms of a clockwise azimuth angle (+) relative to the electric field vectors before the change (see +45D and +45D″ in FIGS. 28A and 28B).

Step 3

According to Scheme 2, on completion of Step 2, the light that has passed through the second half-wave plate 4f2 is passed through a third half-wave plate 4B (Step 3). Specifically, the light is passed through the third half-wave plate 4B whose orientation (the third wave-plate orientation Q3 (Q)) is inclined by +45° in terms of a clockwise azimuth angle (+) relative to the second wave-plate orientation Q2.

Through Step 3, electric field vectors appear whose polarization direction has been changed according to the relationship between the direction of electric field vectors (the polarization direction) in light and the third wave-plate orientation Q3. FIG. 27 shows the distribution of electric field vectors in this state, that is, the distribution of electric field vectors after being changed by the third half-wave plate 4f.

Some of the electric field vectors pointing in the azimuth angle direction in FIG. 26 are inclined by +45° in terms of a clockwise azimuth angle (+) relative to the third wave-plate orientation Q3. Accordingly, as shown in FIG. 27, the electric field vectors after the change point in the radial direction, being inclined by +90° in terms of a clockwise azimuth angle (+) relative to the electric field vectors before the change (see 1D″ and 1D′″ in FIGS. 28C and 28D).

By contrast, some other electric field vectors pointing in the directions of varying angles of orientation in FIG. 26 are inclined by −45° in terms of a counter-clockwise azimuth angle (−) relative to the third wave-plate orientation Q3. Accordingly, as shown in FIG. 27, the electric field vectors after the change point in the radial direction, being inclined by −90° in terms of a counter-clockwise azimuth angle (−) relative to the electric field vectors before the change (see 2D″ and 2D′″ in FIGS. 28C and 28D).

Thus, when the electric field vectors pointing in the direction of varying angels of orientation in FIG. 26 pass through the second half-wave plate 4f3, they change into electric field vectors that constitute a rotation-symmetric radiating electric field vector distribution and that have equal magnitudes at equal distances from the center of rotation symmetry (radially polarized waves R) (see 1D′″ and 2D′″ in FIG. 28D).

On the other hand, the electric field vectors 90° inclined relative to the third wave-plate orientation Q3 in FIG. 26 are not changed under the influence of the wave-plate orientation (see FIG. 27, and +45D″ and +45D′″ in FIGS. 28C and 28D). By contrast, the electric field vectors aligned with the third wave-plate orientation Q3 in FIG. 26 are inverted (see FIG. 27, and −45D″ and −45D′″ in FIGS. 28C and 28D).

That is, the electric field vectors pointing in directions other than that of varying angles of orientation in FIG. 26, irrespective of whether they have passed through the second half-wave plate 4f3 or not, remain to be electric field vectors that constitute a rotation-symmetric radiating electric field vector distribution and that have equal magnitudes at equal distances from the center of rotation symmetry (radially polarized waves R) (see FIGS. 27, and −45D′″ and +45D′″ in FIG. 28D).

In this way, B-mode light, by passing through the three half-wave plates 4 (4f1 to 4f), becomes light of which the most part is radially polarized waves R (a radially polarized beam). Here, while passing through the second half-wave plate 4f2, the electric field vectors pointing in the +45° direction (+45D) and the −45° direction (−45D) constituting a large proportion of the original light change into radially polarized waves R (see FIGS. 28A and 28C). Thus, by passing through the two half-wave plates 4 (4f1 and 4f2), B-mode light comes to contain more radially polarized waves R than it originally does.

4-2. Scheme for A-Mode Light (Scheme 3)

As described earlier, when the A-mode light from the 2-D PCL 3 passes through the light-condensing elements, it becomes S-polarized light; it can also be changed into light of which a very large proportion is radially polarized waves R (a radially polarized beam) by Scheme 3 including the following two steps.

Scheme 3

According to Scheme 3, radially polarized waves R are produced by passing A-mode light through two half-wave plates 4 (4f1 and 4f2). What is particular with Scheme 3 is that the orientation of the first half-wave plate 4f1 (i.e. the first wave-plate orientation Q1) and the orientation of the second half-wave plate 4f2 (i.e. the second wave-plate orientation Q2) are 45° apart from each other. This orientational relationship can be achieved in various ways. For example, to name a few, the second wave-plate orientation Q2 may be inclined by −45° in terms of a counter-clockwise azimuth angle (−) relative to the first wave-plate orientation Q1; or the second wave-plate orientation Q2 may be inclined by +45° in terms of a clockwise azimuth angle (+) relative to the first wave-plate orientation Q1.

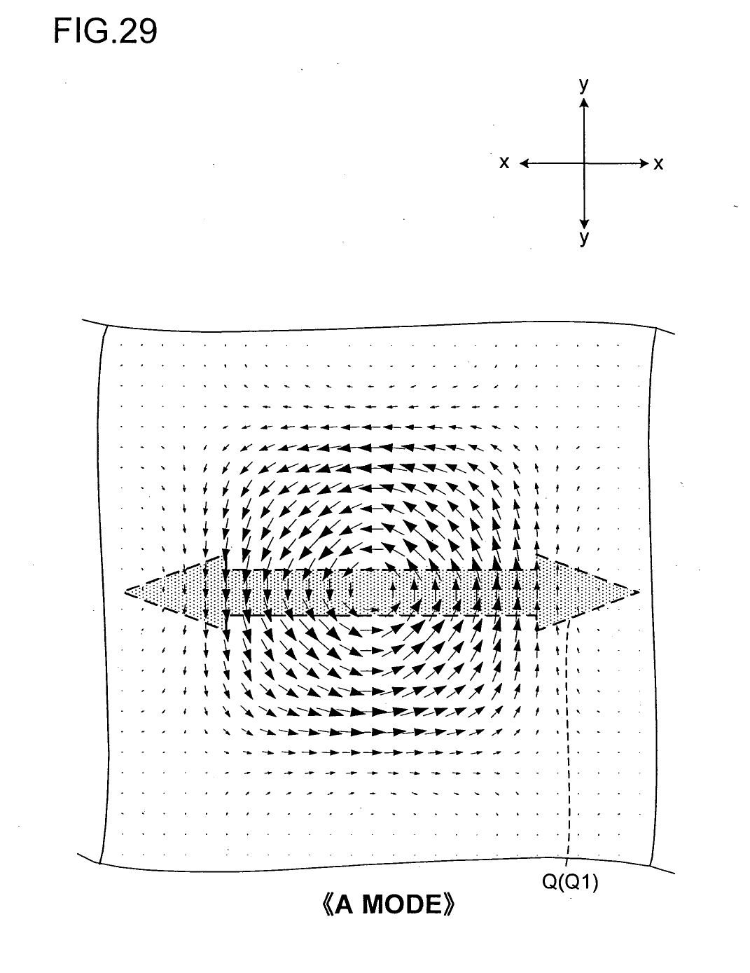

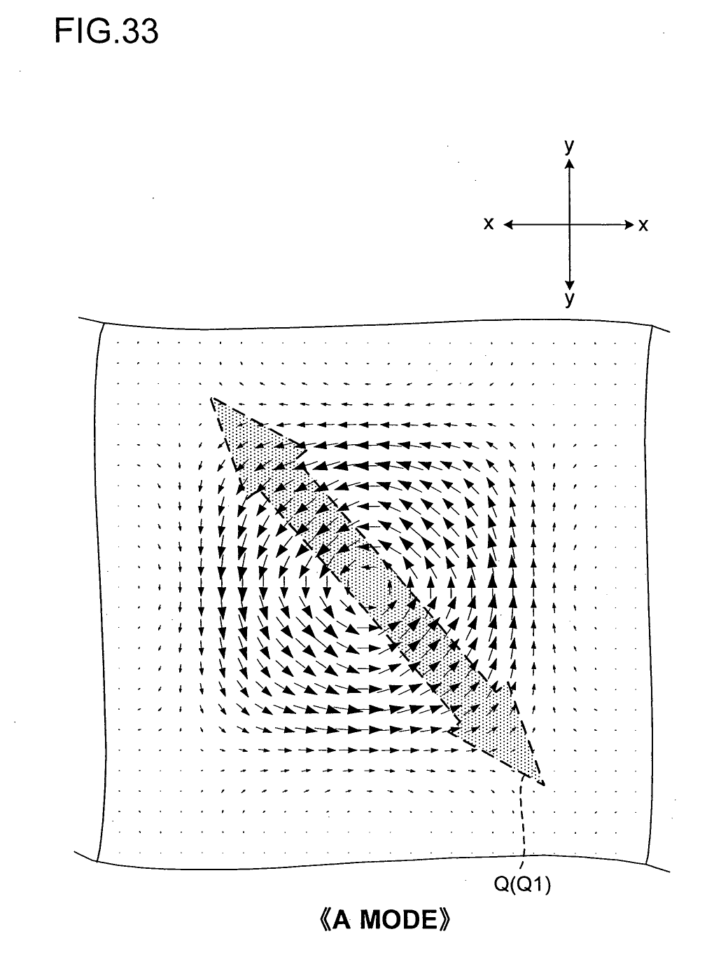

In the electric field vector distribution of A-mode light, the electric field vectors point in the azimuth angle direction DC about the center of the light beam (FIGS. 9 and 10). Therefore, the first wave-plate orientation Q1 of the first half-wave plate 4f1 may be any along the plane perpendicular to the optical axis AX. Accordingly, in the electric field vector distribution diagrams of FIGS. 29 to 36, x and y directions are defined to be mutually perpendicular; the first wave-plate orientation Q1, which is aligned with the x direction, is shown in the electric field vector distribution diagram of FIG. 29, and the first wave-plate orientation Q1, which is inclined by −45° in terms of a counter-clockwise azimuth angle (−) relative to the x direction, is shown in the electric field vector distribution diagram of FIG. 33.

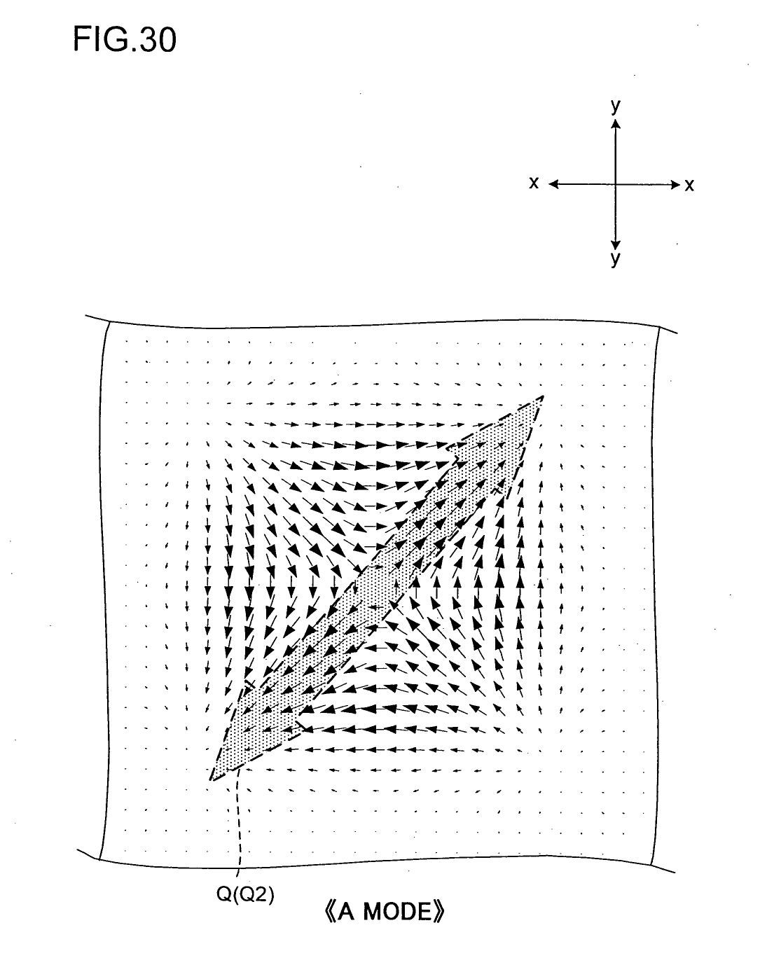

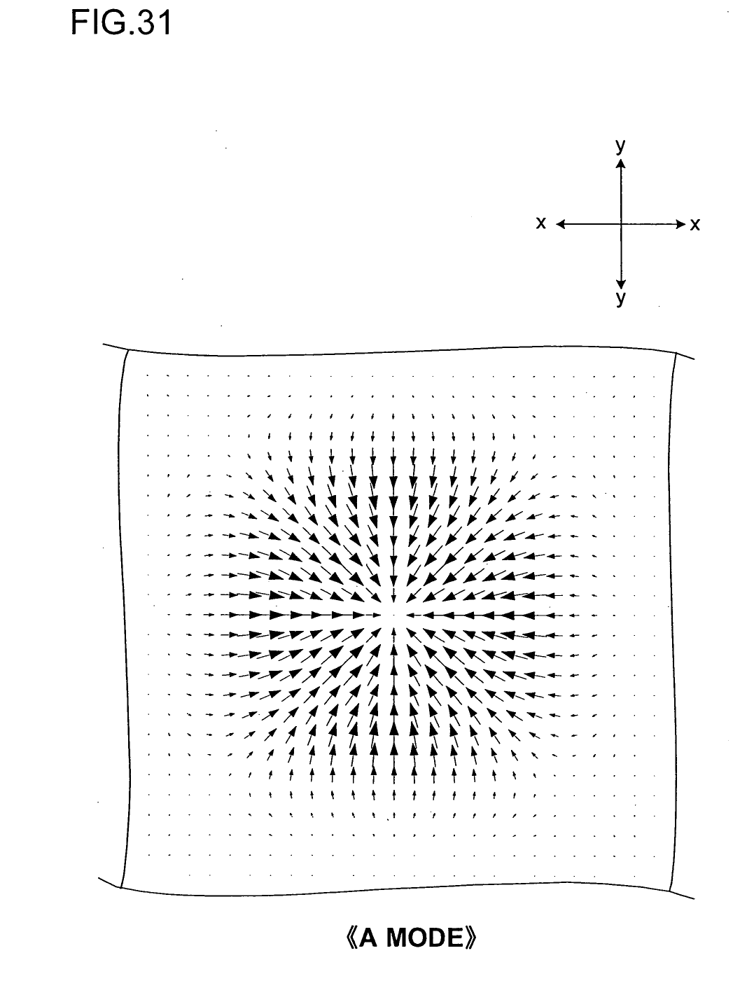

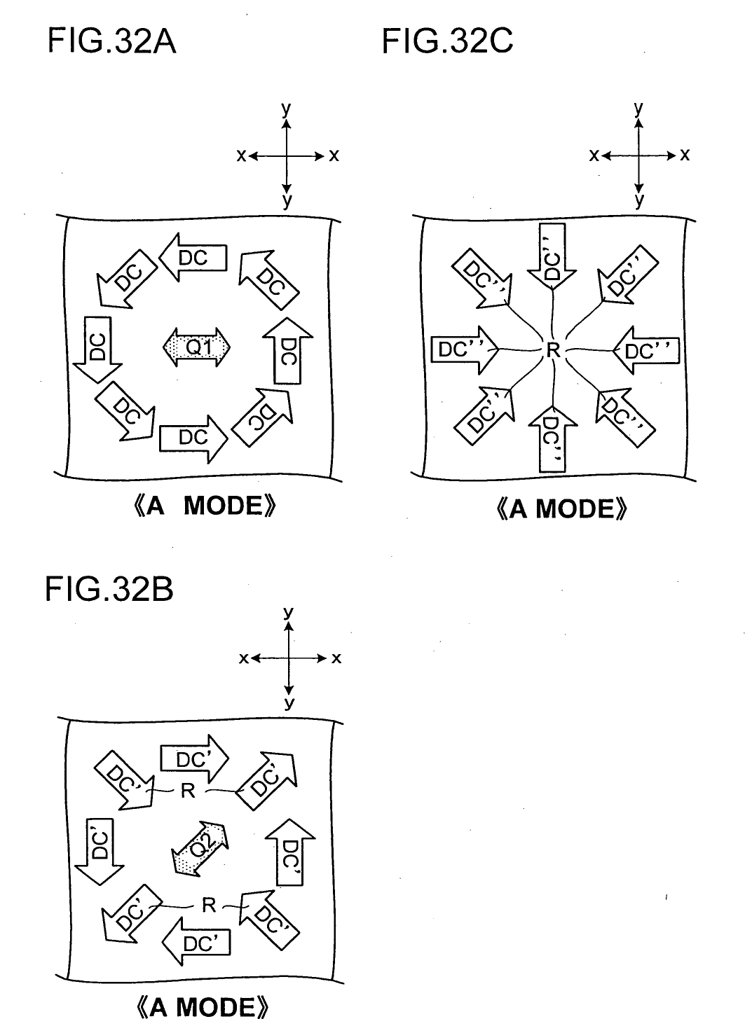

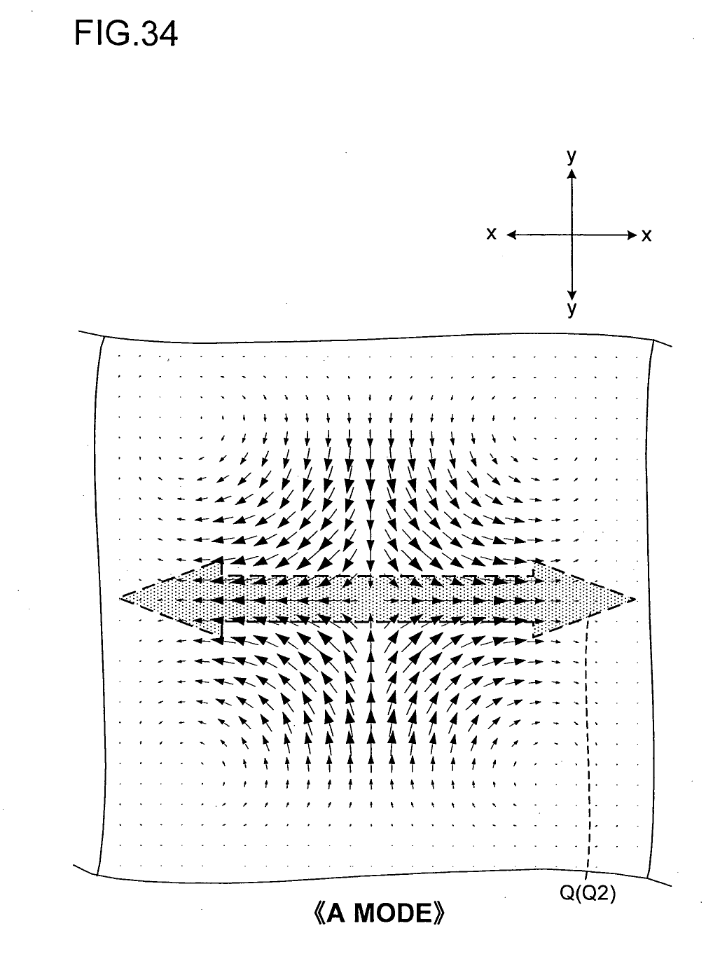

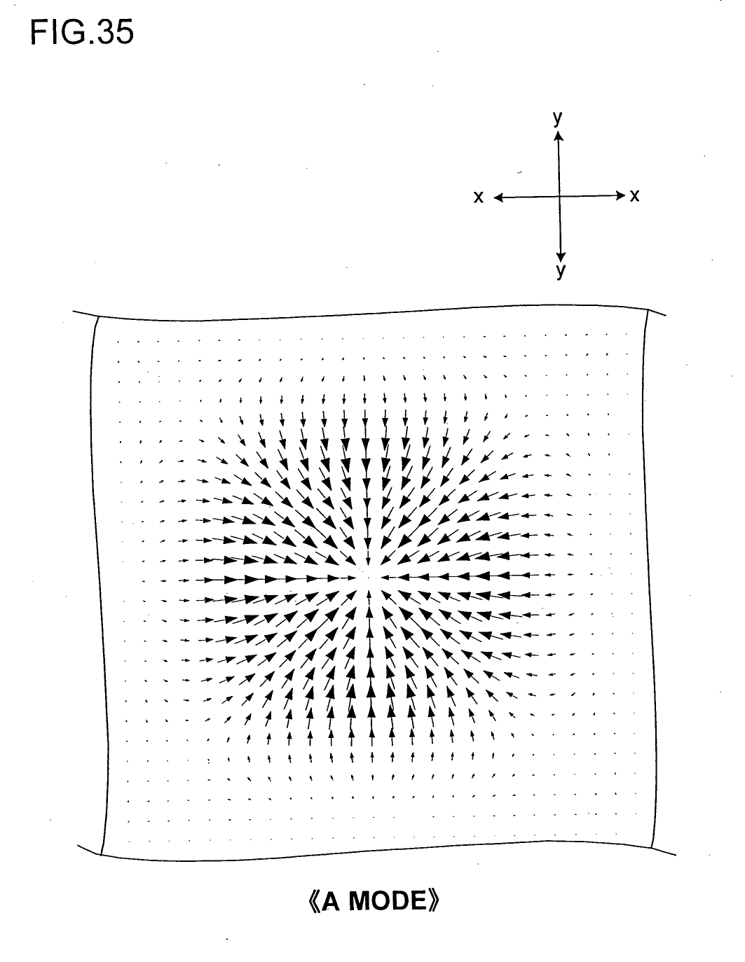

The electric field vector distribution diagram of FIG. 30 shows the light that has passed through the first half-wave plate 4f1 having the first wave-plate orientation Q1 shown in FIG. 29, and the electric field vector distribution diagram of FIG. 31 shows the light that has passed through the second half-wave plate 4f2. The electric field vector distribution diagram of FIG. 34 shows the light that has passed through the first half-wave plate 4f1 having the first wave-plate orientation Q1 shown in FIG. 33, and the electric field vector distribution diagram of FIG. 35 shows the light that has passed through the second half-wave plate 4f2. FIGS. 32A to 32C are simplified diagrams of FIGS. 29 to 31, and FIGS. 36A to 36C are simplified diagrams of FIGS. 33 to 35.

Step 1

According to Scheme 3, in a case where A-mode light as shown in FIGS. 29 and 33 passes through the first half-wave plate 4f1, the first wave-plate orientation Q1 is set at an arbitrary direction along the plane perpendicular to the optical axis AX.

Through Step 1, of the electric field vectors pointing in the azimuth angle direction, those aligned with the first wave-plate orientation Q1 are inverted. By contrast, of the electric field vectors pointing in the azimuth angle direction, those 90° inclined relative to the first wave-plate orientation remain unchanged (see FIGS. 30, 32A and 32B, and FIGS. 34, 36A, and 36).

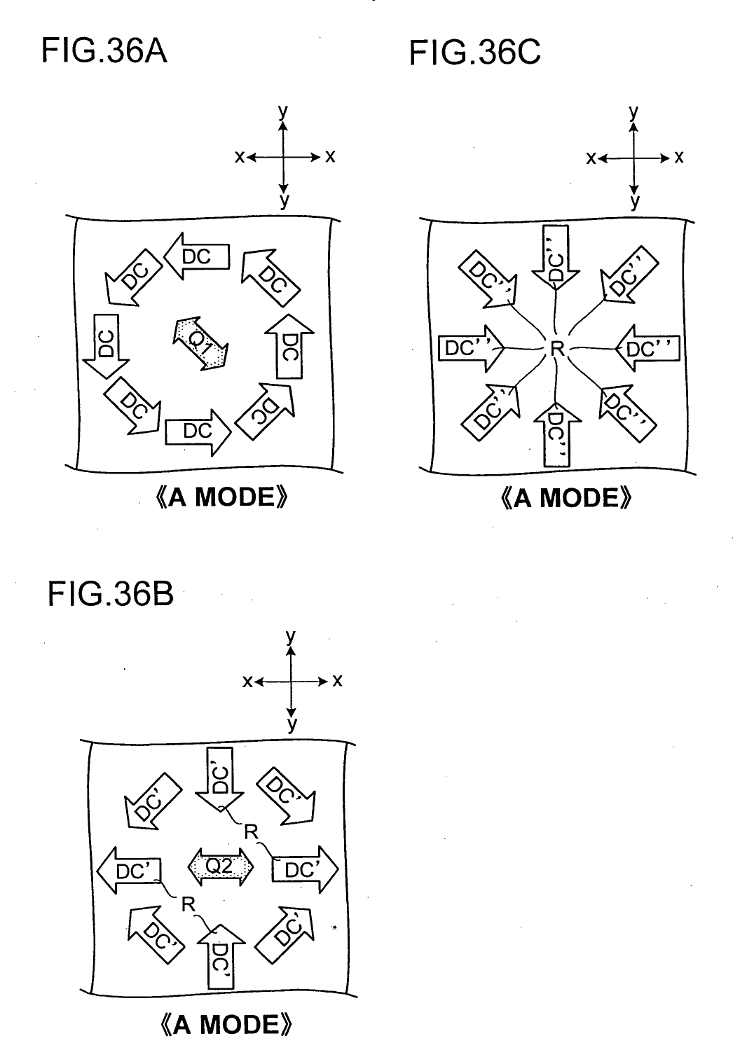

Moreover, as shown in FIGS. 30 and 34, of the electric field vectors pointing in the azimuth angle direction in FIGS. 29 and 33, those inclined by −45° in terms of a counter-clockwise azimuth angle (−) relative to the first wave-plate orientation Q1 point in the radial direction, being inclined by −90° in terms of a counter-clockwise azimuth angle (−) relative to the original electric field vectors (see FIGS. 32A, 32B, 36A, and 36B).

Furthermore, of the electric field vectors pointing in the azimuth angle direction in FIGS. 29 and 33, those inclined by +45° in terms of a clockwise azimuth angle (+) relative to the first wave-plate orientation Q1 point in the radial direction, being inclined by +90° in terms of a clockwise azimuth angle (+) relative to the original electric field vectors (see FIGS. 32A, 32B, 36A, and 36B).

Step 2

According to Scheme 3, on completion of Step 1, the light having passed through the first half-wave plate 4f1 is passed through a second half-wave plate 4f2 (Step 2). Specifically, the light is passed through the second half-wave plate 4f2 whose orientation (the second wave-plate orientation Q2 (Q)) is inclined by −45° in terms of a counter-clockwise azimuth angle (−) relative to the first wave-plate orientation Q1.

Through Step 2, electric field vectors appear whose polarization direction has been changed according to the relationship between the direction of electric field vectors (the polarization direction) in light and the second wave-plate orientation Q2. FIGS. 31 and 35 show the distribution of electric field vectors in this state, that is, the distribution of electric field vectors after being changed by the second half-wave plate 4f2.

As shown in FIGS. 31 and 35, the electric field vectors 90° inclined relative to the second wave-plate orientation Q2 in FIGS. 30 and 34 are not changed under the influence of the second wave-plate orientation Q2. By contrast, the electric field vectors aligned with the second wave-plate orientation Q2 in FIGS. 30 and 34 are inverted (see FIGS. 32B, 32C, 36B, and 36C).

On the other hand, as shown in FIGS. 31 and 35, of the electric field vectors shown in FIGS. 30 and 34, those inclined by −45° in terms of a counter-clockwise azimuth angle (−) relative to the second wave-plate orientation Q2 point in the radial direction, being inclined by −90° in terms of a counter-clockwise azimuth angle (−) (see FIGS. 32B, 32C, 36B, and 36C).

Moreover, of the electric field vectors shown in FIGS. 30 and 34, those inclined by +45° in terms of a clockwise azimuth angle (+) relative to the second wave-plate orientation Q2 point in the radial direction, being inclined by +90° in terms of a clockwise azimuth angle (+) (see FIGS. 32B, 32C, 36B, and 36C).

In this way, by passing through the two half-wave plates 4 (4f1 and 4f2) as described above, A-mode light becomes light of which the most part is radially polarized waves R (a radially polarized beam). Here, while passing through the first half-wave plate 4f1, part of the electric field vectors pointing in the azimuth angle direction change into radially polarized waves R (see the radially polarized waves R shown in FIGS. 32B and 36B). Thus, simply by passing through the first half-wave plate 4f1, A-mode light becomes light of which a comparatively large part is radially polarized waves R.

5. Examples of Various Features

5-1. Light Sources in the Light-Condensing Head

As described above, in the light-condensing head 55 of this embodiment, the light source unit 1 produces light containing radially polarized waves R. Specifically, the light source unit 1 includes a semiconductor laser (the 2-D PCL 3) that includes: an active layer 35 that emits light when carriers are injected thereinto; and clad layers (a first n-type clad layer 32 and a second n-type clad layer 36) that totally reflect light to confine it inside the active layer 35, wherein a two-dimensional periodic structure (the photonic crystal 34) formed of two materials having different refractive indices is formed in at least one of the active layer 35 and the clad layers (for example, in the first n-type clad layer 32).

This 2-D PCL 3 is so designed that at least one of a plurality of periods in the photonic crystal 34 is equal to an integer times the wavelength λ of the light from the active layer 35. That is, the 2-D PCL 3 achieves laser oscillation by exploiting the resonance that occurs at the band edge of the Γ point in the photonic band structure.

More precisely put, laser oscillation occurs as a result of the interval of at least one of a plurality of periods in a two-dimensional periodic structure being made equal to the peak gain wavelength of the TE mode light (which will be described in detail later) emitted from the active layer 35.

This laser oscillation may produce B-mode light as described previously (see FIG. 11). Such B-mode light contains, at least as part thereof, polarized waves that constitute a radial electric field vector distribution (more precisely put, electric field vectors (radially polarized waves R) that constitute a rotation-symmetric radiating electric field vector distribution and that have equal magnitudes at equal distances from the center of rotation symmetry). Specifically, it contains radially polarized waves R that are composed of electric field vectors having two mutually perpendicular directions (1D and 2D) and that constitute an electric field vector distribution having rotation symmetry of order four.

These radially polarized waves R, even after having passed through the light-condensing elements (the objective lens 42 and the hemispherical lens 43), do not produce S-polarized light. That is, the radially polarized waves R having passed through the light-condensing elements contain P-polarized light alone. Thus, when the electrically conductive scatterer 2 is irradiated with light containing more radially polarized waves R (a radially polarized beam), localized plasmon LP, which is produced by P-polarized light, can be produced efficiently.

Relative to the first (1D) of the two directions (1D and 2D) of the radially polarized waves R, a clockwise azimuth angle is given a positive sign “+”, and a counter-clockwise azimuth angle is given a negative sign “−”. Then, B-mode light contains electric field vectors pointing in the direction (+45D)+45° inclined relative to the first direction (1D) and electric field vectors pointing in the direction (−45D)−45° inclined relative to the first direction (1D). The light of these electric field vectors pointing in the +45° direction (+45D) and in the −45° direction (−45D), by passing through the light-condensing elements, becomes S-polarized light, and therefore does not contribute to producing localized plasmon LP.

For this reason, in this embodiment, various schemes are adopted to increase the proportion of the radially polarized waves R in light. For example, for B-mode light, a scheme is adopted that changes the light of the electric field vectors pointing in the +45° direction (+45D) and in the −45° direction (−45D) into radially polarized waves R.

An example of such a scheme is Scheme 1 employing a half-wave plate 4 (4f1) (see FIGS. 21 to 23). Specifically, the light source unit 1 includes: a 2-D PCL 3; and a half-wave plate 4 through which the light emitted from the 2-D PCL 3 is passed and that controls the polarization direction thereof. What is particular with this scheme is that the orientation of the half-wave plate 4 (the first wave-plate orientation Q (Q1)) is aligned with one of the two directions (1D and 2D) of the radially polarized waves R.

This scheme works as follows. The electric field vectors of the radially polarized waves R are either aligned with or 90° inclined relative to the wave-plate orientation Q. Thus, even after having passed through the half-wave plate 4, the radially polarized waves R remains containing electric field vectors that constitute a rotation-symmetric radiating electric field vector distribution and that have equal magnitude at equal distances from the center of rotation symmetry.

However, the electric field vectors pointing in the −45° direction (−45D) are inclined by +45° in terms of a clockwise azimuth angle (+) relative to the wave-plate orientation Q, the electric field vectors pointing in the +45° direction (+45D) are inclined by −45° in terms of a counter-clockwise azimuth angle (−) relative to the wave-plate orientation Q. Thus, by passing through the half-wave plate 4, the electric field vectors pointing in the −45° direction (−45D) get inclined by +90° in terms of a clockwise azimuth angle (+) relative to their original inclination, and the electric field vectors pointing in the +45° direction (+45D) get inclined by −90° in terms of a counter-clockwise azimuth angle (−) relative to their original inclination.

Thus, the electric field vectors pointing in the +45° direction (+45D) and the electric field vectors pointing in the −45° direction (−45D) become electric field vectors that constitute a rotation-symmetric radiating electric field vector distribution and that have equal magnitudes at equal distances from the center of rotation symmetry (radially polarized waves R).

In this way, B-mode light, by passing through a half-wave plate 4 having a wave-plate orientation Q aligned with one of the polarization directions (1D and 2D) of the radially polarized waves R originally contained in the B-mode light, becomes light of which the most parts is radially polarized waves R (a radially polarized beam). Thus, with a light source unit 1 that adopts Scheme 1, the electrically conductive scatterer 2 can be irradiated with a radially polarized beam.

Even with a light source unit 1 that adopts Scheme 2 described previously, it is possible to produce a radially polarized beam (see FIGS. 25 to 28). In the B-mode light that has undergone Steps 1 and 2 of Scheme 2, the electric field vectors originally pointing in the +45° direction (+45D) and in the −45 direction (−45D), which constitute a large proportion of the light, change into radially polarized waves R (see FIGS. 28A and 28C). As a result, B-mode light, even by passing through two half-wave plates 4 (4f1 and 4f2), comes to contain more radially polarized waves R than it originally does. Hence, it can be said that even the B-mode light that has undergone Steps 1 and 2 of Scheme 2 contains enough radially polarized waves R.

The light source unit 1 that performs Steps 1 and 2 in Scheme 2 includes: a 2-D PCL 3; and two half-wave plates 4 (4f1 and 4f2) that are laid together and that, while transmitting the B-mode light from the 2-D PCL 3, controls the polarization direction thereof. What is particular here is that the orientation of the first half-wave plate 4f1 (i.e. the first wave-plate orientation Q1) is inclined by +45° in terms of a clockwise azimuth angle (+) relative to one of the two directions (1D and 2D) of the half-wave plate 4. Moreover, the orientation of the second half-wave plate 4f2 (i.e. the second wave-plate orientation Q2) is inclined by −45° in terms of a counter-clockwise azimuth angle (−) relative to the first wave-plate orientation Q1.

The laser oscillation of the 2-D PCL 3 occurs also with the A-mode light described previously (see FIG. 9). Thus, it is preferable to adopt some scheme for A-mode light in order to make it contain radially polarized waves R. For this purpose, in this embodiment, Scheme 3 described above is adopted according to which the A-mode light of the 2-D PCL 3 is passed through two half-wave plates 4 (4f1 and 4f2) (see FIGS. 29 to 36).

What is notable with Scheme 3 is that radially polarized waves R are produced in the A-mode light that has passed through the first half-wave plate 4f1. Hence, it can be said that even the A-mode light that has undergone Steps 1 of Scheme 3 contains enough radially polarized waves R.

A-mode light contains, at least in part thereof, electric field vectors that constitute a rotation-symmetric radiating electric field vector distribution, that have equal magnitudes at equal distances from the center of rotation symmetry, and that point in the azimuth angle direction (see FIGS. 29 and 33). The azimuth angle direction here permits the orientation of the first half-wave plate 4f1 (the first wave-plate orientation Q1) to point in any direction along the plane perpendicular to the optical axis AX of the A-mode light. Hence, the light source unit 1 that performs Step 1 of Scheme 3 has simply to include: a 2-D PCL 3; and one half-wave plate 4f1 that, while transmitting the A-mode light from the 2-D PCL 3, controls the polarization direction thereof.

With this design, the electric field vectors pointing in the azimuth angle direction mainly contain: (1) electric field vectors aligned with the first wave-plate orientation Q1; (2) electric field vectors inclined by 90° relative to the first wave-plate orientation Q1; (3) electric field vectors inclined by −45° in terms of a counter-clockwise azimuth angle (−) relative to the first wave-plate orientation Q1; and (4) electric field vectors inclined by +45° in terms of a clockwise azimuth angle (+) relative to the first wave-plate orientation Q1 (see FIGS. 32A and 36A).

Thus, while the electric field vectors (1) are inverted relative to their original inclination, the electric field vectors (2) remain unchanged relative to their original inclination (these changes are called Changes (1) and (2)). Moreover, the electric field vectors (3) are inclined by −90° clockwise (−) relative to their original inclination, and the electric field vectors (4) are inclined by +90° counter-clockwise (+) relative to their original inclination (these changes are called Changes (3) and (4)).

Here, Changes (3) and (4) make the electric field vectors point in the radial direction. Thus, A-mode light, simply by passing through the first half-wave plate 4f1, comes to contain comparatively a large proportion of radially polarized waves R (see FIGS. 32B and 36B).

According to Scheme 3, the light that has come to contain, as part thereof, radially polarized waves R through Step 1 is subjected to Step 2 so as the contain more radially polarized waves R. For this purpose, the light source unit 1 includes a second half-wave plate 4f2, which is arranged to overlap the first half-wave plate 4f1. What is particular here is that, when relative to the first wave-plate orientation Q1 a clockwise azimuth angle is given a positive sign “+” and a counter-clockwise azimuth angle is given a negative sign “−”, the second half-wave plate 4f2 is arranged with its orientation (the second wave-plate orientation Q2) inclined by +45° or −45° relative to the first wave-plate orientation Q1.

With this design, the radially polarized waves R produced through Changes (3) and (4) contain electric field vectors inclined by 90° relative to the second wave-plate orientation Q2 and electric field vectors aligned with the second wave-plate orientation Q2 (see FIGS. 32B and 36B). Thus, the electric field vectors inclined by 90° relative to the second wave-plate orientation Q2 do not change under the influence of the second wave-plate orientation Q2, and the electric field vectors aligned with the second wave-plate orientation Q2 are inverted. Thus, the radially polarized waves R produced through Changes (3) and (4) remain fulfilling the requirements for radially polarized waves R (see FIGS. 32C and 36C).

On the other hand, the electric field vectors that have gone through Changes (1) and (2) contain those inclined by −45° in terms of a counter-clockwise azimuth angle (−) relative to the second wave-plate orientation Q2 and those inclined by +45° in terms of a clockwise azimuth angle (+) relative to the second wave-plate orientation Q2 (see FIGS. 32B and 36B). Thus, the electric field vectors inclined by −45° in terms of a counter-clockwise azimuth angle (−) relative to the second wave-plate orientation Q2 are inclined by −90° in terms of a counter-clockwise azimuth angle (−) relative to their original inclination so as to point in the radial direction; on the other hand, the electric field vectors inclined by +45° in terms of a clockwise azimuth angle (+) relative to the second wave-plate orientation Q2 are inclined by +90° in terms of a clockwise azimuth angle (+) relative to their original inclination so as to point in the radial direction (see FIGS. 32C and 36C).

Hence, by passing through the two half-wave plates 4 (4f1 and 4f21) described above, A-mode light becomes light of which the most part is radially polarized waves R (i.e. radially polarized beam).

5-2. Electrically Conductive Scatterer in the Light-Condensing Head

In the light-condensing head 55 of this embodiment, the light-receiving portion 2a of the electrically conductive scatterer 2, that is, the part thereof for receiving the light from the 2-D PCL 3, has rotation symmetry of order three or more. For example, the electrically conductive scatterer 2 is plate-shaped, and the light-receiving portion 2a has the shape of a perfect circle, a right triangle, or a more-sided right polygon.

With this design, the light from the 2-D PCL 3 which contains radially polarized waves R (i.e., the electric field vectors of the radially polarized waves R) and the electric charges in the rotation-symmetric light-receiving portion 2a oscillate in the radial direction. Thus, localized plasmon LP can be produced efficiently in an edge part of the electrically conductive scatterer 2.

The electrically conductive scatterer 2 may have the shape of a columnar solid that extends in the travel direction of the light from the light-receiving portion 2a, or may have the shape of a pyramidal solid that extends in the travel direction of the light from the light-receiving portion 2a.

Irrespective of whether the electrically conductive scatterer 2 has the shape of a plate, column, or pyramid, it is preferable that conditional formula (1) noted earlier be fulfilled. When conditional formula (1) is fulfilled, near-field light is produced with a proper size without inviting Problems 1 and 2 described earlier.

Where the electrically conductive scatterer 2 is pyramid-shaped, it is preferable that conditional formulae (2) and (2′) be fulfilled. When conditional formulae (2) and (2′) are fulfilled, localized plasmon itself is produced in the light-receiving portion 2a, which is larger than the tip end of the electrically conductive scatterer 2; thus, the localized plasmon LP produced in the light-receiving portion 2a, which spreads over a comparatively large area, concentrates at the tip end of the pyramidal shape. Thus, it is possible to efficiently augment the light intensity of the near-field light.

In a peripheral part of the light-receiving portion 2a of the electrically conductive scatterer 2, there may be provided, for example, a rotation-symmetric periodic structure; that is, there may be provided a periodic structure that produces SPP. In the electrically conductive scatterer 2 having such a periodic structure, at the center of the rotation-symmetric periodic structure, there may be provided a column-shaped protrusion 2e; or, at the center of the rotation-symmetric periodic structure, there may be provided a pyramid-shaped protrusion 2f.

Where a column-shaped protrusion 2e is provided, the SPP produced at the electrically conductive scatterer 2 is propagated along the column-shaped protrusion 2e. Thus, around the tip end of the column-shaped protrusion 2e, localized plasmon LP is produced. Hence, if the column-shaped protrusion 2e is arranged close to the disk 80, the near-field light whose light intensity has been augmented by the SPP strikes, as a very small spot, the disk 80. In this way, it is possible, without bringing the light-receiving portion 2a itself of the electrically conductive scatterer 2 closer to the disk 80, simply by bringing the column-shaped protrusion 2e closer thereto, to surely irradiate the disk 80 with near-field light.

On the other hand, where a pyramid-shaped protrusion 2f is provided, the SPP produced at the electrically conductive scatterer 2 concentrates at the pyramid-shaped protrusion 2f. Thus, at the tip end of the pyramid-shaped protrusion 2f, localized plasmon LP is produced. Hence, with localized plasmon LP further enhanced through concentration, the light intensity of the near-field light is efficiently augmented.

### Embodiment 2

A second embodiment of the present invention will be described below. Such members as are used or find their counterparts in the first embodiment will be identified with common reference numerals and symbols, and no explanations thereof will be repeated.

In the first embodiment, the light source unit 1 includes a half-wave plate 4 to make light contain more radially polarized waves R. The present invention, however, is not limited to such a design. For example, the light source unit 1 may instead include a polarization rotator (a scheme that employs a polarization rotator is called Scheme 4).

Scheme 4

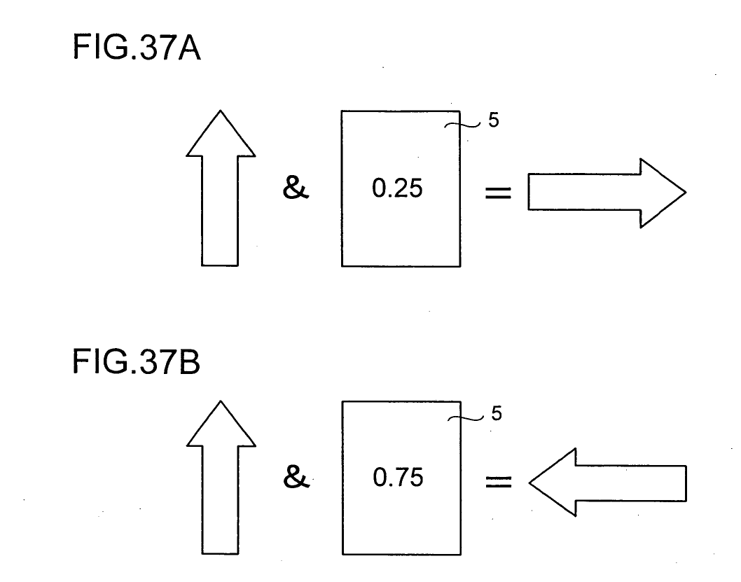

A polarization rotator rotates the direction of the electric field vectors of light (its polarization direction). FIGS. 37A and 37B show how a polarization rotator 5 changes an electric field vector. The symbol “&” denotes that light with electric field vectors as indicated by an arrow with a hollow inside is passed through a polarization rotator 5 with a rotating power of 0.25 or 0.75, and the symbol “=” denotes that what follows it is the state after the passage through the polarization rotator 5. Where a polarization rotator is used, as opposed to where a half-wave plate is used, the direction of the electric field vectors of light is rotated through 90° irrespective of their original direction.

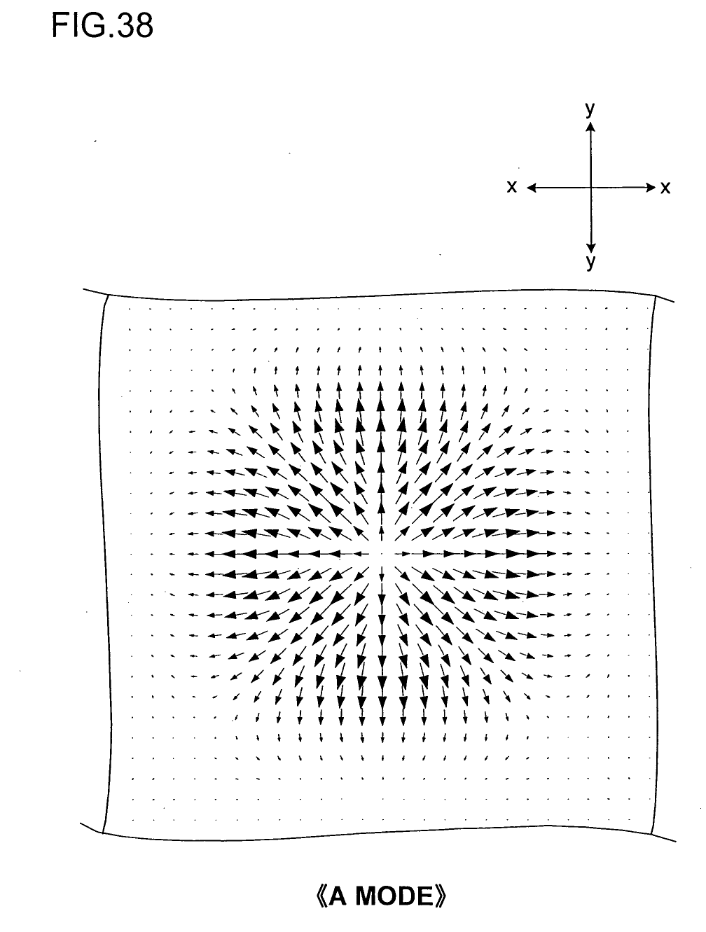

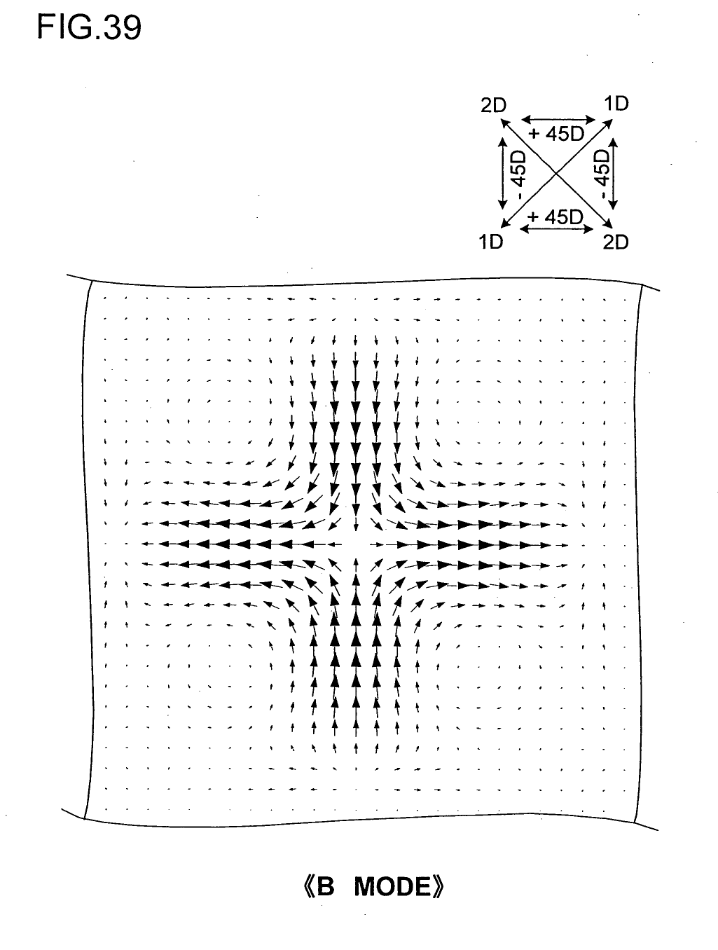

As shown in FIGS. 37A and 37B, with a rotating power of 0.25 or 0.75, the direction of electric field vectors is rotated through 90° (perpendicularly rotated). Hence, when A-mode light or B-mode light as shown in FIG. 9 or 11 is passed through a polarization rotator 5 with a rotating power of 0.25/0.75, it comes to show an electric field vector distribution as shown in FIG. 38 or 39.

Specifically, with A-mode light, the electric field vectors pointing in the azimuth angle direction in FIGS. 9 and 10 are rotated through 90° so as to point in the radial direction (see FIG. 38). Thus, A-mode light comes to contain a very large proportion of electric field vectors that constitute a rotation-symmetric radiating electric field vector distribution and that have equal magnitudes at equal distances from the center of rotation symmetry (radially polarized waves R); that is, it becomes a radially polarized beam.

On the other hand, with B-mode light, the electric field vectors pointing in the −45° direction (−45D) and in the +45° direction (+45D) in FIGS. 11 and 12 are rotated through 90° so as to point in the radial direction; that is, it becomes radially polarized waves R (see FIG. 39). However, the electric field vectors pointing in the two directions (1D and 2D) in FIGS. 11 and 12 are rotated through 90° so as to point in the azimuth angle direction (see FIG. 39). Thus, the B-mode light comes to contain a higher proportion of radially polarized waves R than it originally does. Hence, the light comes to contain enough radially polarized waves R.

Where the proportion of radially polarized waves R is increased by use of a polarization rotator 5 in this way, it is simply necessary that a polarization rotator 5 with a single rotating power be so arranged that the light from the 2-D PCL 3 passes therethrough. That is, it is not necessary to use a polarization rotator with a plurality of rotating powers (a combined polarization rotator) as is conventionally necessary. Thus, it can be said that it is no longer necessary to perform the positioning (alignment of the center of the light beam with the center, within the plane, of the combined polarization rotator) that is conventionally necessary where a combined polarization rotator is used to produce radially polarized waves R or the like.

Moreover, where a polarization rotator 5 is used, the electric field vectors originally pointing in the +45° direction (+45D) and in the −45° direction (−45D) which constitute a large proportion of the light change into radially polarized waves R (see FIGS. 11 and 39). Thus, by passing the polarization rotator 5, B-mode light comes to contain more radially polarized waves R than it originally does.

### Embodiment 3

A third embodiment of the present invention will be described below. Such members as are used or find their counterparts in the first and second embodiments will be identified with common reference numerals and symbols, and no explanations thereof will be repeated.

In the first and second embodiments, the light emitted from the 2-D PCL 3 is passed trough a half-wave plate 4 or through a polarization rotator 5 so as to contain more radially polarized waves R. The present invention, however, is not limited to such a design. For example, the light emitted from the 2-D PCL 3 may itself contain radially polarized waves R.

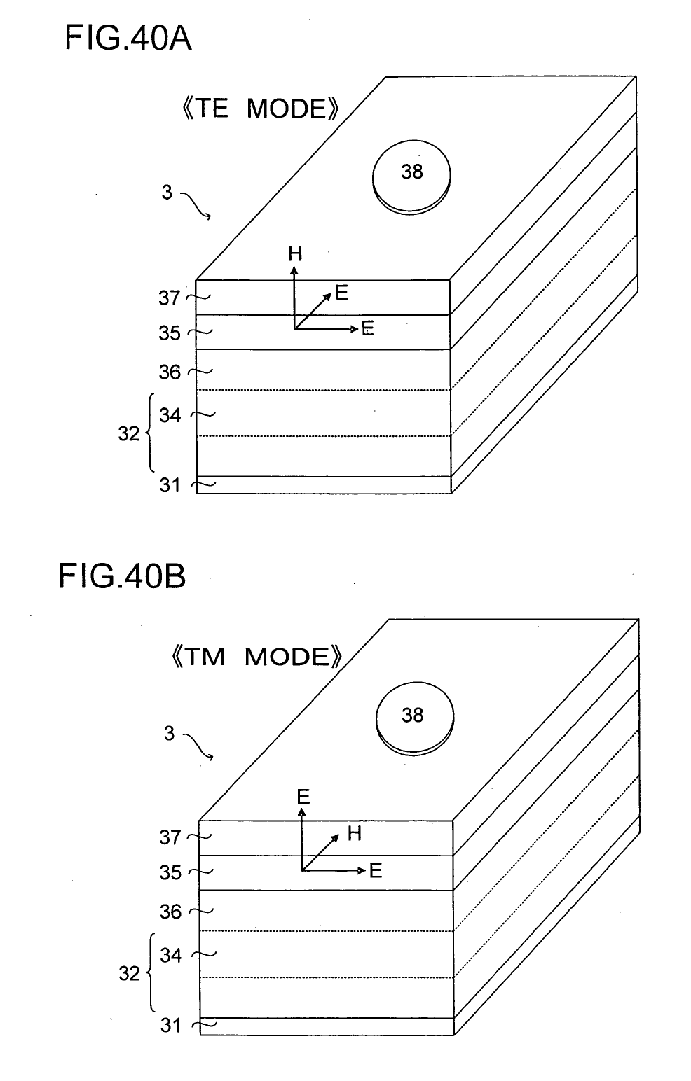

Specifically, the TM oscillation mode of the 2-D PCL 3 is exploited. Normally, a semiconductor laser has TE oscillation mode (TE mode) and TM oscillation mode (TM mode). Accordingly, as shown in FIG. 40, the 2-D PCL 3 has TE oscillation mode, in which it produces an electric field E parallel to and a magnetic field H perpendicular to the layer surface of the active layer 35 (see FIG. 40A), and TM oscillation mode, in which it produces a magnetic field H parallel to and an electric field E perpendicular to the layer surface of the active layer 35 (see FIG. 40B).

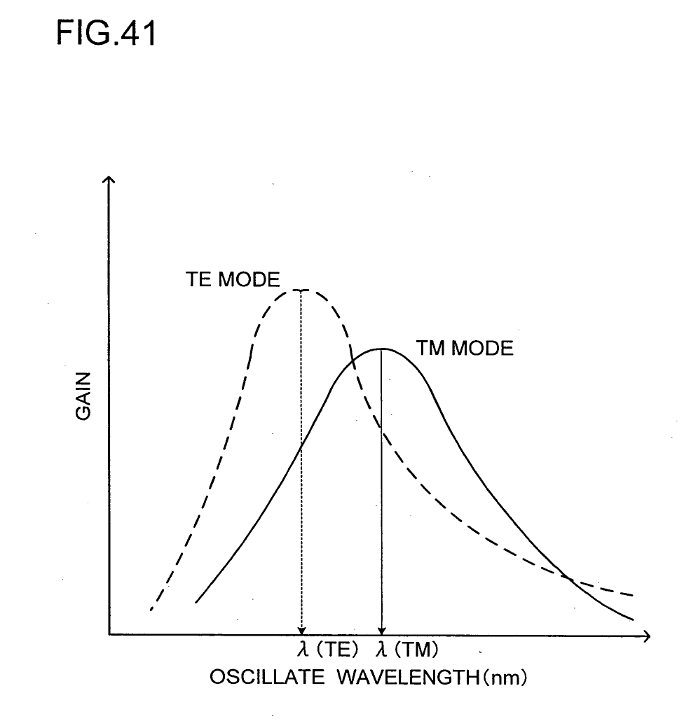

The relationship between the gains (GAIN) in TE and TM oscillation modes and the oscillation wavelength (mn) (the frequency response of the gain in the active layer) is usually as shown in FIG. 41. This means that light in TE oscillation mode yields a higher gain than light in TM oscillation mode. For this reason, the 2-D PCL 3 is usually so designed as to emit light in TE oscillation mode (the light from the 2-D PCL 3 in the above description is assumed to be light in TE oscillation mode).

The 2-D PCL 3 includes a photonic crystal 34 having a two-dimensional periodic structure. Therefore, when the periodic interval of at least one of a plurality of periods of the two-dimensional periodic structure is made equal to the peak gain wavelength (λ(TM)) of the TM oscillation mode light emitted from the active layer 35, the 2-D PCL 3 can easily emit TM oscillation mode light (TM-like polarized light).

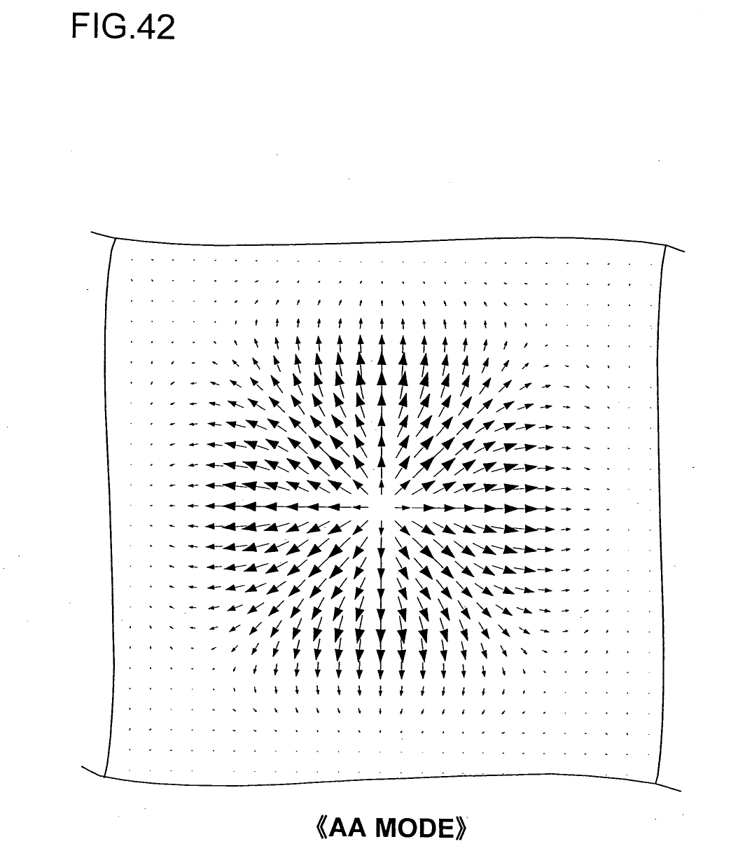

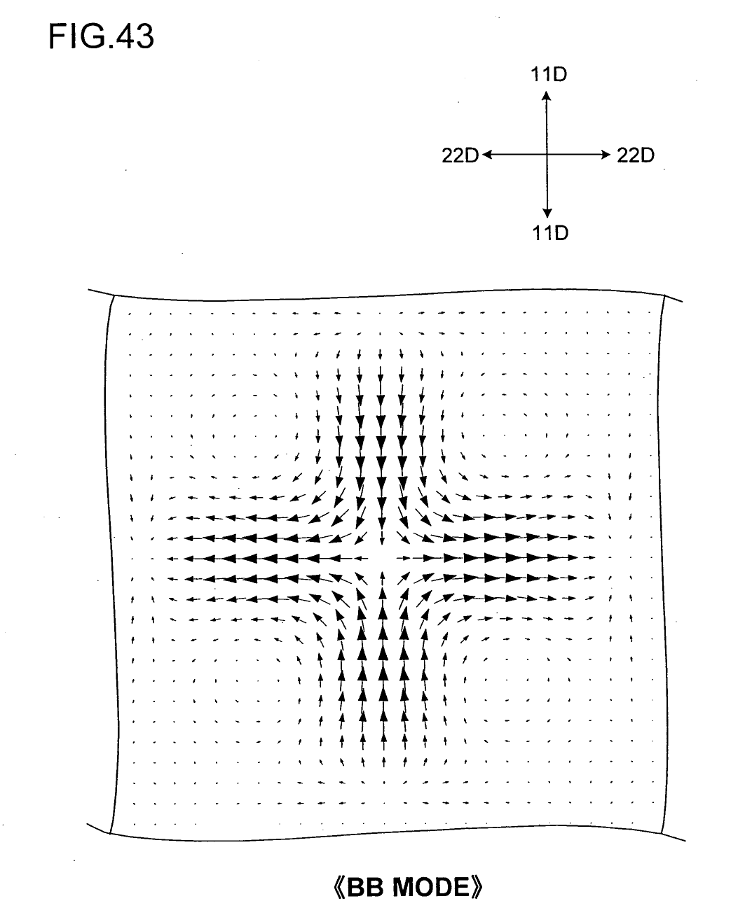

In TM oscillation mode, as in TE oscillation mode, there exist four band edges at the Γ point of the photonic band structure. In addition, again, among these band edges, two are suitable for oscillation and two are unsuitable for oscillation. Here, the band edges suitable for laser oscillation are those with the lowest and highest resonance frequencies. Accordingly, in TM oscillation mode, the band edge with the lowest resonance frequency is called “band edge AA”, and the band edge with the highest resonance frequency is called “band edge BB”. Moreover, the resonance at band edge AA is called “AA mode”, and the resonance at band edge BB is called “BB mode”. The electric field vector distributions in the light of these modes are shown in FIGS. 42 and 43.

As shown in FIG. 42, the electric field vector distribution in AA mode is that of a radially polarized beam of which the most part is radially polarized waves R containing electric field vectors that constitute a rotation-symmetric radiating electric field vectors and that have equal magnitudes at equal distances from the center of rotation symmetry.

On the other hand, as shown in FIG. 43, in the electric field vector distribution in BB mode, electric field vectors having, at least in part thereof, mutually perpendicular two directions (11D and 22D) constitute an electric field vector distribution having rotation symmetry of order four. In addition, these electric field vectors having rotation symmetry of order four point in the direction radiating from the center of rotation symmetry (i.e., the light contains a comparatively large proportion of radially polarized waves R).

Thus, when the light emitted from the active layer 35 of the 2-D PCL 3 is TM oscillation mode light, which has a magnetic field H parallel to and an electric field E perpendicular to the layer surface of the active layer 35, it is possible to easily obtain light containing a large proportion of radially polarized waves R (e.g., a radially polarized beam). This eliminates the need for a polarization control element (a half-wave plate 4 or polarization rotator 5) that, while transmitting the light from the 2-D PCL 3, controls or rotates the polarization direction thereof.

### Embodiment 4

A fourth embodiment of the present invention will be described below. Such members as are used or find their counterparts in the first to third embodiments will be identified with common reference numerals and symbols, and no explanations thereof will be repeated.

In the description of the first to third embodiments, the photonic crystal 34 is assumed to have, as a two-dimensional periodic structure, a square lattice structure. The present invention, however, is not limited to such a design. For example, the two-dimensional periodic structure may instead be a triangular lattice.

Where the two-dimensional periodic structure is a triangular lattice, just as where it is a square lattice, the periodic interval of at least one of a plurality of periods of the photonic crystal 34 is made equal to an integer times the wavelength of the light from the active layer 35. That is, also where the three-dimensional periodic structure is a triangular lattice, the 2-D PCL 3 achieves laser oscillation through resonance that occurs at a band edge of a Γ point of the photonic band structure.

More precisely put, laser oscillation may be achieved by making the periodic interval of at least one of a plurality of periods of the two-dimensional structure equal to the peak gain wavelength (λ (TE)) of the TE oscillation mode light emitted from the active layer 35 (see FIG. 41); alternatively, laser oscillation may be achieved by making the periodic interval of at least one of a plurality of periods of the two-dimensional structure equal to the peak gain wavelength (λ (TM)) of the TM oscillation mode light emitted from the active layer 35 (see FIG. 41).

1. TE Oscillation Mode in a 2-D PCL Having a Triangular Lattice as a Two-Dimensional Periodic Structure

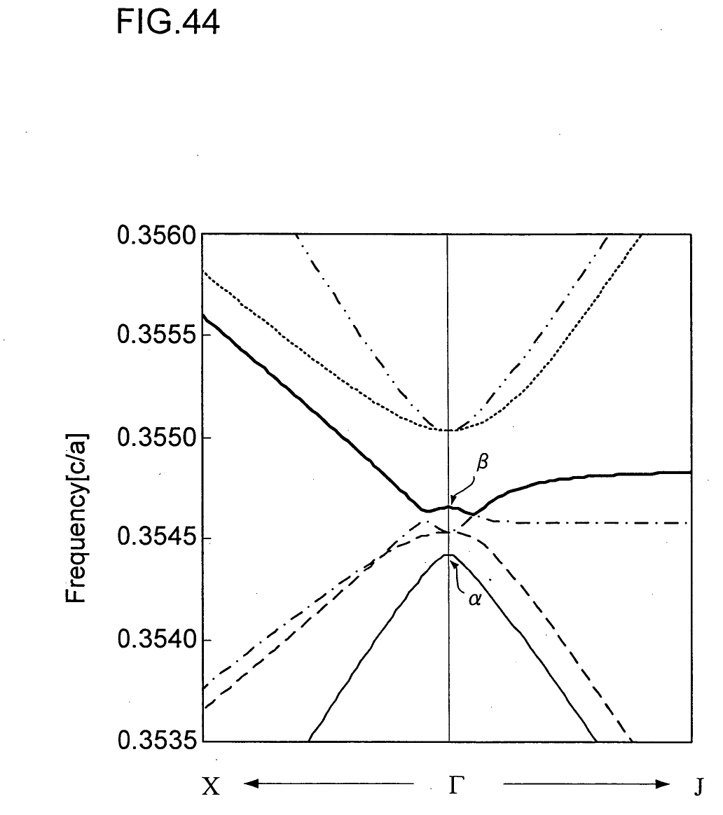

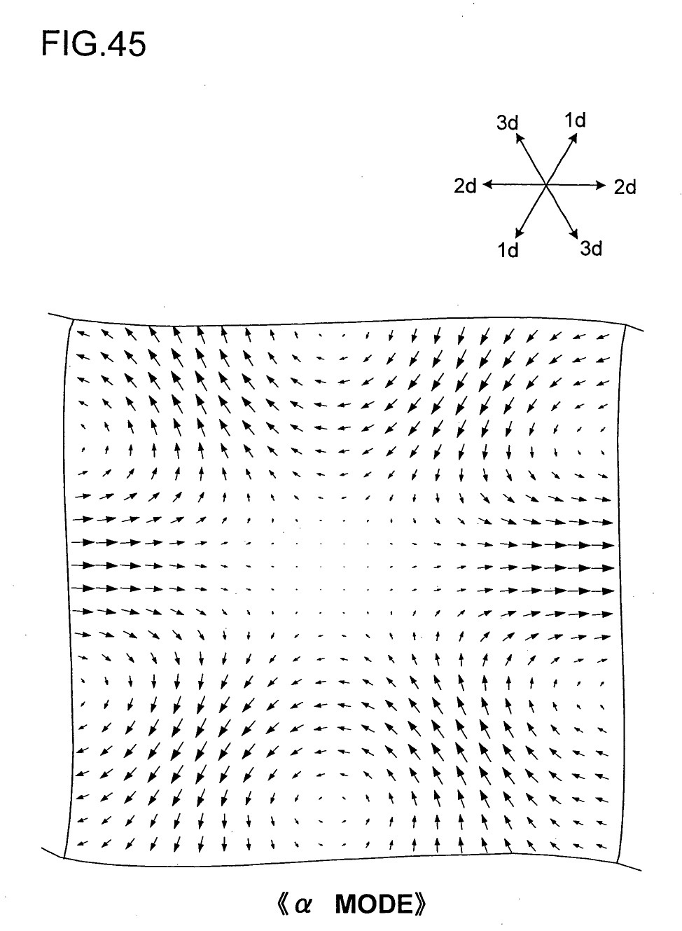

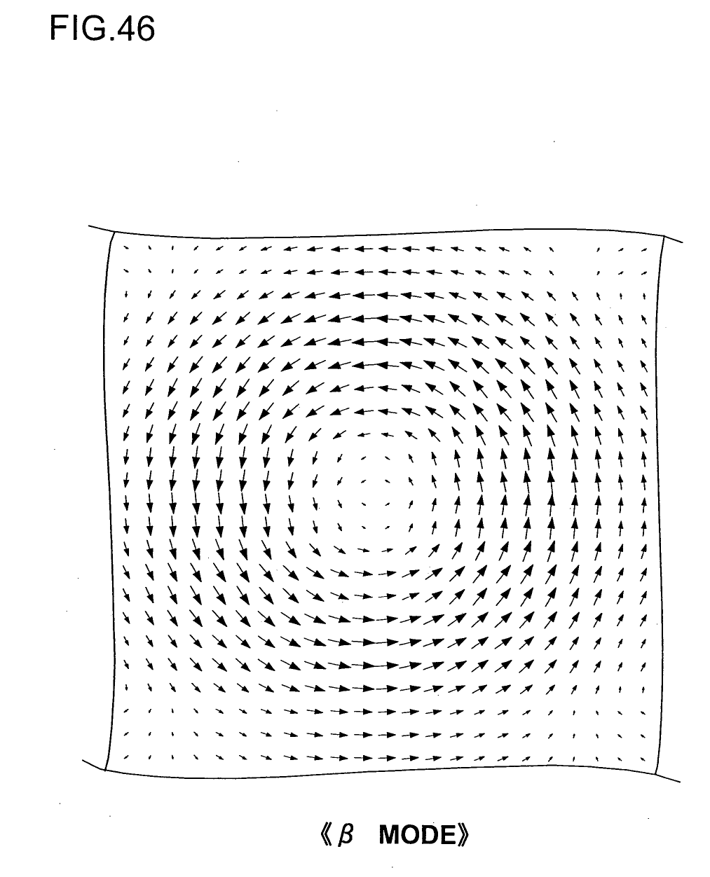

First, a description will be given of TE oscillation mode. As shown in the band diagram of FIG. 44, in TE oscillation mode, there exist six band edges, which are indicated by: 1. a solid line (α mode), 2. a broken line, 3. a dash-and-dot line, 4. a thick solid line (β mode), 5. a dotted line, and 6. a dash-dot-dot line. Among these six band edges, the one a with the lowest resonance frequency and the one β with the fourth lowest resonance frequency are suitable for laser oscillation; the other band edges, on the other hand, are unsuitable for laser oscillation. The resonance at band edge α is called “a mode”, and the resonance at band edge β is called “β mode”. The electric field vector distributions in the light of the two modes (how the light is polarized) are shown in FIGS. 45 and 46.

As shown in FIG. 45, in the electric field vector distribution in a mode, in the most part thereof, electric field vectors having three directions (1d, 2d, and 3d) 60° apart from one another constitute an electric field vector distribution having rotation symmetry of order six. In addition, these electric field vectors having rotation symmetry of order six point in the direction radiating from the center of rotation symmetry (i.e., in the radial direction). That is, α-mode light is a radially polarized beam containing a large proportion of radially polarized waves R. Thus, with α-mode light, there is no need to use a polarization control element (a half-wave plate 4 or polarization rotator 5) that, while transmitting light, controls or rotates the polarization direction thereof.

On the other hand, as shown in FIG. 46, in the electric field vector distribution in β mode, the electric field vectors point in the direction rotating about the center of the light beam (the center of rotation) (i.e., in the azimuth angle direction (in the circumferential direction)). Moreover, the electric field vectors have equal magnitudes at equal distances from the center of the light beam (the center of rotation symmetry). Thus, it can be said that, in β mode, the light from the 2-D PCL 3 contains, at least in part thereof, electric field vectors that constitute a rotation-symmetric radiating electric field vector distribution, that have equal magnitudes at equal distances from the center of rotation symmetry, and that point in the azimuth angle direction DC. Hence, it can be said that β-mode light has an electric field vector distribution similar to that of A-mode light (see FIGS. 46 and 9).

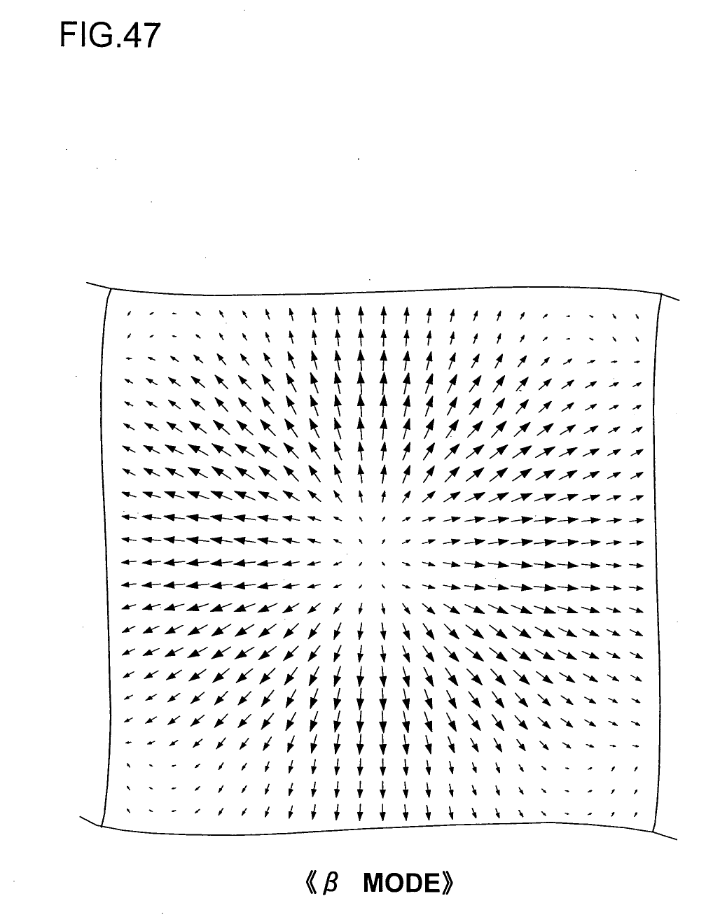

Accordingly, by adopting Scheme 3, which is adopted for A-mode light, for β-mode light, it is possible to produce light containing radially polarized waves. Instead, as described earlier in connection with the second embodiment, it is also possible to use a polarization rotator 5 with a rotating power of 0.25 or 0.75 (to adopt Scheme 4). That is, when β-mode light is passed through a polarization rotator 5 having a rotating power of 0.25/0.75, the electric field vectors pointing in the azimuth angle direction in FIG. 46 are rotated through 90° so as to point in the radial direction, becoming a radially polarized beam as shown in FIG. 47.

2. TM Oscillation Mode in a 2-D PCL Having a Triangular Lattice as a Two-Dimensional Periodic Structure

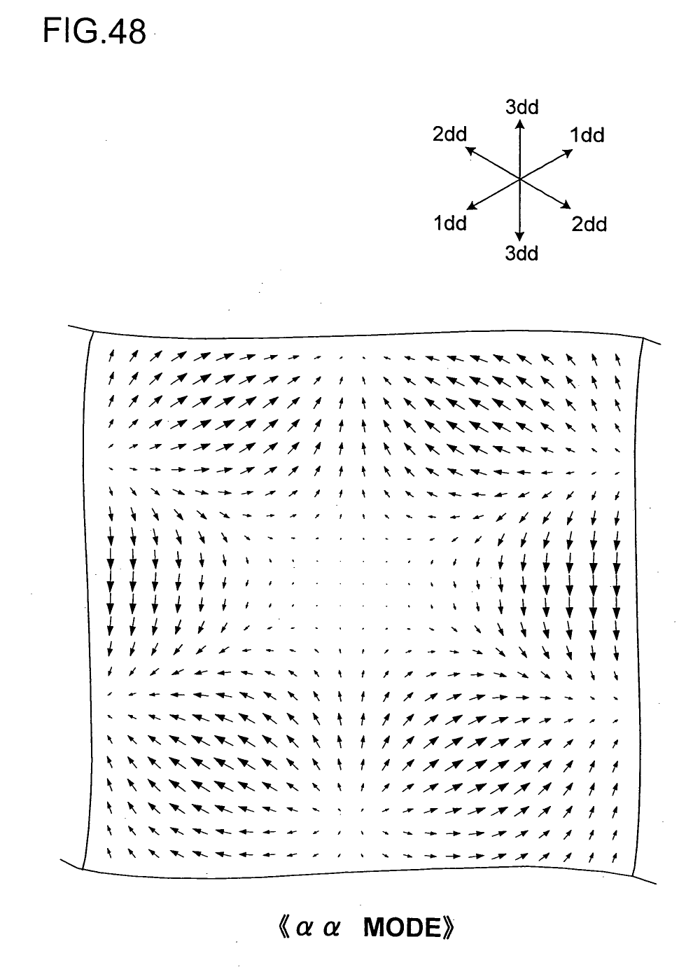

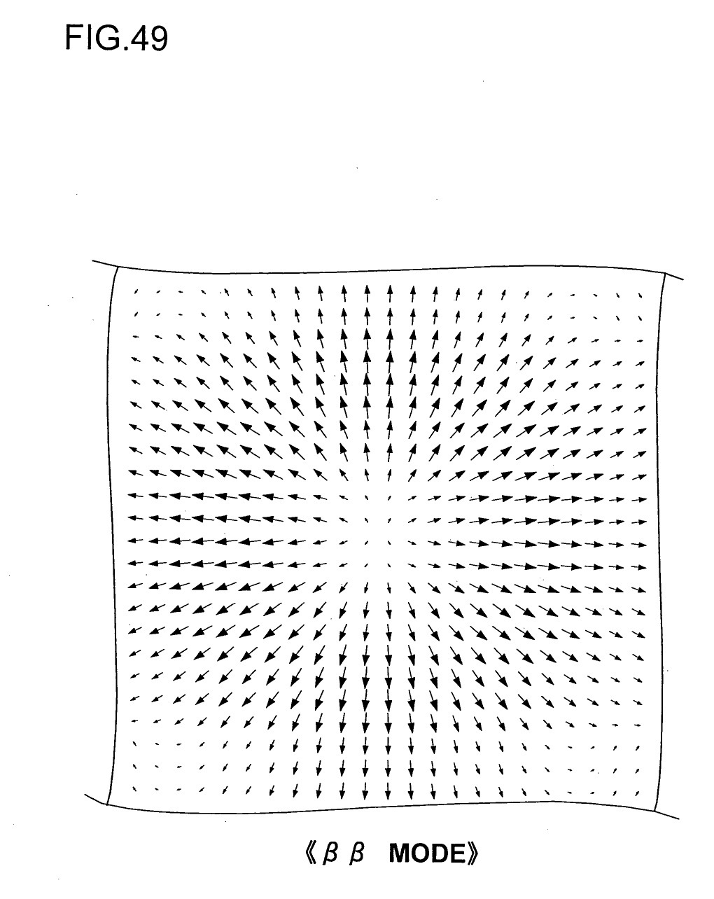

In TM oscillation mode, as in TE oscillation mode, there exist six band edges at the Γ point of the photonic band structure. Again, among these six band edges, the one with the lowest resonance frequency and the one with the fourth lowest resonance frequency are suitable for laser oscillation. Accordingly, in TM oscillation mode, the band edge with the lowest resonance frequency is called “band edge αα”, and the band edge with the fourth lowest resonance frequency is called “band edge ββ”. The resonance at band edge αα is called “αα mode”, and the resonance at band edge ββ is called “ββ mode”. The electric field vector distributions in the light of the two modes are shown in FIGS. 48 and 49.

As shown in FIG. 48, in the electric field vector distribution in αα mode, in the most part thereof, electric field vectors having three directions (1dd, 2dd, and 3dd) whose azimuth angles are 60° apart from one another constitute an electric field vector distribution having rotation symmetry of order six. In addition, these electric field vectors having rotation symmetry of order six point in the direction radiating from the center of rotation symmetry (in the radial direction). That is, αα-mode light is a radially polarized beam containing a large proportion of radially polarized waves R.

By contrast, as shown in FIG. 49, the electric field vector distribution in ββ mode is that of a radially polarized beam of which the most part is radially polarized waves R containing electric field vectors that constitute a rotation-symmetric radiating electric field vector distribution and that have equal magnitudes at equal distances from the center of rotation symmetry.

Thus, when the light emitted from the active layer 35 of the 2-D PCL 3 is TM oscillation mode light, irrespective of whether the two-dimensional periodic structure of the photonic crystal 34 is a square lattice or a triangular lattice, it is possible to easily obtain a radially polarized beam. Hence, in TM oscillation mode, there is no need to use a polarization control element (a half-wave plate 4 or polarization rotator 5) for controlling or rotating the polarization direction.

Light-Source Unit in Embodiments 1 to 4

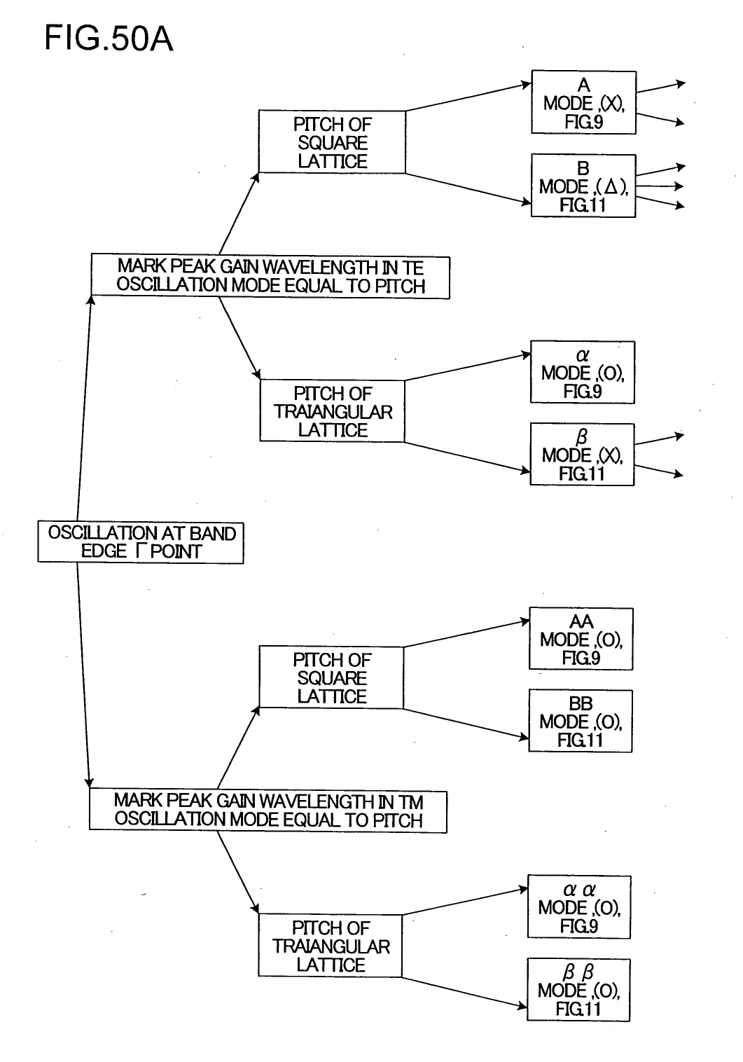

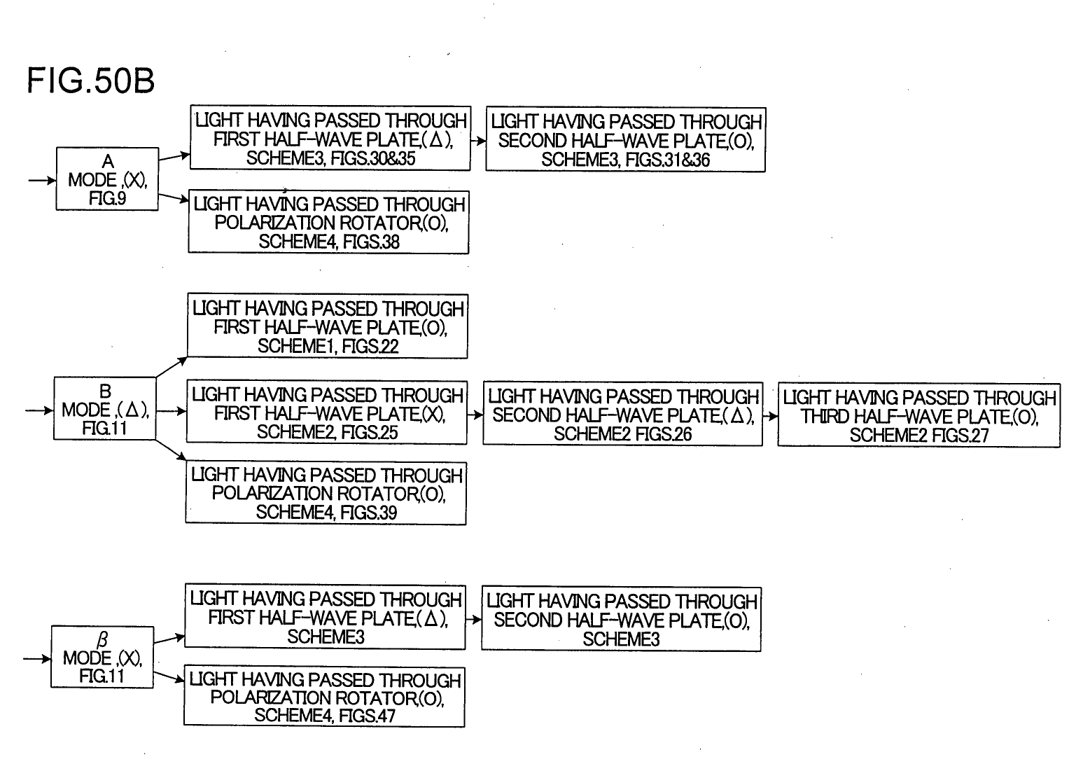

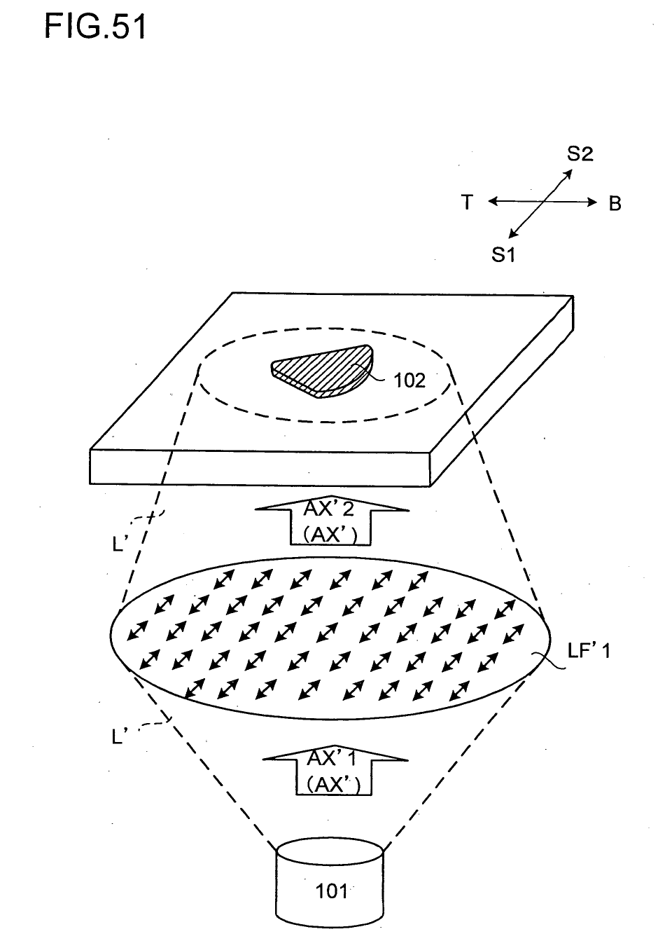

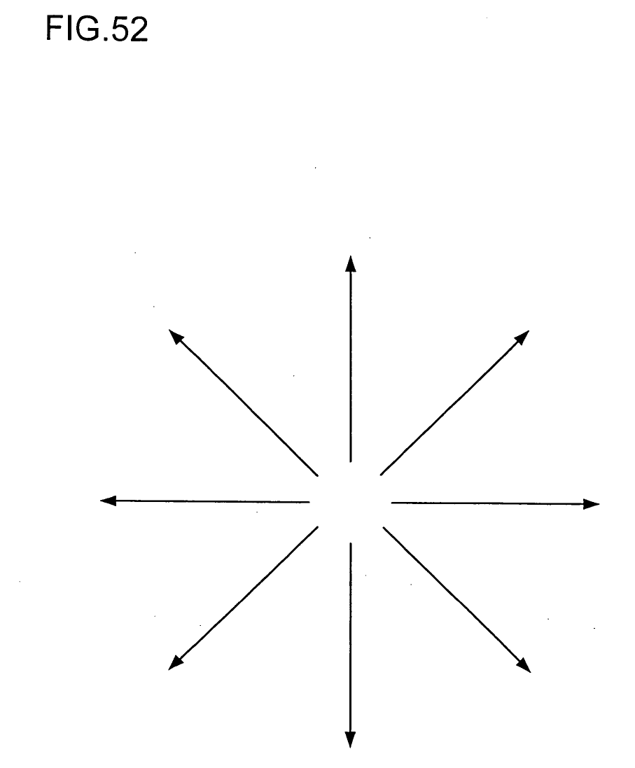

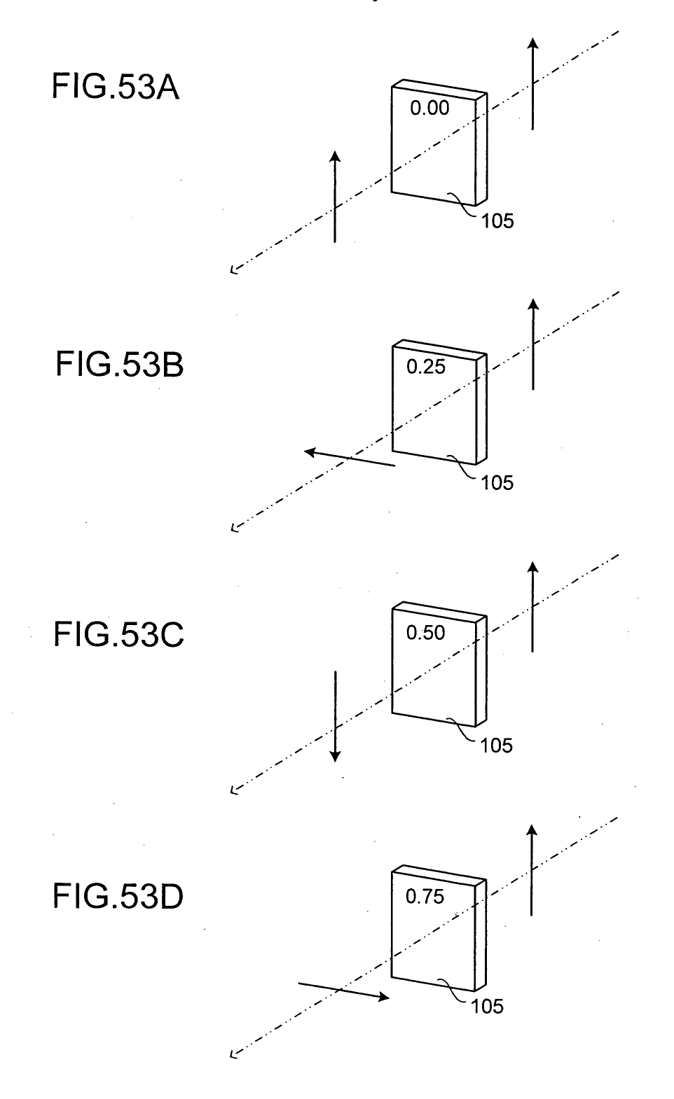

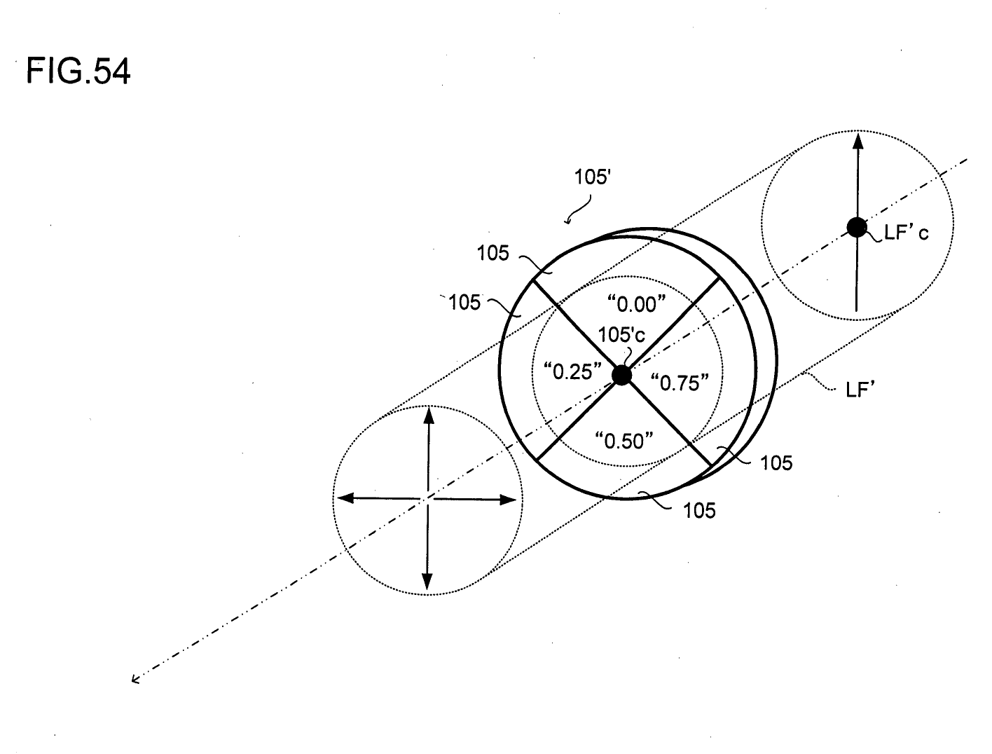

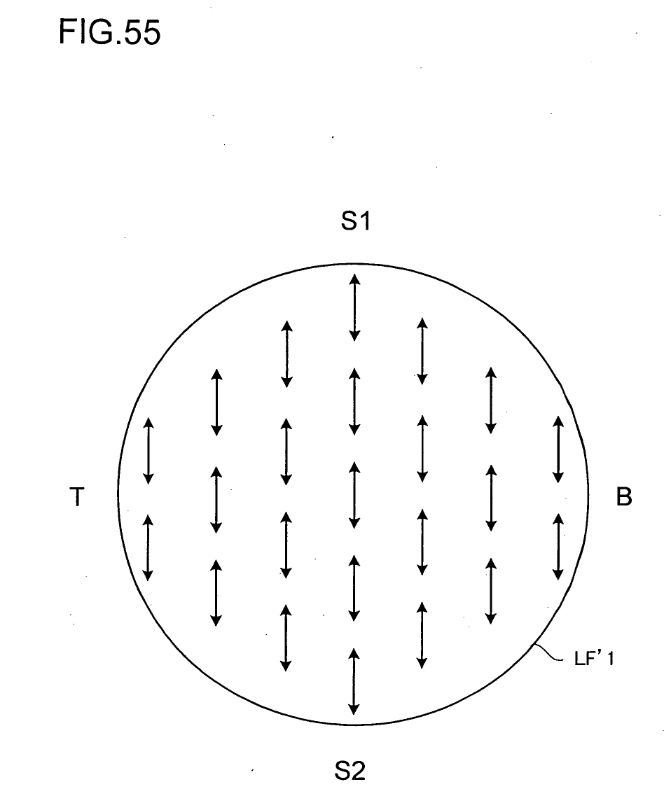

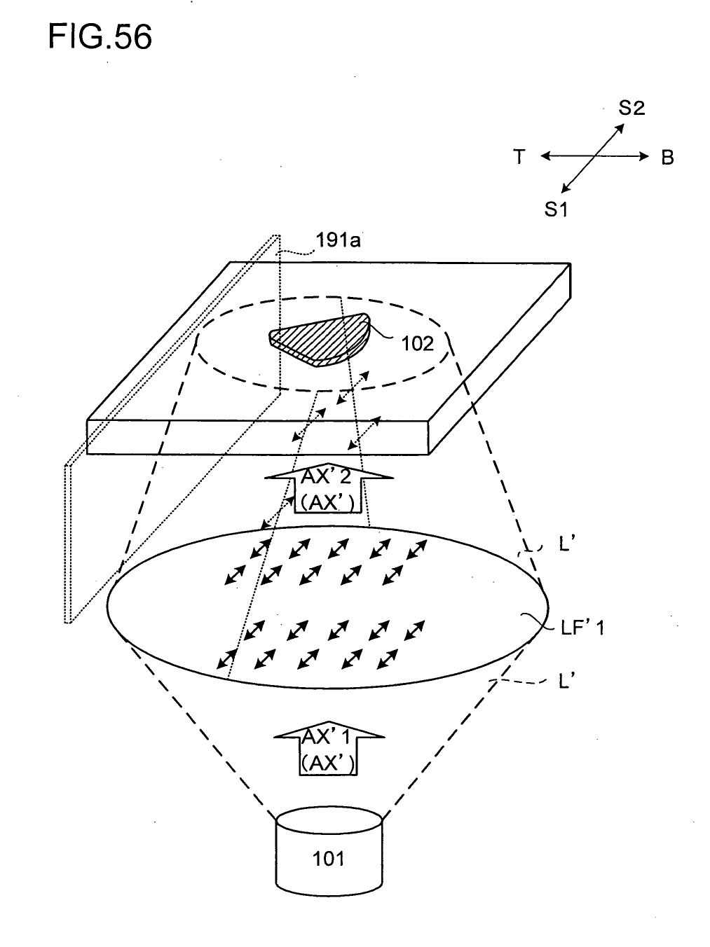

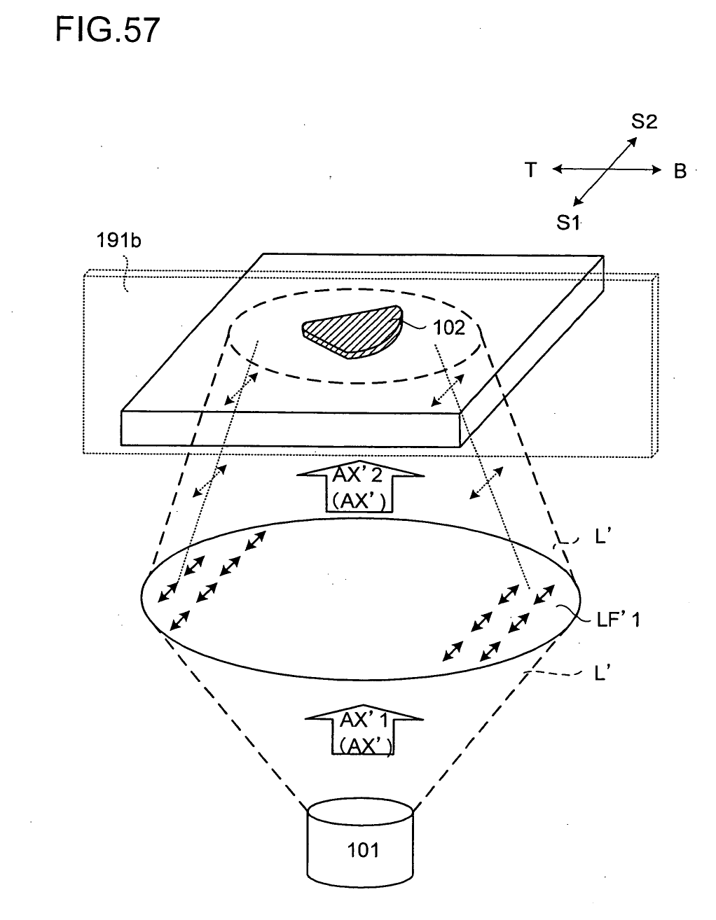

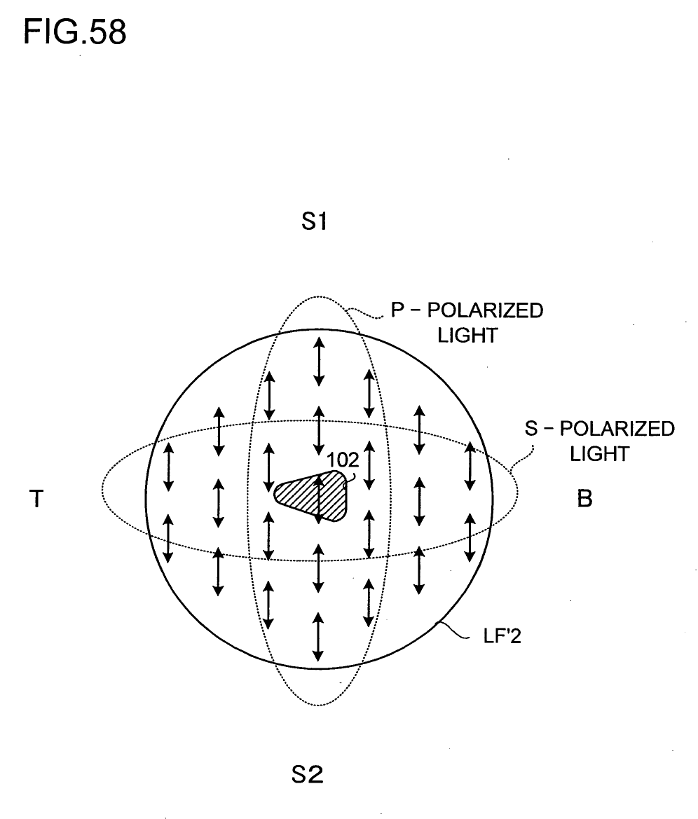

Explained in a simplified manner, the relationship of the light source unit 1 in Embodiments 1 to 4 is as shown in FIGS. 50A and 50B. In FIGS. 50A and 50B, what the symbols put in parentheses, namely “◯”, “Δ”, and “X”, indicate is as follows:
“◯” indicates a radially polarized beam;
“Δ” indicates light that contains, at least in part thereof, radially polarized waves; and
“X” indicates light that does not contain polarized waves that constitute a radiating electric field vector distribution.
   It can be said that any light indicated by “◯” or “A” can be used in the light-condensing head 55 of the embodiments.

As shown in FIGS. 50A and 50B, a light source unit 1 that can emit light containing a large proportion of radially polarized waves R can be said to be an apparatus that can produce a radially polarized beam easily and inexpensively. Thus, the invention can be grasped as a light source unit 1.

For example, the following can be said to be one invention: a light source unit 1 including: a 2-D PCL 3 including an active layer 35 that emits light when carriers are injected thereinto and a clad layer (36, 32) that the emitted light reaches, wherein the clad layer 32 has a two-dimensional periodic structure formed of two materials having different refractive indices; and a polarization control element (a half-wave plate 4 or polarization rotator 5) that controls the polarization of the light from the 2-D PCL 3.

The light source unit 1 is so designed that the 2-D PCL 3 emits light containing radially polarized waves R having an electric field vector distribution having rotation symmetry of order four produced by electric field vectors pointing in two mutually perpendicular directions (1D and 2D). Then, relative to the first direction (1D), which is one of the two directions (1D and 2D) of the radially polarized waves R, a clockwise azimuth angle can be defined as + and a counter-clockwise azimuth angle as −.

In a case where the light form the 2-D PCL 3 contains radially polarized waves, electric field vectors pointing in the direction (+45D) inclined by +45° relative to the first direction (1D), and electric field vectors pointing in the direction (−45D) inclined by −45° relative to the first direction (1D), the light source unit 1 is so designed that the orientation of a half-wave plate Q is aligned with one of the two directions (1D and 2D) of the radially polarized waves R.

That is, a light source unit 1 that can adopt Scheme 1 for B-mode light can also be grasped as an invention.

In a case where, as described just above, the light form the 2-D PCL 3 contains radially polarized waves R, electric field vectors pointing in the direction (+45D) inclined by +45° relative to the first direction (1D), and electric field vectors pointing in the direction (−45D) inclined by −45° relative to the first direction (1D), the light source unit 1 may be one including a polarization rotator 5 with such a rotating power as to perpendicularly rotate the polarization direction of the electric field vectors in the light before passing through the polarization rotator. That is, a light source unit 1 that can adopt Scheme 4 for B-mode light can also be grasped as an invention.

In a case where the light emitted from the 2-D PCL 3 contains, at least in part thereof, electric field vectors that constitute a rotation-symmetric electric field vector distribution, that have equal magnitudes at equal distances from the center of rotation symmetry, and that point in the azimuth angle direction, the light source unit 1 may include a first half-wave plate 4f1 to produce radially polarized waves R. That is, a light source unit 1 that can perform Step 1 of Scheme 3 for A-mode light or β-mode light in FIG. 50 can also be grasped as an invention.

In addition, to produce the radially polarized waves R, this light source unit 1 may further include a second half-wave plate 4f2 that, while transmitting the light from the first half-wave plate 4f1, controls the polarization direction thereof. Here, let the orientation of the first half-wave plate 4f1 be called the first wave-plate orientation Q1, let the orientation of the second half-wave plate 4f2 be called the second wave-plate orientation Q2, and, relative to the first wave-plate orientation Q1, let a clockwise azimuth angle be given a “+” sign and let a counter-clockwise azimuth angle be given a “−” sign, then what is particular is that the second half-wave plate 4f2 so arranged that the second wave-plate orientation Q2 is inclined by +45° or −45 relative to the first wave-plate orientation Q1. That is, a light source unit 1 that can adopt Scheme 3, including Steps 1 and 2, for A-mode light or β-mode light in FIGS. 50A and 50B can also be grasped as an invention.

In a case where, as described above, the light emitted from the 2-D PCL 3 contains, at least in part thereof, electric field vectors that constitute a rotation-symmetric electric field vector distribution, that have equal magnitudes at equal distances from the center of rotation symmetry, and that point in the azimuth angle direction, the light source unit 1 includes a polarization rotator 5 to produce radially polarized waves. What is particular here is that the polarization rotator 5 has such a rotating power as to perpendicularly change the polarization direction of the electric field vectors in the light before passing through the polarization rotator. That is, a light source unit 1 that can adopt Scheme 4 for A-mode light or β-mode light in FIGS. 50A and 50B can also be grasped as an invention.

The 2-D PCL 3 achieves laser oscillation through the resonance that occurs at a band edge of the Γ point of the photonic band structure. When the 2-D PCL 3 is in TM oscillation mode, at least if the lattice structure in the two-dimensional periodic structure of the photonic crystal is a square lattice or a triangular lattice, the light from the 2-D PCL 3 contains radially polarized waves R. That is, a light source unit 1 that can adopt Scheme 4 for AA-mode light, BB-mode light, αα-mode light, or ββ-mode light in FIGS. 50A and 50B can also be grasped as an invention.

By contrast, when the 2-D PCL 3 is in TE oscillation mode, at least if the lattice structure in the two-dimensional periodic structure of the photonic crystal is a triangular lattice, radially polarized waves R are produced that have an electric field vector distribution having rotation symmetry of order six produced by electric field vectors pointing in three directions whose azimuth angles are 60° apart from one another (see α-mode light in FIGS. 50A and 50B).

### Other Embodiments

The present invention is not limited to the embodiments specifically described above, and permits various modifications within the spirit of the invention.

For example, the light-emitting element used in the light source unit is not limited to a two-dimensional photonic crystal surface-emission laser; there is no particular limitation on the light-emitting element (and hence the light source unit) so long as it can produce a radially polarized beam. This is because, wherever the light with which the rotation-symmetric electrically conductive scatterer is irradiated is light containing polarized waves that constitute a radiating electric field vector distribution, in particular a radially polarized beam, it is possible to realize a light-condensing head that can efficiently produce near-field light with augmented light intensity, which is the object of the present invention.

The openings that form the two-dimensional periodic structure in the photonic crystal have been described as being cylindrical. This, however, is not meant to be taken as any limitation. What is important here is that the photonic crystal be so designed as to function as a 2-D PCL.

There is no particular limitation on the wavelength of the light emitted from the two-dimensional photonic crystal surface-emission laser. The wavelength may be, for example, 405 nm, 660 nm, or 785 nm.

Where the electrically conductive scatterer is plate-shaped, its thickness is not subject to any particular limitation. The thickness may be, for example, 20 nm. What is important here is that the electrically conductive scatterer be so designed as to be capable of producing properly sized near-field light.

In the rotation-symmetric structure of the peripheral part of the light-receiving portion of the electrically conductive scatterer that produces SPP, the rotation-symmetric periodic structure provided there is not limited to one having rotation symmetry of order infinity. It may be a periodic structure having, for example, rotation symmetry of order three or more. Even when the electrically conductive scatterer (more specifically, its light-receiving portion) has, for example, the shape of a right quadrangle, the rotation symmetry of the periodic structure is not limited to that of order four. That is, the rotation symmetry observed in the shape of the electrically conductive scatterer may be unrelated to the rotation symmetry of the periodic structure of the peripheral part of the light-receiving portion.

### SUMMARY

A first main object of the present invention is:

To produce a radially polarized beam easily and inexpensively.

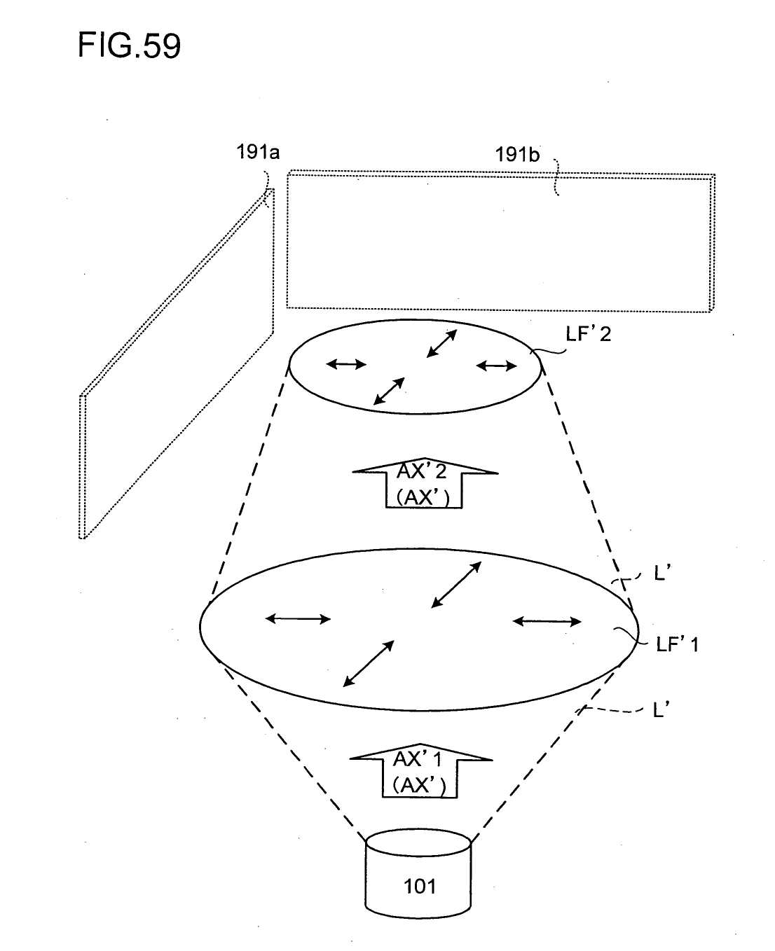

As shown FIGS. 59 to 61, the produced radially polarized beam, even after passing through a light-condensing element, only contains P-polarized light. Thus, a second main object of the present invention is:

To efficiently produce near-field light with augmented light intensity from a radially polarized beam containing only P-polarized light.

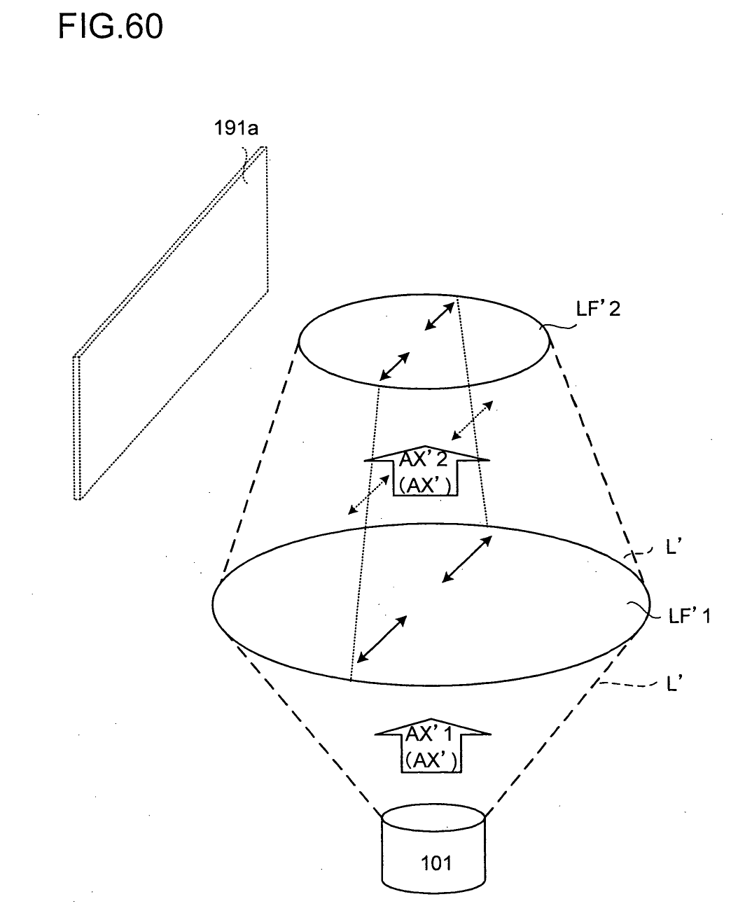

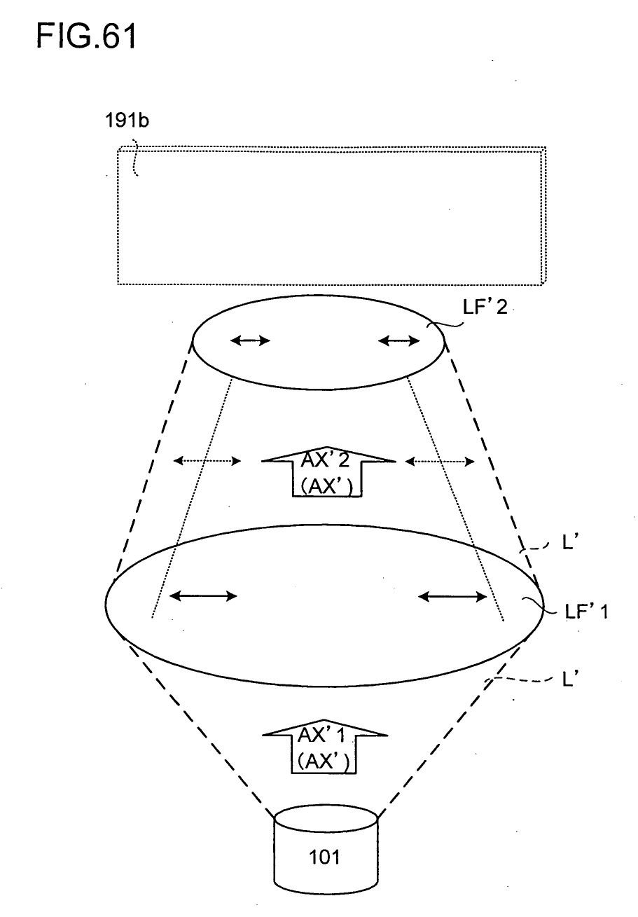

FIGS. 59 to 61 are perspective views of the light beam LF′1 before passing through the light-condensing element and the light beam LF′2 after passing through the light-condensing element. In FIG. 59, arrows indicate only one example of the polarization direction along two mutually perpendicular direction in a radially polarized beam. In FIG. 60, arrows indicate the polarization direction along one of the two directions and, in FIG. 61, arrows indicate the polarization direction along the other direction.

According to the present invention, a light-condensing head includes a light source unit, a light-condensing element that condenses the light emitted from the light source unit, and an electrically conductive scatterer that is arranged at the light condensation position of the light-condensing element and that produces plasmon when irradiated with light.

What is particular here is that the light emitted from the light source unit contains, at least in part thereof, polarized waves that constitute a radiating electric field vector distribution. On the other hand, the electrically conductive scatterer has, in its light-receiving portion for receiving light, rotation symmetry of order three or more.

More specifically, the light emitted from the light source unit contains, at least in part thereof, radially polarized waves of which the electric field vectors constitute a rotation-symmetric radiating electric field vector distribution and have equal magnitudes at equal distances from the center of rotation symmetry.

With this design, the light-receiving portion has rotation symmetry, and the light-receiving portion is irradiated with light containing polarized waves that constitute a radiating electric field vector distribution. Thus, the electric charges in the light-receiving portion having rotation symmetry and the electric field vectors pointing in the radial direction oscillate in the radial direction. As a result, in the peripheral part of the electrically conductive scatterer located further in the radial direction, plasmon (localized plasmon or the like) is produced efficiently. Then, by the electric field augmenting effect exerted by localized plasmon, the light intensity of near-field light is augmented.

Thus, according to the present invention, an electrically conductive scatterer (more specifically, its light-receiving portion) having rotation symmetry is irradiated with light containing polarized waves that constitute a radiating electric field vector distribution. Hence, the electric charges in the light-receiving portion having rotation symmetry and the electric field vectors pointing in the radial direction oscillate in the radial direction, and thus localized plasmon is produced efficiently. Consequently, by the electric field augmenting effect exerted by localized plasmon, the light intensity of near-field light is augmented.

The electrically conductive scatterer may be given any shape so long as it has rotation symmetry of order three or more. For example, the electrically conductive scatterer may be plate-shaped, with its light-receiving portion having the shape of a perfect circle, a right triangle, or a more-sided right polygon.

With a view to producing localized plasmon at the desired location, the electrically conductive scatterer may be formed as a columnar solid that extends in the travel direction of the light from the light-receiving portion. With a view to concentrating localized plasmon at one location, the electrically conductive scatterer may be formed as a pyramidal solid that extends in the travel direction of the light from the light-receiving portion.

Inconveniently, however, the localized plasmon that occurs at the light-receiving portion of the electrically conductive scatterer is easily influenced by the size of the light-receiving portion. Accordingly, the near-field light whose light intensity is augmented by the localized plasmon is also influenced by the size of the light-receiving portion. Thus, the light-receiving portion needs to be so sized as to function as a light-condensing head. One example of how the size is defined is formula (1) below.
λ/1 000≦LM1≦λ/10 (1)
where

LM1 represents the maximum width dimension of the light-receiving portion; and

λrepresents the wavelength of light.

Where the electrically conductive scatterer is formed as a pyramidal solid, localized plasmon tends to concentrate at the tip end of the pyramidal solid. Thus, again, the tip end of the pyramidal solid needs to be suitably sized. One example of how the size of the tip end and the size of the base face are defined are formulae (2) and (2′) below.
λ/1 000≦LM2≦λ/10 (2)
λ/10≦LM3≦≦λ (2′)
where
LM2 represents the maximum width dimension of the curved surface part produced at the tip end of the pyramidal solid, as measured within the plane perpendicular to the optical axis;
LM3 represents the maximum width dimension of the base face of the pyramidal solid; and
λ represents the wavelength of light.

Also when designed to produce surface plasmon, the electrically conductive scatterer may be, for example, plate-shaped, with its light-receiving portion having the shape of a perfect circle, a right triangle, or a more-sided right polygon

The surface plasmon produced by a rotation-symmetric periodic structure tends to concentrate at the center of rotation symmetry. Thus, by arranging a structure that produces localized plasmon, such as a column-shaped protrusion or a pyramid-shaped protrusion, at the center of the rotation-symmetric periodic structure, it is possible to produce localized plasmon efficiently. With a view to concentrating surface plasmon at one location, a pyramid-shaped protrusion may be provided at the center of rotation-symmetric periodic structure.

The light source unit provided in the light-condensing head includes a light-emitting element that emits light. It is preferable that the light-emitting element be a two-dimensional photonic crystal surface-emission laser that includes an active layer that emits light when carriers are injected thereinto and a clad layer that totally reflects light to confine it inside the active layer, wherein at least one of the active layer and the clad layer has a two-dimensional periodic structure (photonic crystal) formed of two materials having different refractive indices.

This is because, among various types of light-emitting element, two-dimensional photonic crystal surface-emission lasers easily produce light containing radially polarized waves. That is, the light emitted from a two-dimensional photonic crystal surface-emission laser usually contains, at least in part thereof, radially polarized waves whose electric field vectors constitute a rotation-symmetric radiating electric field vector distribution and have equal magnitude at equal distances from the center of rotation symmetry.

With a two-dimensional photonic crystal surface-emission laser, laser oscillation occurs when the periodic interval of at least one of a plurality of periods in the two-dimensional periodic structure (for example, a square or triangular lattice structure) is equal to an integer times the effective wavelength of the light propagated through the active layer (i.e., laser oscillation occurs through resonance occurring at a band edge of the Γ point of the photonic crystal).

In particular, when the periodic interval of at least one of a plurality of periods in the two-dimensional periodic structure is equal to the peak gain wavelength of the TE oscillation mode light (TE-like polarized light) emitted from the active layer (the wavelength at which the gain for the TE oscillation mode light is maximal), the laser oscillation that occurs then may by itself produce light containing radially polarized waves.

For example, at least where the lattice structure in the two-dimensional periodic structure is a square lattice, radially polarized waves are produced that have an electric field vector distribution having rotation symmetry of order four produced by electric field vectors pointing in two mutually perpendicular directions.

For another example, at least where the lattice structure in the two-dimensional periodic structure is a triangular lattice, radially polarized waves are produced that have an electric field vector distribution having rotation symmetry of order six produced by electric field vectors pointing in three directions whose azimuth angles are 60° apart from one anther.

The light from the two-dimensional photonic crystal surface-emission laser may be subjected to a scheme of, for example, arranging an optical element such as one or more half-wave plates or a polarization rotator. This permits the light source unit to produce light containing radially polarized waves, or to increase the proportion (ratio) of the radially polarized waves.

For example, in a case where the light emitted from the light-emitting element contains polarized waves that constitute a radiating electric field vector distribution and polarized waves that constitute a non-radiating electric field vector distribution, it is preferable to adopt a scheme according to which the orientation of the half-wave plate is aligned with the direction of any of the radiating electric field vectors. More specifically, for example, where the light contains radially polarized waves having rotation symmetry of order four produced by electric field vectors pointing in two mutually perpendicular directions, it can be said that adopting such a scheme helps further increase the proportion of the radially polarized waves.

One example of such a case is: relative to the first direction, that is, one of the two directions of the radially polarized waves, let a clockwise azimuth angle be given a “+” sign and let a counter-clockwise azimuth angle be given a “−” sign, then a case where the light from the two-dimensional photonic crystal surface-emission laser contains radially polarized waves, electric field vectors pointing in the direction +45° inclined relative to the first direction, and electric field vectors pointing in the direction −45° inclined relative to the first direction.

In this case, the light source unit includes a half-wave plate that, while transmitting the light emitted from the two-dimensional photonic crystal surface-emission laser, controls the polarization direction thereof, and the orientation of the half-wave plate is aligned with one of the above-mentioned two directions of the radially polarized waves.

With this design, by the half-wave plate, the direction of the electric field vectors (the polarization direction) pointing in the directions +45° and −45° inclined relative to the first direction is turned into the radial direction, changing into radially polarized waves. Thus, new radially polarized waves add to those that have been existing from the beginning. This greatly increases the proportion of the radially polarized waves in the light emitted from the light source unit.

The light source unit may include, instead of the half-wave plate, a polarization rotator that, while transmitting the light emitted from the light-emitting element, rotates the polarization direction thereof, with the polarization rotator having such a rotating power as to perpendicularly rotate the polarization direction of the electric field vectors of the light before passing through the polarization rotator.

Also with such a polarization rotator, the electric field vectors pointing in the directions +45° and −45° inclined relative to the first direction are made to point in the radial direction, and thus change into radially polarized waves.

According to another scheme, light containing no radially polarized waves is made to contain radially polarized waves. One example is where the lattice structure in the two-dimensional periodic structure is a square lattice or triangular lattice and the light emitted from the two-dimensional photonic crystal surface-emission laser contains, at least in part thereof, electric field vectors that constitute a rotation-symmetric electric field vector distribution, that have equal magnitudes at equal distances from the center of rotation symmetry, and that point in the azimuth angle direction.

In this case, the light source unit includes a first half-wave plate that, while transmitting the light emitted from the two-dimensional photonic crystal surface-emission laser, controls the polarization direction thereof. With this design, by the first half-wave plate, part of the electric field vectors that constitute a rotation-symmetric electric field vector distribution, that have equal magnitudes at equal distances from the center of rotation symmetry, and that point in the azimuth angle direction are made to point in the radial direction, and thus change into radially polarized waves.

It is preferable that the light source unit further include a second half-wave plate that, while transmitting the light from the first half-wave plate, controls the polarization direction thereof. Specifically, let the orientation of the first half-wave plate be called the first orientation, let the orientation of the second half-wave plate be called the second orientation, and, relative to the first orientation, let a clockwise azimuth angle be given a “+” sign and let a counter-clockwise azimuth angle be given a “−” sign, then it is preferable that the second half-wave plate be arranged so that the second orientation is +45° or −45° inclined relative to the first orientation.

With this design, the rest of the electric field vectors that have not been changed into radially polarized waves by the first half-wave plate are made to point in the radial direction by the second half-wave plate, and thus change into radially polarized waves.

The light source unit may include, instead of the two half-wave plates, a polarization rotator that, while transmitting the light emitted from the two-dimensional photonic crystal surface-emission laser, rotates the polarization direction thereof, with the polarization rotator having such a rotating power as to perpendicularly rotate the polarization direction of the electric field vectors in the light before passing through the polarization rotator.

This is because, even with such a polarization rotator, most of the electric field vectors that constitute a rotation-symmetric electric field vector distribution, that have equal magnitudes at equal distances from the center of rotation symmetry, and that point in the azimuth angle direction are made to point in the radial direction, and thus change into radially polarized waves.

In any case, with a combination of a photonic crystal with a polarization rotator or one or two or more half-wave plates, it is possible to convert electric field vectors that do not point in the radial direction into electric field vectors pointing in the radial direction, and thereby to increase the polarized waves that constitute a radiating electric field vector distribution.

A two-dimensional photonic crystal surface-emission laser is capable of laser oscillation in TM oscillation mode. In that case, that is, where the periodic interval of at least one of a plurality of periods in the two-dimensional periodic structure is equal to the peak gain wavelength of the TM oscillation mode light (TM-like polarized light) emitted from the active layer (the wavelength at which the gain for the TM oscillation mode light is maximal), the laser oscillation that occurs then may by itself produce light containing radially polarized waves.

More specifically, in TM oscillation mode, at least where the lattice structure in the two-dimensional periodic structure is a square or triangular lattice, light is produced that contains radially polarized waves.

With this design, the light source unit in the light-condensing head can emit light containing a very large proportion of radially polarized waves without using a half-wave plate, polarization rotator, or the like.

A storage apparatus, when provided with the light-condensing head described above and a magnetic head that at least writes magnetically recorded information to a recording medium irradiated with the light from the light-condensing head, offers the functionality and advantages described above, and thereby achieves reliable writing and reading of information by use of near-field light with augmented light intensity.

It should be understood that the embodiments, examples, etc. specifically described above are simply intended to clarify the technical idea of the present invention. That is, the present invention should not be narrowly interpreted in terms of the specific examples alone, but may be practiced with various modifications made within the scope of the appended claims.

What is claimed is:

1. A light-condensing head comprising:
a light source unit;
a light-condensing element that condenses light emitted from the light source unit; and
an electrically conductive scatterer that is arranged at a light condensation position of the light-condensing element and that produces localized plasmon when irradiated with light;
wherein the light emitted from the light source unit contains, at least in part thereof, polarized waves that constitute a radiating electric field vector distribution, and
wherein the electrically conductive scatterer has, in a light-receiving portion thereof that receives the light from the light-condensing element, rotation symmetry of order three or more.

2. The light-condensing head according to claim 1,
wherein the light emitted from the light source unit contains, at least in part thereof, radially polarized waves whose electric field vectors constitute a rotation-symmetric radiating electric field vector distribution and have equal magnitudes at equal distances from a center of rotation symmetry.

3. The light-condensing head according to claim 1,
wherein the electrically conductive scatterer is plate-shaped, and the light-receiving portion has a shape of a perfect circle, a right triangle, or a more-sided right polygon.

4. The light-condensing head according to claim 1,
wherein the light-receiving portion has a rotation-symmetric periodic structure.

5. The light-condensing head according to claim 1,
wherein the electrically conductive scatterer has a shape of a column extending in a travel direction of the light from the light receiving portion.

6. The light-condensing head according to claim 1,
wherein the following conditional formula is fulfilled:
λ/1 000≦LM1≦λ/10 (1)
where
LM1 represents a maximum width dimension of the light-receiving portion; and
λ represents a wavelength of the light.

7. The light-condensing head according to claim 1,
wherein the electrically conductive scatterer has a shape of a pyramid extending in a travel direction of the light from the light receiving portion.

8. The light-condensing head according to claim 7,
wherein the following conditional formula is fulfilled:
λ/1 000≦LM2≦10 (2)
λ/10≦LM3≦λ (2′)
where
LM2 represents a maximum width dimension of a curved surface part produced at a tip end of the pyramid, as measured in a plane perpendicular to the optical axis;
LM3 represents a maximum width dimension of a base face of the pyramid; and
λ represents a wavelength of the light.

9. The light-condensing head according to claim 1,
wherein the light source unit includes a light-emitting element that emits light, and
wherein the light-emitting element is a two-dimensional photonic crystal surface-emission laser including:
an active layer that emits light when carriers are injected thereinto; and
a clad layer that totally reflects light to confine the light inside the active layer,
wherein at least one of the active layer and the clad layer has a two-dimensional periodic structure formed of two materials having different refractive indices.

10. The light-condensing head according to claim 9,
wherein the light emitted from the two-dimensional photonic crystal surface-emission laser contains, at least in part thereof, radially polarized waves whose electric field vectors constitute a rotation-symmetric radiating electric field vector distribution and have equal magnitudes at equal distances from a center of rotation symmetry.

11. The light-condensing head according to claim 9,
wherein the two-dimensional periodic structure is a square lattice structure.

12. The light-condensing head according to claim 9,
wherein the two-dimensional periodic structure is a triangular lattice structure.

13. The light-condensing head according to claim 9,
wherein at least one of a plurality of periodic intervals in the two-dimensional periodic structure equals an even number times an effective wavelength of light propagated through the active layer.

14. The light-condensing head according to claim 13,
wherein the effective wavelength of the light propagated through the active layer equals a wavelength at which a maximum gain is obtained in TE lasing mode light of the active layer.

15. The light-condensing head according to claim 11,
wherein the light source unit includes a half-wave plate that transmits the light emitted from the light-emitting element and that controls a polarization direction of the light.

16. The light-condensing head according to claim 15,
wherein the light emitted from the light-emitting element contains polarized waves that constitute a radiating electric field vector distribution and polarized waves that constitute a non-radiating electric field vector distribution, and
wherein the half-wave plate is so arranged that an orientation thereof is aligned with an orientation of one of radiating electric field vectors.

17. The light-condensing head according to claim 15,
wherein, as the half-wave plate, a stack of a plurality of half-wave plates is used.

18. The light-condensing head according to claim 17,
wherein the half-wave plate includes a first half-wave plate and a second half-wave plate, and
wherein, let an orientation of the first half-wave plate be a first orientation, let an orientation of the second half-wave plate be a second orientation, let a clockwise azimuth angle relative to the first orientation be positive, and let a counter-clockwise azimuth angle relative to the first orientation be negative, then the second half-wave plate is so arranged that the second orientation is +45° or −455 inclined relative to the first orientation.

19. The light-condensing head according to claim 11,
wherein the light source unit includes a polarization rotator that transmits the light emitted from the light-emitting element and that rotates a polarization direction of the light.

20. The light-condensing head according to claim 19,
wherein the light emitted from the light-emitting element contains polarized waves that constitute a circumferential electric field vector distribution, and the polarization rotator has such a rotating power as to rotate circumferential electric field vectors into radiating electric field vectors.

21. The light-condensing head according to claim 9,
wherein at least one of a plurality of periodic intervals in the two-dimensional periodic structure equals a wavelength at which a maximum gain is obtained in TM lasing mode light emitted from the active layer.

22. The light-condensing head according to claim 21,
wherein the radially polarized waves are produced at least as a result of the two-dimensional periodic structure being a square or triangular lattice structure.

23. A storage apparatus comprising:
a light-condensing head including:
a light source unit;
a light-condensing element that condenses light emitted from the light source unit; and
an electrically conductive scatterer that is arranged at a light condensation position of the light-condensing element and that produces localized plasmon when irradiated with light;
wherein the light emitted from the light source unit contains, at least in part thereof, polarized waves that constitute a radiating electric field vector distribution, and
wherein the electrically conductive scatterer has, in a light-receiving portion thereof that receives the light from the light-condensing element, rotation symmetry of order three or more; and
a magnetic head that at least writes magnetically recorded information to a recording medium that is irradiated with light by the light-condensing head.
